(19) United States
(12) Patent Application Publication
(10) Pub. No.: US 2026/0292882 A1
(43) Pub. Date: Sep. 24, 2026

(54) METHOD AND APPARATUS FOR PERFORMING DIRECT TRANSMISSION BETWEEN MULTI USERS IN WLAN

(71) Applicant: HOLISTIC MANIFOLD INC., Daejeon (KR)

(72) Inventors: Yongho KIM, Incheon (KR); Woojin AHN, Anyang-si (KR); Juseong MOON, Osan-si (KR)

(73) Assignee: HOLISTIC MANIFOLD INC., Daejeon (KR)

(21) Appl. No.: 19/675,913

(22) Filed: May 13, 2026

Related U.S. Application Data
(63) Continuation of application No. PCT/KR2024/017919, filed on Nov. 13, 2024.

(30) Foreign Application Priority Data
Nov. 13, 2023 (KR) 10-2023-0156306
Mar. 18, 2024 (KR) 10-2024-0037338
May 9, 2024 (KR) 10-2024-0061151
Jun. 28, 2024 (KR) 10-2024-0085462

(51) Int. Cl. H04W 74/0816; H04W 74/06; H04W 84/12

(52) U.S. Cl. CPC H04W 74/0816; H04W 74/06; H04W 84/12

(57) ABSTRACT

A method of operating a STA in a wireless LAN system, the method may comprise: receiving a P2P control frame from an AP within a TXOP of the AP, wherein a P2P communication period is allocated to at least one STA based on the P2P control frame, transmitting a CTS frame to the AP in response to the P2P control frame, wherein at least one STA including the first STA that received the P2P control frame simultaneously transmits a CTS frame to the AP, and transmitting at least one of a P2P frame and an uplink frame within an individual P2P communication period of the first STA within the P2P communication period allocated to the at least one STAs.

### CROSS REFERENCE TO RELATED APPLICATIONS

This application is a bypass continuation application of International Application No. PCT/KR2024/017919, filed on Nov. 13, 2024, which claims priority to Korean Patent Application No. 10-2023-0156306, filed on Nov. 13, 2023, Korean Patent Application No. 10-2024-0037338, filed on Mar. 18, 2024, Korean Patent Application No. 10-2024-0061151, filed on May 9, 2024 and Korean Patent Application No. 10-2024-0085462, filed on Jun. 28, 2024, the disclosures of which are incorporated herein by reference in their entireties.

### FIELD

The present disclosure relates to a method and apparatus for performing direct transmission between multiple users in a Wireless Local Area Network (WLAN). Specifically, the present disclosure relates to a method for performing peer-to-peer (P2P) communication between users in a WLAN.

The present disclosure also relates to a method for communication nodes to share communication resources enabling bidirectional data transmission in a WLAN.

The present disclosure also relates to a method for sharing a proxy bidirectional transmission opportunity in a WLAN.

### DESCRIPTION OF THE RELATED ART

With the recent widespread adoption of mobile devices, wireless local area network (WLAN) technology capable of providing fast wireless communication services to mobile devices has been receiving significant attention. WLAN technology may refer to technology that enables mobile devices, such as smartphones, smart pads, laptop computers, portable multimedia players, and embedded devices, to wirelessly access the Internet based on short-range wireless communication technology.

Standards utilizing WLAN technology are primarily developed by the Institute of Electrical and Electronics Engineers (IEEE) as the IEEE 802.11 standard. As the WLAN technology has been developed and commercialized, applications utilizing WLAN technology have diversified, and the demand for WLAN technology supporting higher reliability has emerged.

As applications requiring higher reliability have emerged, the IEEE 802.11bn standard, which is an Ultra High Reliability (UHR) WLAN technology, is being developed for use in single Basic Service Set (BSS) environments and/or overlapping BSS environments. The objectives of the IEEE 802.11bn standard may include supporting improvements in data transmission rate, latency performance, and data error rate. In addition, the IEEE 802.11bn standard may support low-power operation and peer-to-peer (P2P) communication.

However, there may be no method for allocating a direct communication period to multiple users in a WLAN. Accordingly, the procedure that must be performed for multiple users to perform direct communication may need to be performed multiple times. The procedures required for direct communication may be unnecessarily increased. Therefore, the direct communication method in a WLAN may not be efficient. That is, inefficient use of wireless resources may arise. Accordingly, performance issues may occur during direct communication in a WLAN network.

Meanwhile, the background art section has been prepared to promote understanding of the background of the invention. It may include content that is not prior art already known to those skilled in the art to which this technology pertains.

### SUMMARY

The present disclosure may provide a method and apparatus for performing direct transmission between multiple users in a WLAN.

The present disclosure may provide a method and apparatus for performing P2P communication in a WLAN.

The present disclosure may provide a method and apparatus for an access point (AP) to allocate a P2P communication period to at least one station (STA) in a WLAN.

The present disclosure may provide a method and apparatus for a STA to transmit at least one of an uplink frame and a P2P frame within a P2P communication period allocated by an AP in a WLAN.

The present disclosure may provide a method and apparatus for sharing a transmission opportunity (TXOP) among a plurality of WLAN terminals in a bidirectional manner and exchanging data bidirectionally with low channel access delay in a WLAN.

The present disclosure relates to a method and apparatus for sharing a proxy bidirectional transmission opportunity in a WLAN.

The technical problems to be achieved in the present disclosure are not limited to the technical problems mentioned above, and other technical problems not mentioned herein will be clearly understood by those skilled in the art to which the present disclosure pertains from the description below.

According to an embodiment of the present disclosure, a method of operating a station (STA) in a wireless LAN system may comprise: receiving a peer-to-peer (P2P) control frame from an access point (AP) within a transmission opportunity (TXOP) of the AP; transmitting a clear to send (CTS) frame to the AP in response to the P2P control frame; and transmitting at least one of a P2P frame and an uplink frame within an individual P2P communication period of the STA within the P2P communication period, wherein the P2P control frame is also received by at least one other STA, whereby a P2P communication period is allocated based on the P2P control frame, and the CTS frame is transmitted to the AP simultaneously with CTS frames transmitted by the at least one other STA that received the P2P control frame.

According to an embodiment of the present disclosure, a wireless user equipment may comprise: at least one processor; and a memory storing instructions that cause the wireless user equipment to perform certain operations by the at least one processor, wherein the certain operations comprise: receiving a peer-to-peer (P2P) control frame from an access point (AP) within a transmission opportunity (TXOP) of the AP; transmitting a clear to send (CTS) frame to the AP in response to the P2P control frame; and transmitting at least one of a P2P frame and an uplink frame within an individual P2P communication period of the STA within the P2P communication period, wherein the P2P control frame is also received by at least one other STAs, whereby a P2P communication period is allocated based on the P2P control frame, and the CTS frame is transmitted to the AP simultaneously with CTS frames transmitted by the at least one other STA that received the P2P control frame.

According to an embodiment of the present disclosure, a method of operating an access point (AP) may comprise: acquiring a transmission opportunity (TXOP) by occupying a channel based on an enhanced distributed channel access (EDCA) backoff procedure; transmitting a peer-to-peer (P2P) control frame to at least one station (STA) within the TXOP, wherein a P2P communication period is allocated to the at least one STA based on the P2P control frame; and simultaneously receiving clear to send (CTS) frames from the at least one STA in response to the P2P control frame, wherein after receiving the CTS frames, the P2P communication period may be allocated to the at least one STA.

According to an embodiment of the present disclosure, a wireless user equipment may comprise: at least one processor; and a memory storing instructions that cause the wireless user equipment to perform certain operations by the at least one processor, wherein the certain operations comprise: acquiring a transmission opportunity (TXOP) by occupying a channel based on an enhanced distributed channel access (EDCA) backoff procedure; transmitting a peer-to-peer (P2P) control frame to at least one station (STA) within the TXOP, wherein a P2P communication period is allocated to the at least one STA based on the P2P control frame; and simultaneously receiving clear to send (CTS) frames from the at least one STA in response to the P2P control frame, wherein after receiving the CTS frames, the P2P communication period may be allocated to the at least one STA.

In addition, the following may be commonly applied.

According to an embodiment of the present disclosure, the STA may receive a polling trigger frame for P2P communication from the AP prior to receiving the P2P control frame, and may transmit a response frame to the polling trigger frame to the AP, wherein the response frame transmitted by the STA intending to perform P2P communication and response frames transmitted by each of the at least one other STAs may be simultaneously transmitted to the AP on respective tones allocated based on association IDs (AIDs) of orthogonal frequency division multiple access (OFDMA).

According to an embodiment of the present disclosure, the STA may receive a buffer status report polling frame from the AP prior to receiving the P2P control frame, and may transmit a response frame including a buffer status report to the AP based on the buffer status report polling frame, wherein the buffer status report includes data information to be transmitted by the STA, and response frames transmitted from each of the at least one other STAs to the AP may include buffer status reports for each of the at least one other STAs.

According to an embodiment of the present disclosure, the individual P2P communication period of the STA among the total P2P communication period allocated by the AP may be determined based on the buffer status report transmitted from the STA and the buffer status reports transmitted from each of the at least one other STAs.

According to an embodiment of the present disclosure, the individual P2P communication period of the STA among the total P2P communication period allocated by the AP may be a communication period allocated to the STA based on the P2P control frame, or a communication time acquired by the STA through channel contention within the total P2P communication period allocated by the AP.

According to an embodiment of the present disclosure, the P2P control frame may include at least one of: a list of at least one STA performing P2P communication; a total P2P communication period; an individual P2P communication period per STA; a P2P communication performance order; and CTS frame transmission timing information.

According to an embodiment of the present disclosure, the P2P control frame may include a user information field, wherein the user information field includes identification information of the at least one STA and individual P2P communication period information per STA, and the order of performing P2P communication in the total P2P communication period may be determined based on the order of the STAs included in the user information field.

According to an embodiment of the present disclosure, the P2P control frame may directly indicate individual time information per STA or may indicate individual time information per STA through a P2P communication period occupancy end time per STA.

According to an embodiment of the present disclosure, when the P2P communication of the STA is shorter than the individual P2P communication period of the STA, the STA may add padding bits to the frame transmitted based on the P2P communication so as to make it equal to the individual P2P communication period of the STA.

According to an embodiment of the present disclosure, when P2P communication is not detected for a preset duration within the P2P communication period allocated to the STA and the at least one other STAs, the P2P control frame may be retransmitted from the AP and the P2P communication period may be reallocated.

According to an embodiment of the present disclosure, the STA may receive a poll frame of the STA from the AP after transmitting the CTS frame to the AP, wherein the poll frame of the STA includes at least one of information granting P2P communication to the STA and individual P2P communication period information of the STA, and the STA may transmit to the AP at least one of an uplink frame and a return frame including individual P2P communication period return indicator information of the STA within the individual P2P communication period of the STA.

According to an embodiment of the present disclosure, the P2P control frame includes information indicating whether the STA may share the P2P communication period with other STAs, and when the STA may share the P2P communication period with other STAs, the STA may transmit a P2P frame to any one of the other STAs within the P2P communication period and then transmit a P2P communication period sharing indicator frame to the any one of the other STAs, and P2P transmission by the any one of the other STAs that received the P2P communication period sharing indicator frame may be performed within the P2P communication period.

According to an embodiment of the present disclosure, the STA may transmit a P2P frame to any one of the other STAs within the P2P communication period and then transmit a P2P communication period sharing indicator frame, and the P2P communication period of the STA may be terminated by the AP that received the P2P communication period sharing indicator frame, and the P2P control frame may be transmitted by the AP to the any one of the other STAs based on the information included in the P2P communication period sharing indicator frame, whereby the P2P communication period may be allocated to the any one of the other STAs.

According to the present disclosure, there is an effect of performing direct transmission between multiple users in a WLAN.

According to the present disclosure, there is an effect of providing a method for performing P2P communication in a WLAN.

According to the present disclosure, there is an effect of providing a method for an access point (AP) to allocate a P2P communication period to at least one station (STA) in a WLAN.

According to the present disclosure, there is an effect of providing a method for a STA to transmit at least one of an uplink frame and a P2P frame within a P2P communication period allocated by an AP in a WLAN.

According to the present disclosure, there is an effect of providing a method for sharing a TXOP among a plurality of WLAN terminals in a bidirectional manner and exchanging data bidirectionally with low channel access delay in a WLAN.

According to the present disclosure, there is an effect of providing a method for sharing a proxy bidirectional transmission opportunity in a WLAN.

The effects obtainable from the present disclosure are not limited to the effects mentioned above, and other effects not mentioned herein will be clearly understood by those skilled in the art to which the present disclosure pertains from the description below.

### BRIEF DESCRIPTION OF THE DRAWINGS

FIG. 1 is a diagram illustrating a communication node in a wireless LAN system to which the present disclosure is applied.

FIG. 2 is a diagram illustrating a wireless LAN system to which the present disclosure is applied.

FIG. 3 is a diagram illustrating a machine learning unit to which the present disclosure is applied.

FIG. 4 is a flowchart illustrating a method of performing communication based on a machine learning unit to which the present disclosure is applied.

FIG. 5A and FIG. 5B are diagrams illustrating a method of performing multi-user direct communication in a wireless LAN to which the present disclosure is applied.

FIG. 6A and FIG. 6B are diagrams illustrating a multi-user direct communication method in a wireless LAN to which the present disclosure is applied.

FIG. 7 is a diagram illustrating a multi-user direct communication method in a wireless LAN to which the present disclosure is applied.

FIG. 8 is a diagram illustrating a multi-user direct communication method in a wireless LAN to which the present disclosure is applied.

FIG. 9 is a diagram illustrating a bidirectional TXOP sharing configuration method in a wireless LAN to which the present disclosure is applied.

FIG. 10 is a diagram illustrating a bidirectional TXOP sharing configuration method in a wireless LAN to which the present disclosure is applied.

FIG. 11 is a diagram illustrating a bidirectional TXOP sharing configuration method in a wireless LAN to which the present disclosure is applied.

FIG. 12 is a diagram illustrating a bidirectional TXOP sharing configuration method in a wireless LAN to which the present disclosure is applied.

FIG. 13 is a diagram illustrating a bidirectional TXOP sharing configuration method in a wireless LAN to which the present disclosure is applied.

FIG. 14 is a diagram illustrating a bidirectional TXOP sharing data transmission method in a wireless LAN to which the present disclosure is applied.

FIG. 15 is a diagram illustrating a bidirectional TXOP sharing data transmission method in a wireless LAN to which the present disclosure is applied.

FIG. 16 is a diagram illustrating a bidirectional TXOP sharing data transmission method in a wireless LAN to which the present disclosure is applied.

FIG. 17 is a diagram illustrating a bidirectional TXOP sharing data transmission method in a wireless LAN to which the present disclosure is applied.

FIG. 18 is a diagram illustrating a bidirectional TXOP sharing data transmission method in a wireless LAN to which the present disclosure is applied.

FIG. 19 is a diagram illustrating a bidirectional TXOP sharing data transmission method in a wireless LAN to which the present disclosure is applied.

FIG. 20 is a diagram illustrating a bidirectional OFDMA transmission method in a wireless LAN to which the present disclosure is applied.

FIG. 21 is a diagram illustrating a bidirectional OFDMA transmission method in a wireless LAN to which the present disclosure is applied.

FIG. 22A through FIG. 22C are diagrams illustrating a proxy bidirectional TXOP sharing configuration method in a wireless LAN to which the present disclosure is applied.

FIG. 23A and FIG. 23B are diagrams illustrating a proxy bidirectional TXOP sharing configuration method in a wireless LAN to which the present disclosure is applied.

FIG. 24 is a flowchart illustrating a method of operating a STA performing direct transmission between multiple users in a wireless LAN to which the present disclosure is applied.

FIG. 25 is a flowchart illustrating a method of operating an AP performing direct transmission between multiple users in a wireless LAN to which the present disclosure is applied.

### DETAILED DESCRIPTION

The present disclosure is susceptible to various modifications and may have various embodiments, and specific embodiments will be illustrated in the drawings and described in detail. However, this is not intended to limit the present disclosure to specific embodiments, and it should be understood that the present disclosure includes all modifications, equivalents, and substitutes within the spirit and technical scope of the present disclosure.

Terms such as first, second, etc. may be used to describe various components, but said components should not be limited by said terms. Said terms are used only for the purpose of distinguishing one component from another component. In an embodiment, a first component may be designated as a second component, and similarly, a second component may also be designated as a first component, without departing from the scope of the present disclosure. The term “and/or” includes any combination of a plurality of related listed items or any one of a plurality of related listed items.

When a component is referred to as being “connected” or “coupled” to another component, it should be understood that the component may be directly connected or coupled to the other component, but another component may also exist in between. On the other hand, when a component is referred to as being “directly connected” or “directly coupled” to another component, it should be understood that no other component exists in between.

The terms used in the present disclosure are used only to describe specific embodiments and are not intended to limit the present disclosure. Singular expressions include plural expressions unless the context clearly indicates otherwise. In the present disclosure, terms such as “comprise” or “have” are intended to designate the presence of features, numbers, steps, operations, components, parts, or combinations thereof described in the specification, and should be understood as not precluding the possibility of the presence or addition of one or more other features, numbers, steps, operations, components, parts, or combinations thereof.

Unless otherwise defined, all terms used herein, including technical or scientific terms, have the same meaning as commonly understood by those skilled in the art to which the present disclosure pertains. Terms defined in commonly used dictionaries should be interpreted as having meanings consistent with the meanings they have in the context of the relevant art, and unless explicitly defined in the present disclosure, should not be interpreted in an ideal or excessively formal sense.

Hereinafter, preferred embodiments of the present disclosure will be described in greater detail with reference to the accompanying drawings. In describing the present disclosure, the same reference numerals are used for the same components in the drawings to facilitate overall understanding, and duplicate descriptions of the same components are omitted.

In the following, a wireless communication system to which embodiments according to the present disclosure are applied will be described. The wireless communication system to which the embodiments according to the present disclosure are applied is not limited to the content described below, and the embodiments according to the present disclosure may be applied to various wireless communication systems. A wireless communication system may be referred to as a “wireless communication network.”

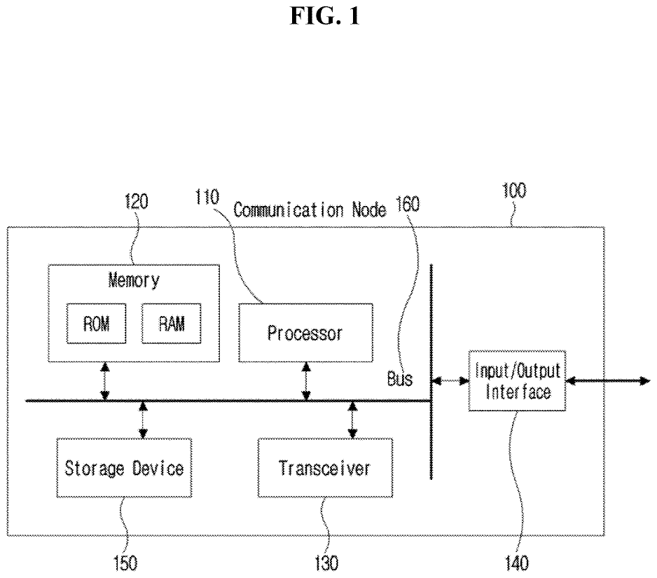

FIG. 1 is a diagram illustrating a communication node in a wireless LAN system to which the present disclosure is applied. Referring to FIG. 1, a communication node (100) may include at least one of a processor (110), a memory (120), a transceiver (130), an input/output interface (140), a storage device (150), and a bus (160). In an embodiment, the communication node (100) may be an access point (AP), a station (STA), an AP multi-link device (MLD), or a non-AP MLD. However, the communication node may not be limited thereto, and may be a node that communicates with other nodes or devices based on the configuration. In an embodiment, an operating channel width supported by an AP may be 20 MHz (megahertz), 80 MHz, 160 MHz, or the like. An operating channel width supported by a station may be 20 MHz, 80 MHz, or the like. However, the present disclosure may not be limited thereto.

The processor (110) within the communication node (100) may control at least one of the memory (120), the transceiver (130), the input/output interface (140), and the storage device (150) as respective components within the communication node. The memory (120) within the communication node (100) may store information regarding instructions and directives executed by the processor (110), and the transceiver (130) may refer to a transceiver, a radio frequency (RF) unit, an RF module, or any other component that performs signal transmission and reception. The input/output interface (140) within the communication node (100) is an interface for input and output that may interoperate with other interfaces, and may further include a separate storage device (150). Each of the components within the communication node (100) may be connected via a bus (160) to communicate with one another.

However, as an embodiment, each of the components included in the communication node (100) may be connected not via a common bus (160), but via individual interfaces or individual buses centered around the processor (110). The processor (110) may be connected to at least one of the memory (120), the transceiver (130), the input/output interface (140), and the storage device (150) via a dedicated interface.

The processor (110) may execute program commands stored in at least one of the memory (120) or the storage device (150). The processor (110) may refer to a central processing unit (CPU), a graphics processing unit (GPU), or a dedicated processor on which methods according to embodiments of the present disclosure are performed. Each of the memory (120) and the storage device (150) may be configured as at least one of a volatile storage medium or a non-volatile storage medium. In an embodiment, the memory (120) may be configured as at least one of a read only memory (ROM) or a random access memory (RAM).

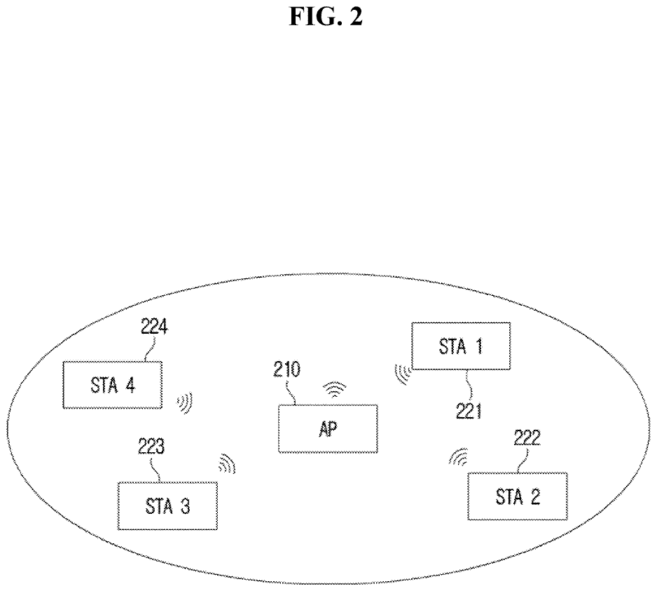

FIG. 2 is a diagram illustrating a wireless LAN system to which the present disclosure is applied. Referring to FIG. 2, a basic service set (BSS) of the wireless LAN system may include one AP (210) and a plurality of STAs (221, 222, 223, 224), and the plurality of STAs (221, 222, 223, 224) may be controlled by the AP (210). However, the wireless LAN system is not limited to a BSS, and an environment consisting only of STAs without a defined service set or AP may also be considered, and the wireless LAN system is not limited to any specific form. Each of the wireless devices within the wireless LAN system may include a medium access control (MAC) layer and a physical (PHY) layer, and communication between the wireless devices may be performed. In the following description, the AP and STA are primarily described for convenience of explanation, but the description may not be limited thereto. In an embodiment, the following may be equally applicable to other communication nodes or devices, and is not limited to any specific form.

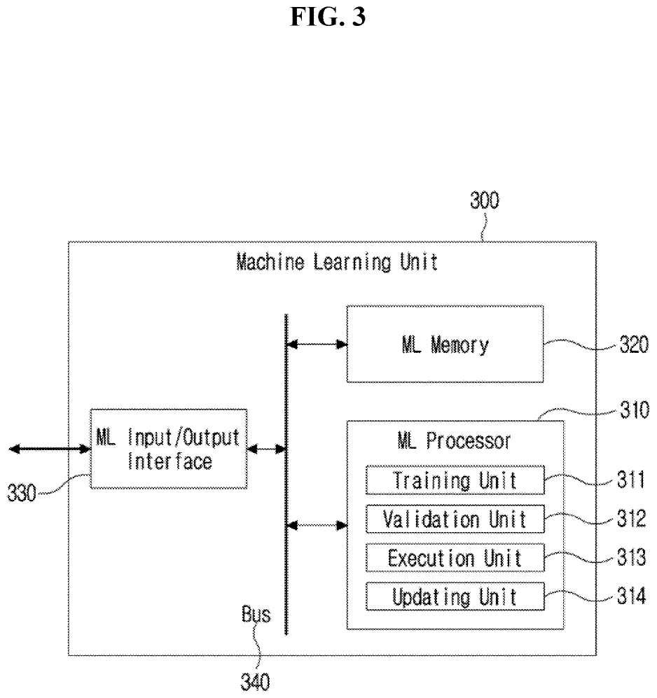

FIG. 3 is a diagram illustrating a machine learning unit to which the present disclosure is applied. Each of the wireless devices within the wireless LAN system may be connected to a machine learning unit (300). However, the present disclosure may not be limited thereto, and it may also be possible for a wireless device that is not connected to the machine learning unit (300) to operate.

In an embodiment, the processor (110) of the communication node (100) of FIG. 1 may be connected to the machine learning unit (300). The machine learning unit (300) may communicate with the processor (110) via the input/output interface (140) of the communication node (100). As another embodiment, the machine learning unit (300) may communicate with the processor (110) via the bus (160) of the communication node (100). As yet another embodiment, the machine learning unit (300) may be connected to and communicate with the processor (110) of the communication node (100) via an individual interface or a dedicated bus. The machine learning unit (300) may be connected to and communicate with the memory (120), the transceiver (130), and the storage device (140) via the input/output interface (140), the bus (160), or a dedicated bus of the communication node (100), but may not be limited to any specific form.

In an embodiment, the machine learning unit (300) may include at least one machine learning (ML) processor (310), an ML memory (320), an ML input/output interface (330), and ML buses (340). The ML processor (310), the ML memory (320), and the ML input/output interface (330) may be connected to and communicate with one another via the ML bus (340). As another embodiment, the ML processor (310) may be connected to and communicate with at least one of the ML memory (320) and the ML input/output interface (330) via a dedicated bus or interface. The ML processor (310) may be a central processing unit, a graphics processing unit, a dedicated processor on which methods according to embodiments of the present disclosure are performed, or a processor combining at least one of a central processing unit and a dedicated processor. The ML processor (310) may include at least one of a training unit (311), a validation unit (312), an execution unit (313), and an updating unit (314). The training unit (311), the validation unit (312), the execution unit (313), and the updating unit (314) may be logical entities implemented in software or hardware processing devices. In an embodiment, the ML processor (310) may perform at least one of training, validation, execution, and updating of a machine learning model. The machine learning model may be in the form of a plurality of matrices or vectors. As a specific embodiment, the machine learning model may include weights, transition matrices, and hyperparameters that implement and train single or multiple combined machine learning algorithms (e.g., deep neural network (DNN), convolutional neural network (CNN), recurrent neural network (RNN), and deep reinforcement learning (DRL) algorithms). The machine learning model may include an input layer, at least one hidden layer, and an output layer to implement a DNN algorithm. Each of the input layer, the hidden layer, and the output layer may include at least one perceptron (e.g., an artificial neuron). A perceptron includes an activation function, input weights, and a bias. A plurality of perceptron may have their inputs and outputs connected to form the input layer, the hidden layer, and the output layer. The machine learning model may include a convolution algorithm and the DNN algorithm to implement a CNN algorithm. The convolution algorithm is an algorithm that applies a kernel matrix to input data in matrix form via convolution, and may be performed at least once on the input data. When the convolution algorithm is performed on the input data, the size of the data may increase through concatenation or decrease through pooling. Input data on which the convolution algorithm has been performed at least once is used as input data for the DNN algorithm. In an embodiment, the machine learning model may include a DNN algorithm and a cell structure to implement an RNN algorithm. The cell structure may be a structure that memorizes previous input data and feeds it back as input, and may be used in at least one perceptron of the DNN algorithm. The machine learning model may include an agent, an environment structure, and a DNN algorithm to implement a DRL algorithm. In the DRL algorithm, the agent may observe the environment and perform an optimal action based thereon. The environment may provide feedback to the agent in the form of a reward based on the action of the agent. Based on the foregoing, the agent may learn a policy for taking optimal actions. The agent may use a DNN algorithm to learn optimal actions.

As another embodiment, the machine learning unit (300) may be designed to additionally implement other machine learning algorithms beyond those already implemented. To this end, the machine learning unit (300) may include additional components for implementing other machine learning algorithms. The ML memory (320) within the machine learning unit (300) may store machine learning models and machine learning algorithms. Implementation of a machine learning algorithm may be performed by the ML processor (310) based on the machine learning model.

As another embodiment, all or part of the functions of the machine learning unit (300) may be integrated into the processor (110) and the memory (120) of the communication node (100). That is, the processor (110) of the communication node (100) may perform some or all of the functions of the ML processor (310), and the memory (120) may perform all or some of the functions of the ML memory (320). When the processor (110) and the memory (120) of the communication node (100) perform all functions of the machine learning unit (300), the machine learning unit (300) may not be connected via the input/output interface (140), and the processor (110) and the memory (120) may operate as the machine learning unit (300).

As another embodiment, the machine learning unit (300) may not be connected via the input/output interface (140) of the communication node (100), but may be connected via the bus (160), or via a dedicated bus or interface centered around the processor (110) of the communication node (100), but the present disclosure may not be limited to such embodiments.

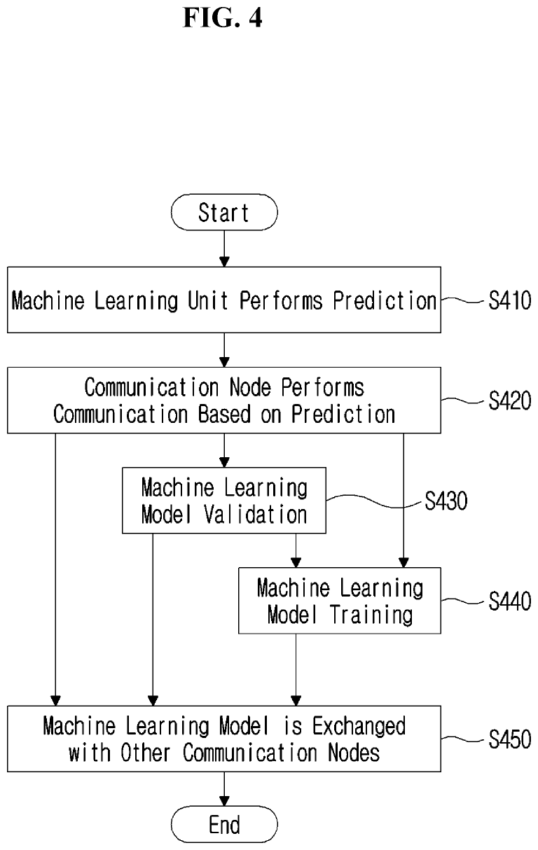

FIG. 4 is a flowchart illustrating a method of performing communication based on a machine learning unit to which the present disclosure is applied. Referring to FIG. 4, the machine learning unit (300) may be connected to the communication node (100) to collect communication data and perform prediction based on a machine learning model (S410). In an embodiment, the prediction may be performed by the execution unit (313) of the machine learning unit (300), but is not limited thereto. Here, the communication data collected by the machine learning unit (300) may include at least one of channel noise status, channel congestion, received signal strength, collision frequency, and other information obtained from the physical layer. In addition, the communication data may include information obtained from the MAC layer, and is not limited to any specific form. The communication data collected by the machine learning unit (300) may be provided as input to the machine learning model as-is. As another embodiment, the communication data collected by the machine learning unit (300) may be processed or pre-processed before being provided as input to the machine learning model. In an embodiment, the prediction result of the machine learning unit (300) may be at least one of physical layer and MAC parameters (e.g., modulation and coding scheme (MCS) parameters, beamforming parameters, enhanced distributed channel access (EDCA) parameters, etc.). As another embodiment, the prediction result of the machine learning unit (300) may be information for packet scheduling, multi-AP operation scheduling, and other scheduling, but is not limited to any specific form. As another embodiment, the communication node (100) may receive all or part of a machine learning model from another communication node. All or part of the machine learning model may be collected by the machine learning unit (300), and is not limited to any specific form. In an embodiment, the communication node (100) may perform communication based on the prediction of the machine learning unit (300) (S420). In addition, the machine learning unit (300) may collect communication data based on the performed communication, and based thereon, machine learning model validation (S430) or machine learning model training (S440) may be performed. Also, In an embodiment, the machine learning model may be exchanged with other communication nodes (S450), and the exchanged machine learning model information may be used for machine learning model validation or machine learning model training. In an embodiment, when machine learning model validation is performed, it may be verified whether the communication operation performed by the prediction of the machine learning unit (300) is appropriate. As a specific embodiment, machine learning model validation may be performed based on at least one of the frame collision frequency, transmission error frequency, and packet transmission delay of the communication node (100), and an operation of determining whether the communication performance of the communication node (100) has improved may be performed.

In addition, In an embodiment, when it is determined that training of the machine learning model is necessary (e.g., when communication performance has not improved, or when the performance of the machine learning model of another communication node (e.g., all or part of the machine learning model) is determined to be superior to the machine learning model of the current communication node (100)), the communication node (100) may perform machine learning model training. As another embodiment, the communication node (100) may exchange the machine learning model with other communication nodes without performing machine learning model validation or machine learning model training. Also, In an embodiment, when it is determined that training of the machine learning model is not necessary, the communication node (100) may exchange the machine learning model with other communication nodes without performing machine learning model training.

Here, the training of the machine learning model may be performed based on at least one of the collected communication data and all or part of the machine learning model of another communication node. The training of the machine learning model may be performed by the training unit (311), and may be performed based on at least one of the collected communication data, the machine learning model of another communication node, and the output of the machine learning model of the communication node (100).

As another embodiment, all or part of the machine learning model of the communication node (100) may be replaced with all or part of the machine learning model of another communication node by the updating unit (314) of the machine learning unit (300). As another embodiment, the machine learning model (e.g., all or part of the machine learning model) of the communication node (100) may be shared with other communication nodes. Alternatively, it may also be possible for the communication node (100) to operate based solely on machine learning model validation and training without exchanging the machine learning model with other communication nodes, and the present disclosure is not limited to any specific form. In an embodiment, in the flowchart of the present disclosure, at least one of reordering of steps, addition or removal of steps, and repetition of specific steps may be performed. That is, the present flowchart is one embodiment illustrating the operation of the machine learning unit (300) of the wireless communication node (100), and the procedures and operations may be variously modified. In an embodiment, it may also be possible for the machine learning model validation step to be performed again after machine learning model training in order to validate the trained machine learning model, and the present disclosure may not be limited to any specific form. In the following description, the operation of wireless LAN terminals is described based on the station (STA). As used consistently with IEEE 802.11 terminology, “STA” may refer to both an AP STA operating as an access point (AP) and a non-AP STA operating in connection with an AP. For convenience of description, however, the AP and the non-AP STA are described separately below; this distinction is made solely for ease of explanation, and it will be apparent that operations described for the AP may apply to both AP STAs and non-AP STAs. It will likewise be apparent that non-AP STA operations described below may also apply to both non-AP STAs and AP STAs. Each wireless device within a wireless LAN system may include a medium access control (MAC) layer and a physical (PHY) layer, and communication between wireless devices may be performed. For convenience of description, the following focuses on the AP and non-AP STA, though the disclosure is not limited thereto. For example, the matters described below may apply equally to other communication nodes or devices, and are not limited to any particular form.

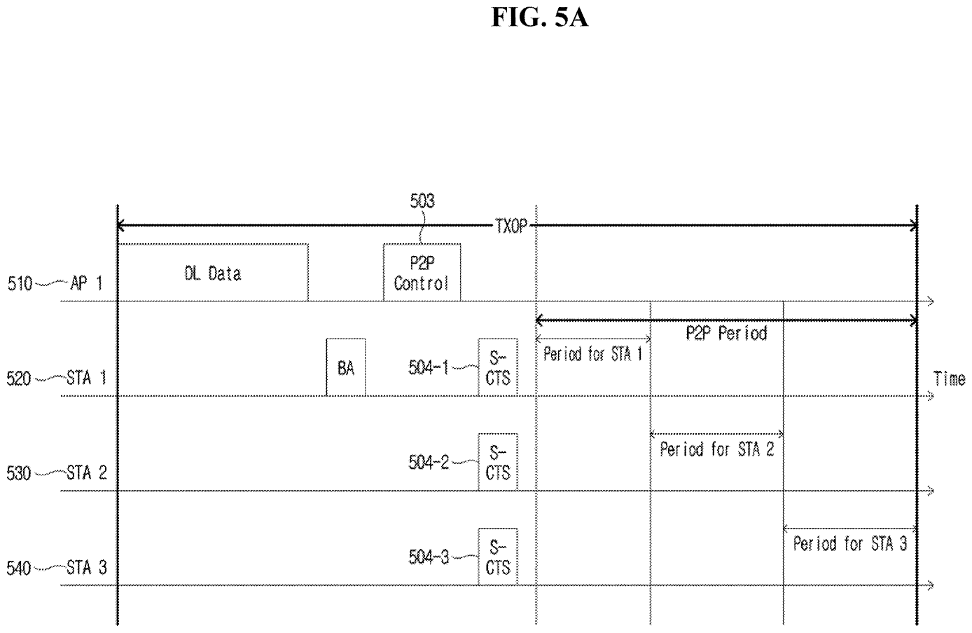

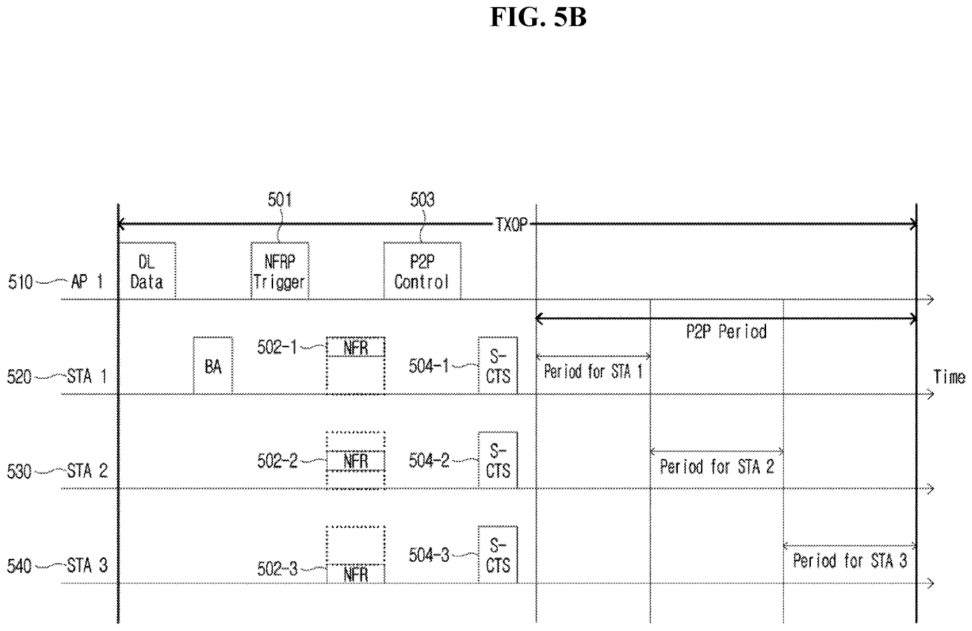

FIG. 5A and FIG. 5B are diagrams illustrating a method of performing multi-user direct communication in a wireless LAN.

Referring to FIG. 5A and FIG. 5B, an environment in which AP 1 (510), STA 1 (520), STA 2 (530), and STA 3 (540) operate in a wireless LAN network may be considered. However, this is for convenience of explanation only and is not limited thereto, and the same may be equally applicable to other cases. AP 1 (510) may perform an Enhanced Distributed Channel Access (EDCA) backoff, and may transmit a frame upon successfully completing the backoff and occupying the channel. In the EDCA backoff procedure, EDCA functions (EDCAFs) associated with each access category (AC) (e.g., AC_VO EDCAF, AC_VI EDCAF, AC_BE EDCAF, AC_BK EDCAF) may determine a random backoff counter value, and the EDCAFs may decrement the backoff counter. When the backoff counter reaches zero, the EDCAF may perform frame transmission at the slot boundary at which the backoff counter reaches zero. When the EDCAF of AP 1 (510) determines frame transmission, an EDCA transmission opportunity (TXOP) may be granted to the EDCAF of AP 1 (510). The TXOP may be a time period during which an AP (or STA) may transmit one or more frames.

AP 1 (510) may transmit downlink data (e.g., downlink frames) to STAs (STA 1 through STA 3) within the TXOP. In an embodiment, AP 1 (510) may transmit a downlink frame to STA 1 (520) within the TXOP. As another embodiment, AP 1 (510) may transmit a clear to send (CTS) frame instead of transmitting a downlink frame to STA 1 (520). The CTS frame transmitted by AP 1 (510) may be a CTS-to-Self frame in which the receiver address (RA) is set to the medium access control (MAC) address of AP 1 (510), but the present disclosure may not be limited to such embodiments. After AP 1 (510) transmits a downlink frame to STA 1 (520), AP 1 (510) may allocate a period within the TXOP of AP 1 (510) during which STAs may perform peer-to-peer (P2P) communication.

As another embodiment, AP 1 (510) may allocate a period during which STAs may perform P2P communication without transmitting a downlink frame within the TXOP, and the present disclosure may not be limited to any specific form. Here, P2P communication may refer to direct communication in which STAs communicate directly with one another.

Referring to FIG. 5B, AP 1 (510) may perform a polling operation to determine which STAs will perform P2P operation prior to allocating the P2P communication period. In an embodiment, AP 1 (510) may perform an NDP (Null Data PPDU) Feedback Report Poll (NFRP) operation, but the present disclosure may not be limited thereto. However, in the following description, the NFRP is used as a reference for convenience of explanation. Through the polling operation described below, AP 1 (510) may identify STAs that will perform P2P operation and form a group among STAs performing P2P communication.

AP 1 (510) may transmit an NFRP trigger frame (501) to STA 1 (520), STA 2 (530), and STA 3 (540). STA 1 (520), STA 2 (530), and STA 3 (540) may intend to perform P2P communication, and each of STA 1 (520), STA 2 (530), and STA 3 (540) may transmit an NDP feedback report (NFR) (502-1, 502-2, 502-3) to AP 1 (510) after a SIFS duration in response to the NFRP trigger frame (501) of AP 1 (510). In an embodiment, among the STAs that received the NFRP trigger frame (501), a STA that will not perform P2P communication during the P2P communication period allocated by the AP may not transmit a response to the NFRP trigger frame (501), but the present disclosure may not be limited thereto.

The NFRs (502-1, 502-2, 502-3) transmitted by each of STA 1 (520), STA 2 (530), and STA 3 (540) may be transmitted on tones allocated per association ID (AID) of orthogonal frequency division multiple access (OFDMA). That is, each of STA 1 (520), STA 2 (530), and STA 3 (540) may simultaneously perform NFR (502-1, 502-2, 502-3) transmission on tones allocated based on the AID. In an embodiment, a tone may be an OFDMA subcarrier. AP 1 (510) may receive the NFRs (502-1, 502-2, 502-3) from each of STA 1 (520), STA 2 (530), and STA 3 (540), and may recognize that STA 1 (520), STA 2 (530), and STA 3 (540) intend to perform P2P communication during the allocated P2P communication period. Through the foregoing, AP 1 (510) may identify the STAs to which the P2P communication period should be allocated. That is, after transmitting the NFRP trigger frame (501) to at least one STA, AP 1 (510) may recognize STAs that did not transmit an NFR in response thereto as STAs that will not perform P2P communication.

Referring to FIG. 5A and FIG. 5B, AP 1 (510) may transmit a P2P control frame (503) to allocate a period during which STA 1 (520), STA 2 (530), and STA 3 (540) may perform P2P communication. Prior to transmitting the P2P control frame (503), AP 1 (510) may check the traffic conditions of the STAs that are required to perform P2P communication (e.g., the size of data stored in the transmission buffers of the STAs). To this end, AP 1 (510) may transmit a buffer status report poll (BSRP) frame to at least one STA performing P2P communication, and may receive frames including a buffer status report (BSR) from the at least one STA. The BSR may indicate buffer information of each STA.

Specifically, the BSR may include information on P2P data to be transmitted by the STAs (e.g., the size of P2P data stored in the buffer). AP 1 (510) may transmit the P2P control frame (503) based on the BSRs of the STAs to allocate a period during which P2P communication may be performed. In an embodiment, AP 1 (510) may allocate a period during which P2P communication may be performed in order of the STA with the largest amount of P2P data to be transmitted. As another embodiment, AP 1 (510) may recognize the buffer status of the STAs based on the BSRs of the STAs, and may determine the length of the period during which P2P communication may be performed based on the buffer status information.

As a specific embodiment, AP 1 (510) may determine the length of the period during which P2P communication may be performed in proportion to the size of P2P data to be transmitted by the STAs, and may allocate the period to the STAs. Taking the foregoing into consideration, the P2P control frame (503) may include at least one of: a list of at least one STA capable of performing P2P communication; a total time period during which the STAs may perform P2P communication; an individual time period per STA during which the STAs may perform P2P communication; order information indicating the sequence in which the STAs may perform P2P communication; and other information related to P2P communication performance. In an embodiment, the P2P control frame (503) may be a multi-user request to send (MU-RTS) trigger frame. Specifically, the P2P control frame (503) may be a basic MU-RTS trigger frame or a variant MU-RTS trigger frame. As another embodiment, the P2P control frame (503) may be a variant trigger frame capable of indicating P2P communication, and may not be limited to any specific form.

Here, the P2P control frame (503) transmitted by AP 1 (510) may include user information fields of STA 1 (520), STA 2 (530), and STA 3 (540). The user information field may include at least one of association identifiers (AIDs) and MAC addresses capable of identifying STA 1 (520), STA 2 (530), and STA 3 (540). In an embodiment, the order of STAs using the P2P communication period may be determined based on the order of STAs included in the user information field. As a specific embodiment, when information on STAs is included in the user information field in the order of STA 1 (520), STA 2 (530), and STA 3 (540), the P2P communication period may be allocated in the order of STA 1 (520), STA 2 (530), and STA 3 (540). Here, the user information field may include information indicating an individual P2P communication period available to each of STA 1 (520), STA 2 (530), and STA 3 (540). The information indicating the individual P2P communication period may be P2P duration information, and the P2P duration information may be a time indicated in units of μs. Table 1 below may be an example of P2P duration information, and individual P2P durations may be indicated in the form of Example 1 and Example 2 of Table 1. Here, the total P2P communication period may be 3000 μs.

TABLE 1

Example 1
STA 1: 1000 us
STA 2: 2000 us
STA 3: 3000 us
Example 2
STA 1: 1000 us
STA 2: 1000 us
STA 3: 1000 us

In Example 1 and Example 2 of Table 1, each of STA 1 (520), STA 2 (530), and STA 3 (540) may perform P2P communication for a time period of 1000 μs. In Example 1, STA 1 (520) may be the first STA indicated in the user information field of the P2P control frame (503), and the indicated time period may be 1000 μs. STA 2 (530) may check the duration information of 1000 μs of the preceding STA, STA 1 (520), included in the user information field of the P2P control frame (503), and may check the duration information of 2000 μs indicated for STA 2 (530), thereby recognizing that the indicated time period is 1000 μs. That is, STA 2 (530) may check the end time of the individual P2P communication period of STA 1 (520) and the end time of its own individual P2P communication period to perform P2P communication for a time period of 1000 μs. In addition, STA 3 (540) may also check the end time of the individual P2P communication period of the preceding STA, STA 2 (530), which is 2000 μs, from its own individual P2P communication period end time of 3000 μs, and may perform P2P communication for 1000 μs.

On the other hand, in Example 2 of Table 1, information on the individual P2P communication period itself may be indicated to STA 1 (520), STA 2 (530), and STA 3 (540), and STA 1 (520), STA 2 (530), and STA 3 (540) may perform P2P communication during the individually indicated individual P2P communication period. STA 1 (520), STA 2 (530), and STA 3 (540) may start P2P communication after the P2P communication period of the preceding STAs has ended, and may perform P2P communication during the individually indicated P2P communication period. In an embodiment, since STA 1 (520) is the first STA allocated a P2P communication period, it does not need to consider the P2P communication periods of preceding STAs, STA 2 (530) may perform P2P communication after the P2P communication period of STA 1 (520) has ended, and STA 3 (540) may perform P2P communication after the P2P communication period of STA 2 (530) has ended.

Each of STA 1 (520), STA 2 (530), and STA 3 (540) may simultaneously transmit CTS frames (504-1, 504-2, 504-3) after receiving the P2P control frame (503). The simultaneously transmitted CTS frames may be simultaneous-CTS (S-CTS) frames. In an embodiment, the P2P control frame (503) may include a “SCRAMBLER_INITIAL_VALUE” so that the CTS frames (504-1, 504-2, 504-3) of STA 1 (520), STA 2 (530), and STA 3 (540) may be transmitted identically. Each of STA 1 (520), STA 2 (530), and STA 3 (540) may generate and transmit the CTS frames (504-1, 504-2, 504-3) based on the corresponding information in the P2P control frame (503). That is, each of STA 1 (520), STA 2 (530), and STA 3 (540) may utilize the information indicated in the P2P control frame (503) to simultaneously transmit the CTS frames (504-1, 504-2, 504-3). Each of STA 1 (520), STA 2 (530), and STA 3 (540) may perform P2P communication during the individual P2P communication period allocated to each STA. Here, when the P2P communication of each STA is shorter than the allocated individual P2P communication period, each STA may add padding (e.g., QoS Null frame, A-MPDU padding, PHY padding) to the frame for transmission in order to match the time period. P2P communication may be performed among STA 1 (520), STA 2 (530), and STA 3 (540) that responded to the polling of AP 1 (510). That is, it may be performed within the group. Alternatively, P2P communication may also be performed with WLAN terminals outside of STA 1 (520), STA 2 (530), and STA 3 (540) that responded to the polling of AP 1 (510). Depending on the P2P traffic of STA 1 (520), STA 2 (530), and STA 3 (540), P2P communication may be performed both within and outside of STA 1 (520), STA 2 (530), and STA 3 (540) that responded to the polling of AP 1 (510).

As another embodiment, STA 1 (520), STA 2 (530), and STA 3 (540) may not be able to transmit frames during each P2P communication period. When no communication is detected for a certain duration (e.g., a PIFS duration) during the P2P communication period, AP 1 (510) may retransmit the P2P control frame (503) to reallocate the P2P communication period. Through the foregoing, delays and inefficiencies due to channel access in the P2P operation of a plurality of STAs may be reduced. Meanwhile, STAs may need to perform a channel access operation to perform P2P communication according to the information indicated in the P2P control frame (503). The channel access operation may be performed using minimized EDCA parameters (e.g., CWmin[AC], CWmax[AC], AIFSN[AC]). The minimized EDCA parameters may be obtained through a beacon frame transmitted by AP 1 (510). The minimized EDCA parameters may have values smaller than those of the normal EDCA parameters. In an embodiment, when channel access is performed using minimized EDCA parameters in which CWmin[AC] and CWmax[AC] are set to values smaller than CWmin[AC] and CWmax[AC] of the normal EDCA parameters, the channel access time may be shorter than when channel access is performed using the normal EDCA parameters.

In addition, In an embodiment, when AP 1 (510) selects target STAs (e.g., STA 1, STA 2, STA 3) to which frames are to be transmitted for the P2P communication period allocation, AP 1 (510) may use the machine learning unit and machine learning algorithm of FIG. 3 and FIG. 4. In an embodiment, AP 1 (510) may always receive buffer status reports (BSRs) from STAs and may check queue information for data to be transmitted by the STAs. That is, AP 1 (510) may be aware of P2P traffic information of the STAs. Alternatively, AP 1 (510) may overhear the traffic information of the STAs. AP 1 (510) may monitor the RA and TA fields of frames transmitted by the STAs, and may determine whether the STAs are performing P2P communication. Additionally, a machine learning algorithm may infer information such as the P2P communication cycle and duration of the STAs. AP 1 (510) may use the information as input to a machine learning algorithm (e.g., deep reinforcement learning (DRL)). That is, AP 1 (510) may utilize the traffic information as a state obtained from the environment of the DRL algorithm. The operation of AP 1 (510) of “scheduling P2P communication periods to STAs” is regarded as an action of the DRL algorithm. That is, AP 1 (510) may schedule P2P communication periods. More specifically, the operation of AP 1 (510) of allocating P2P communication periods to specific STAs within the P2P communication period and adjusting the length of the P2P communication period of specific STAs may constitute an action. In addition, AP 1 (510) may schedule frames to the STAs and subsequently collect traffic information. The collected traffic information of AP 1 (510) may be regarded as a reward of the DRL algorithm. AP 1 (510) may train the agent of AP 1 (510) (i.e., the agent of the DRL algorithm) in a direction that maximizes the reward. Here, maximizing the reward may mean appropriate scheduling of traffic, and AP 1 (510) may perform optimal multi-user P2P scheduling operations (e.g., selection of the optimal STA to be scheduled and selection of the P2P communication period duration).

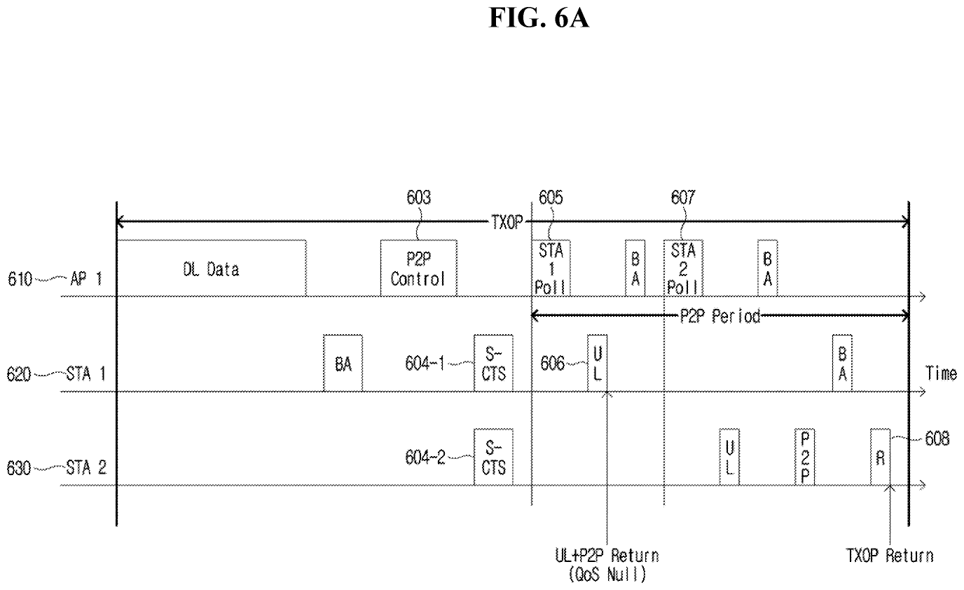

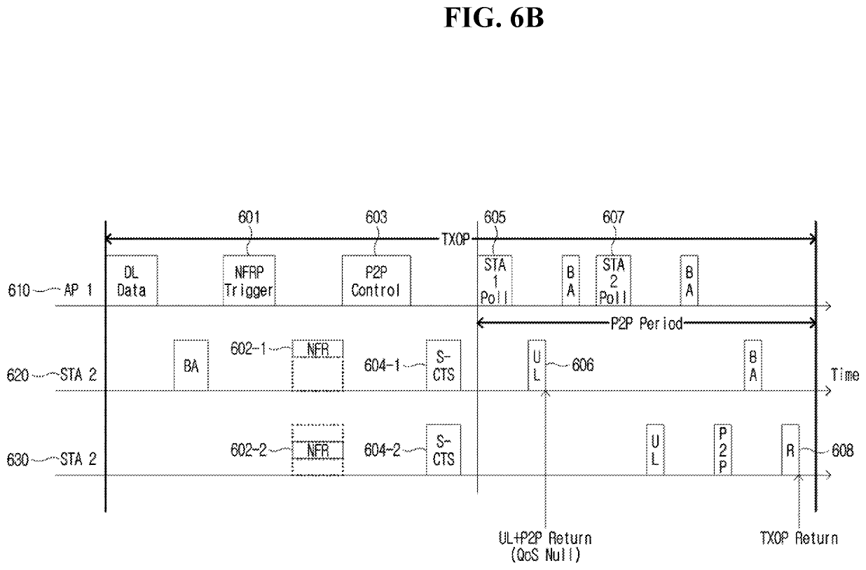

FIG. 6A and FIG. 6B are diagrams illustrating a multi-user direct communication method in a wireless LAN.

Referring to FIG. 6A and FIG. 6B, an environment in which AP 1 (610), STA 1 (620), STA 2 (630), and STA 3 (640) operate in a wireless LAN network may be considered. However, this is for convenience of explanation only and is not limited thereto, and the same may be equally applicable to other cases. AP 1 (610) may perform an Enhanced Distributed Channel Access (EDCA) backoff, and may transmit a frame upon successfully completing the backoff and occupying the channel. In the EDCA backoff procedure, EDCA functions (EDCAFs) associated with each access category (AC) (e.g., AC_VO EDCAF, AC_VI EDCAF, AC_BE EDCAF, AC_BK EDCAF) may determine a random backoff counter value, and the EDCAFs may decrement the backoff counter. When the backoff counter reaches zero, the EDCAF may perform frame transmission at the slot boundary at which the backoff counter reaches zero. When the EDCAF of AP 1 (610) determines frame transmission, an EDCA transmission opportunity (TXOP) may be granted to the EDCAF of AP 1 (610). The TXOP may be a time period during which an AP (or STA) may transmit one or more frames.

AP 1 (610) may transmit downlink data (e.g., downlink frames) to STAs (STA 1 through STA 3) within the TXOP. In an embodiment, AP 1 (610) may transmit a downlink frame to STA 1 (620) within the TXOP. As another embodiment, AP 1 (610) may transmit a clear to send (CTS) frame instead of transmitting a downlink frame to STA 1 (620). The CTS frame transmitted by AP 1 (610) may be a CTS-to-Self frame in which the receiver address (RA) is set to the medium access control (MAC) address of AP 1 (610).

After AP 1 (610) transmits a downlink frame to STA 1 (620), AP 1 (610) may allocate a period within the TXOP of AP 1 (610) during which STAs may perform peer-to-peer (P2P) communication. As another embodiment, AP 1 (610) may allocate a period during which P2P communication may be performed without transmitting a downlink frame within the TXOP, and the present disclosure may not be limited to any specific form. Here, P2P communication may refer to direct communication in which STAs communicate directly with one another.

Referring to FIG. 6B, AP 1 (610) may perform a polling operation to determine which STAs will perform P2P operation prior to allocating the P2P communication period. In an embodiment, AP 1 (610) may perform an NDP (Null Data PPDU) Feedback Report Poll (NFRP) operation, but the present disclosure may not be limited thereto. However, in the following description, the NFRP is used as a reference for convenience of explanation.

Here, AP 1 (610) may transmit an NFRP trigger frame (601) to STA 1 (620) and STA 2 (630). STA 1 (620) and STA 2 (630) may intend to perform P2P communication, and each of STA 1 (620) and STA 2 (630) may transmit an NDP feedback report (NFR) (602-1, 602-2) to AP 1 (610) after a SIFS duration in response to the NFRP trigger frame (601) of AP 1 (610). Here, the NFRs (602-1, 602-2) transmitted by each of STA 1 (620) and STA 2 (630) may be transmitted on tones allocated per association ID (AID) of orthogonal frequency division multiple access (OFDMA). That is, each of STA 1 (620) and STA 2 (630) may perform NFR (602-1, 602-2) transmission on tones allocated based on the AID. In an embodiment, among the STAs that received the NFRP trigger frame (601), a STA that will not perform P2P communication during the P2P communication period allocated by the AP may not transmit a response to the NFRP trigger frame (601), but the present disclosure may not be limited thereto.

In an embodiment, a tone may be an OFDMA subcarrier. AP 1 (610) may receive the NFRs (602-1, 602-2) from each of STA 1 (620) and STA 2 (630), and may recognize that STA 1 (620) and STA 2 (630) intend to perform P2P communication. Through the foregoing, AP 1 (610) may identify the STAs to which the P2P communication period should be allocated. That is, after transmitting the NFRP trigger frame (601) to at least one STA, AP 1 (610) may recognize STAs that did not transmit an NFR in response thereto as STAs that will not perform P2P communication. AP 1 (610) may identify STAs that will perform P2P operation and form a group among STAs performing P2P communication.

Referring to FIG. 6A and FIG. 6B, AP 1 (610) may transmit a P2P control frame (603) to allocate a period during which STA 1 (620) and STA 2 (630) may perform P2P communication. Prior to transmitting the P2P control frame (603), AP 1 (610) may check the traffic conditions of the STAs that are required to perform P2P communication (e.g., the size of data stored in the transmission buffers of the STAs). To this end, AP 1 (610) may transmit a buffer status report poll (BSRP) frame to at least one STA performing P2P communication, and may receive frames including a buffer status report (BSR) from the at least one STA. In an embodiment, the BSR may indicate buffer information of each STA. Specifically, the BSR may include information on P2P data to be transmitted by the STAs (e.g., the size of P2P data stored in the buffer). AP 1 (610) may transmit the P2P control frame (603) based on the BSRs of the STAs to allocate a period during which P2P communication may be performed. In an embodiment, AP 1 (610) may allocate a period during which P2P communication may be performed in order of the STA with the largest amount of P2P data to be transmitted. In addition, AP 1 (610) may recognize the buffer status of the STAs based on the BSRs of the STAs, and may determine the length of the period during which P2P communication may be performed based thereon.

As a specific embodiment, AP 1 (610) may determine the length of the period during which P2P communication may be performed in proportion to the size of P2P data to be transmitted by the STAs, and may allocate the period to the STAs. Taking the foregoing into consideration, the P2P control frame (603) may include at least one of: a list of at least one STA capable of performing P2P communication; a total time period during which the STAs may perform P2P communication; an individual time period per STA during which the STAs may perform P2P communication; order information indicating the sequence in which the STAs may perform P2P communication; and other information related to P2P communication performance. In an embodiment, the P2P control frame (603) may be a multi-user request to send (MU-RTS) trigger frame. Specifically, the P2P control frame (603) may be a basic MU-RTS trigger frame or a variant MU-RTS trigger frame. As another embodiment, the P2P control frame (603) may be a variant trigger frame capable of indicating P2P communication, and may not be limited to any specific form.

Here, the P2P control frame (603) transmitted by AP 1 (610) may include user information fields of STA 1 (620) and STA 2 (630). The user information field may include at least one of association identifiers (AIDs) and MAC addresses capable of identifying STA 1 (620) and STA 2 (630). As another embodiment, the user information field may not indicate a specific STA. That is, the user information field may include at least one broadcast AID.

Each of STA 1 (620) and STA 2 (630) may simultaneously transmit CTS frames (604-1, 604-2) after receiving the P2P control frame (603). The simultaneously transmitted CTS frames may be simultaneous-CTS (S-CTS) frames. In an embodiment, the P2P control frame (603) may include a SCRAMBLER_INITIAL_VALUE so that the CTS frames (604-1, 604-2) of STA 1 (620) and STA 2 (630) may be transmitted identically. Each of STA 1 (620) and STA 2 (630) may generate and transmit the CTS frames (604-1, 604-2) based on the corresponding information. That is, each of STA 1 (620) and STA 2 (630) may utilize the information indicated in the P2P control frame (603) to simultaneously transmit the CTS frames (604-1, 604-2).

After the CTS frames (604-1, 604-2) are transmitted, AP 1 (610) may transmit a poll frame (605) to STA 1 (620). In an embodiment, the poll frame (605) may be a trigger frame. As another embodiment, the poll frame (605) may be a quality of service (QoS) Null frame or a QoS data frame. Here, the poll frame (605) may be a frame in which the RDG/MorePPDU (Reverse Direction Grant/More Physical Protocol Data Units) bit of the CAS (command and status) control field included in the HT (high throughput) control field of the frame MAC header of the poll frame (605) is set to 1. The CAS control field may be included in the HT control field in the form of A-control. As another embodiment, the RDG/MorePPDU bit may be included in the HT control field. Here, the RDG/MorePPDU bit may be a bit indicating at least one of whether reverse direction communication is granted or whether additional data exists. In an embodiment, the poll frame (605) may be a frame that permits the receiver of the poll frame to perform reverse direction (RD) communication. As another embodiment, the poll frame (605) may be a contention free (CF)-poll frame, a variation of a CF-poll frame, a QoS CF poll frame, or a QoS data+CF poll frame, but the present disclosure may not be limited to such embodiments. Here, the QoS CF poll frame may be a frame in which the frame subtype (1110 in B7-B4 bit order) is set differently from the frame subtype of the QoS Null frame (1100 in B7-B4 bit order). In addition, the QoS data+CF poll frame may be a frame in which the frame subtype (1010 in B7-B4 bit order) is set differently from the frame subtype of the QoS data frame (1000 in B7-B4 bit order), but is not limited to such embodiments.

The poll frame (605) may indicate an individual time period during which STA 1 (620) may use the P2P communication period. STA 1 (620) may transmit at least one of an uplink frames and a P2P frame within the individual time period. In an embodiment, STA 1 (620) may transmit an uplink frame (606) to AP 1 (610) after receiving the poll frame (605). Here, the uplink frame (606) may include an indicator that STA 1 (620) is returning the individual P2P communication period. In an embodiment, the indicator indicating the return of the individual P2P communication period may be the more PPDU bit of the HT control field (e.g., CAS (command and status) control) included in the MAC header. As another embodiment, the indicator indicating the return of the individual P2P communication period may be another bit of the CAS control (e.g., a reserved bit), and may not be limited to any specific form.

AP 1 (610) may receive the uplink frame (606) from STA 1 (620) and transmit a BA frame to STA 1 (620) in response thereto. Thereafter, AP 1 (610) may transmit a poll frame (607) indicating the individual P2P communication period to STA 2 (630). STA 2 (630) may transmit at least one of an uplink frame and a P2P frame within the individual P2P communication period. When STA 2 (630) has completed communication, STA 2 (630) may transmit a return frame (608) to AP 1 (610). The return frame (608) may include an indicator that STA 2 (630) is returning the individual P2P communication period. In an embodiment, the return frame (608) may be a QoS Null frame, a QoS data frame, or another form of action frame, and may not be limited to any specific form. In addition, In an embodiment, the indicator indicating the return of the individual P2P communication period may be the more PPDU bit of the HT control field (e.g., CAS (command and status) control) included in the MAC header. As another embodiment, the indicator indicating the return of the individual P2P communication period may be other bits of the CAS control (e.g., reserved bits). Alternatively, STA 2 (630) may not return the individual P2P communication period. STA 2 (630) may use the entire individual P2P communication period to perform at least one of uplink frame transmission and P2P frame transmission.

In addition, In an embodiment, the return frame (608) transmitted by at least one of STA 1 (620) and STA 2 (630) may be a CF-ACK frame. Here, the CF-ACK frame may be an indicator indicating the return of the individual communication period. At least one of STA 1 (620) and STA 2 (630) may transmit a QoS data frame and a return frame as a single frame. As a specific embodiment, when at least one of STA 1 (620) and STA 2 (630) receives the poll frame of AP 1 (610), the at least one of STA 1 (620) and STA 2 (630) may transmit a single frame including a QoS data frame and a CF-ACK frame in response to the poll frame. Here, the subtype (1001 in B7-B4 bit order) of the single frame including the QoS data frame and the CF-ACK frame may differ from the subtype of the QoS data frame.

Alternatively, when at least one of STA 1 (620) and STA 2 (630) receives the poll frame of AP 1 (610), the at least one of STA 1 (620) and STA 2 (630) may construct and transmit an aggregated MAC protocol data unit (A-MPDU) including a data frame and a return frame. Through the methods, delays and inefficiencies due to channel access when a plurality of STAs perform P2P operation may be reduced.

P2P communication may be performed among STA 1 (620), STA 2 (630), and STA 3 (640) that responded to the polling of AP 1 (610). That is, it may be performed within the group. Alternatively, P2P communication may also be performed with WLAN terminals outside of STA 1 (620), STA 2 (630), and STA 3 (640) that responded to the polling of AP 1 (610). Depending on the P2P traffic of STA 1 (620), STA 2 (630), and STA 3 (640), P2P communication may be performed both within and outside of STA 1 (620), STA 2 (630), and STA 3 (640) that responded to the polling of AP 1 (610).

In addition, In an embodiment, when AP 1 (610) selects target STAs (e.g., STA 1, STA 2, STA 3) to which frames are to be transmitted for the P2P communication period allocation, AP 1 (610) may use the machine learning unit and machine learning algorithm of FIG. 3 and FIG. 4. In an embodiment, AP 1 (610) may always receive buffer status reports (BSRs) from STAs and may check queue information for data to be transmitted by the STAs. That is, AP 1 (610) may be aware of P2P traffic information of the STAs. Alternatively, AP 1 (610) may overhear the traffic information of the STAs. AP 1 (610) may monitor the RA and TA fields of frames transmitted by the STAs, and may determine whether the STAs are performing P2P communication. Additionally, a machine learning algorithm may infer information such as the P2P communication cycle and duration of the STAs. AP 1 (610) may use the information as input to a machine learning algorithm (e.g., deep reinforcement learning (DRL)). That is, AP 1 (610) may utilize the traffic information as a state obtained from the environment of the DRL algorithm. The operation of AP 1 (610) of “scheduling P2P communication periods to STAs” is regarded as an action of the DRL algorithm. That is, AP 1 (610) may schedule P2P communication periods. More specifically, the operation of AP 1 (610) of allocating P2P communication periods to specific STAs within the P2P communication period and adjusting the length of the P2P communication period of specific STAs may constitute an action. In addition, AP 1 (610) may schedule frames to the STAs and subsequently collect traffic information. The collected traffic information of AP 1 (610) may be regarded as a reward of the DRL algorithm. AP 1 (610) may train the agent of AP 1 (610) (i.e., the agent of the DRL algorithm) in a direction that maximizes the reward. Here, maximizing the reward may mean appropriate scheduling of traffic, and AP 1 (610) may perform optimal multi-user P2P scheduling operations (e.g., selection of the optimal STA to be scheduled and selection of the P2P communication period duration). In addition, the above-described operation may be as follows. Specifically, a STA may perform a polling operation to allocate a partial time interval within a TXOP to at least one STA. The at least one polling STA to be allocated the partial time interval within the TXOP may be determined based on the polling operation. The STA may transmit a trigger frame for allocating the partial time interval to the at least one polling STA, and may allocate the partial time interval within the TXOP acquired by the STA to the at least one polling STA based on the trigger frame. More specifically, the STA transmits a first frame to the at least one STA, and receives a response frame for the first frame from the at least one polling STA that is allocated the partial time interval within the TXOP acquired by the STA. At this point, a request for allocation of the partial time interval by the at least one polling STA is performed based on the response frame. The STA transmits the first frame based on identification information for the at least one STA. The STA does not receive the response frame from a STA among the at least one STA that is not allocated the partial time interval within the TXOP acquired by the STA, and the partial time interval is allocated by the STA only to a STA that transmits the response frame.

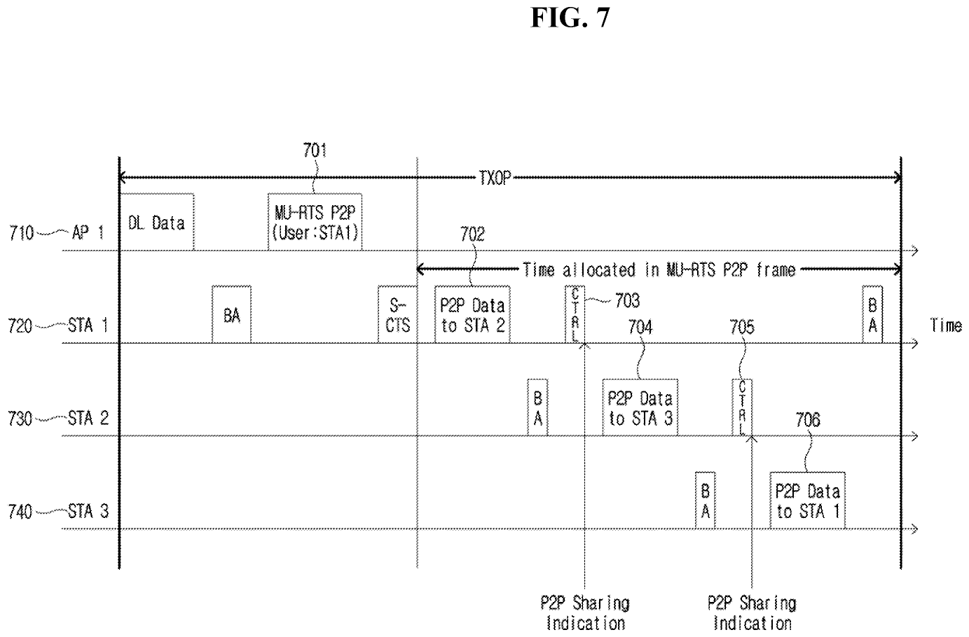

FIG. 7 is a diagram illustrating a multi-user direct communication method in a wireless LAN to which the present disclosure is applied. Referring to FIG. 7, an environment in which AP 1 (710), STA 1 (720), STA 2 (730), and STA 3 (740) operate in a wireless LAN network may be considered. However, this is for convenience of explanation only and is not limited thereto, and the same may be equally applicable to other cases. AP 1 (710) may perform an Enhanced Distributed Channel Access (EDCA) backoff, and may transmit a frame upon successfully completing the backoff and occupying the channel. In the EDCA backoff procedure, EDCA functions (EDCAFs) associated with each access category (AC) (e.g., AC_VO EDCAF, AC_VI EDCAF, AC_BE EDCAF, AC_BK EDCAF) may determine a random backoff counter value, and the EDCAFs may decrement the backoff counter. When the backoff counter reaches zero, the EDCAF may perform frame transmission at the slot boundary at which the backoff counter reaches zero. When the EDCAF of AP 1 (710) determines frame transmission, an EDCA transmission opportunity (TXOP) may be granted to the EDCAF of AP 1 (710). The TXOP may be a time period during which an AP (or STA) may transmit one or more frames.

AP 1 (710) may transmit downlink data (e.g., downlink frames) to STAs (STA 1 through STA 3) within the TXOP. In an embodiment, AP 1 (710) may transmit a downlink frame to STA 1 (720) within the TXOP. As another embodiment, AP 1 (710) may transmit a clear to send (CTS) frame instead of transmitting a downlink frame to STA 1 (720). The CTS frame transmitted by AP 1 (710) may be a CTS-to-Self frame in which the receiver address (RA) is set to the medium access control (MAC) address of AP 1 (710).

After AP 1 (710) transmits a downlink frame to STA 1 (720), AP 1 (710) may allocate a period within the TXOP of AP 1 (710) during which STAs may perform peer-to-peer (P2P) communication. As another embodiment, AP 1 (710) may allocate a period during which P2P communication may be performed without transmitting a downlink frame within the TXOP, and the present disclosure may not be limited to any specific form. Here, P2P communication may refer to direct communication in which STAs communicate directly with one another.

Here, AP 1 (710) may transmit a multi-user request to send (MU-RTS) P2P control frame to allocate a period during which P2P communication may be performed. In an embodiment, the MU-RTS P2P control frame may be a variant of an MU-RTS trigger frame. Prior to transmitting the MU-RTS P2P control frame, AP 1 (710) may transmit a buffer status report poll (BSRP) frame to check the traffic conditions of the STAs that are required to perform P2P communication (e.g., the size of data stored in the transmission buffers of the STAs), and may receive frames including a buffer status report (BSR) from the STAs. The BSR may indicate buffer information of each STA. The BSR may include information on P2P data to be transmitted by the STAs (e.g., the size of P2P data stored in the buffer). Based on the BSRs of the STAs, AP 1 (710) may determine the STA to which a period enabling P2P communication should be allocated via the MU-RTS P2P control frame (701). The MU-RTS P2P control frame (701) includes at least one of: an indicator capable of identifying one STA that may perform P2P communication (e.g., at least one of an AID and a MAC address); a time period during which the STA may perform P2P communication; and an indicator indicating whether the P2P communication period may be shared. In an embodiment, the MU-RTS P2P control frame (701) transmitted by AP 1 (710) may include a user information field capable of identifying STA 1 (720). The user information field may include information indicating an individual P2P communication period available to STA 1 (720). In an embodiment, the information indicating the individual P2P communication period available to STA 1 (720) may be P2P duration information. The P2P duration information may be a time indicated in units of μs, but is not limited to such embodiments. In addition, in relation to the above-described operation, the MU-RTS P2P control frame may be a trigger frame, and the trigger frame may include identification information representing a P2P group and information on a partial time interval allocated to the P2P group. Here, a duration field of the trigger frame may be set to a value obtained by adding a transmission time of the response frame and a short interframe space (SIFS). Furthermore, the trigger frame may further include the identification information representing the P2P group and information indicating whether the partial time interval allocated to the P2P group is sharable with at least one other STA within the P2P group. Additionally, a request frame for requesting TXOP sharing for the P2P group may be received before the transmission of the trigger frame, and the request frame may include information identifying the P2P group; however, the operation is not limited thereto.

In addition, the user information field may include information indicating whether STA 1 (720) may share the P2P communication period with other STAs. In an embodiment, when STA 1 (720) is instructed based on the user information field to share the P2P communication period with other STAs, STA 1 (720) may allocate a period within the P2P communication period during which at least one of STA 2 (730) and STA 3 (740) may perform transmission. In an embodiment, STA 1 (720), STA 2 (730), and STA 3 (740) may form one P2P group, and STA 1 (720) may be the leader STA of the P2P group. STA 1 (720) may convey information on other STAs within the P2P group to AP 1 (710). In an embodiment, the information on other STAs within the P2P group may be ID information of STAs within the P2P group or other information. As the leader of the P2P group, STA 1 (720) may be allocated a P2P communication period from AP 1 (710) and may share it with other STAs, and the present disclosure may not be limited to any specific embodiment.

AP 1 (710) may allocate a P2P communication period to STA 1 (720) and may enable STA 1 (720) to share the period. In an embodiment, STA 1 (720) may transmit a P2P data frame (702) to STA 2 (730) during the P2P communication period. In addition, STA 1 (720) may share the P2P communication period with STA 2 (730). STA 1 (720) may transmit a P2P communication period sharing indication frame (e.g., CTRL frame, 703) to share the P2P communication period with STA 2 (730). As another embodiment, the P2P communication period sharing indication frame (703) may be a QoS Null frame. The QoS Null frame may set the RDG bit of the HT control field (e.g., CAS control) included in the MAC header to 1, thereby indicating the sharing of the P2P communication period to another STA. However, this is merely one embodiment and may not be limited thereto, and in FIG. 7, the CTRL frame (703) is used as a reference for convenience of explanation.

When STA 2 (730) receives the P2P communication period sharing indication frame from STA 1 (720), STA 2 (730) may transmit a frame with the more PPDU bit of the MAC header set to 1 to STA 1 (720). As another embodiment, STA 2 (730) may immediately use the period shared by STA 1 (720) without transmitting a separate frame to STA 1 (720). STA 2 (730) may transmit a P2P data frame (704) to STA 3 (740) within the period shared by STA 1 (720). STA 2 (730) may in turn share the P2P communication period with STA 3 (740). This may be performed based on the same or similar procedure as the method by which STA 1 (720) shares the P2P communication period with STA 2 (730). That is, STA 2 (730) may transmit a P2P communication period sharing indication frame (705) to STA 3 (740) to share the P2P communication period shared by STA 1 (720). STA 3 (730) may transmit a P2P frame (706) to STA 1 (720) within the shared period.

As another embodiment, as the leader STA of the P2P group, STA 1 (720) may indicate the sharing of the P2P communication period with STA 3 (740). In an embodiment, STA 1 (720) may overhear the response frame transmitted by STA 3 (740) in response to the P2P data frame (704) transmitted by STA 2 (730) to STA 3 (740) within the period shared by STA 1 (720), and thereafter STA 1 (720) may transmit a P2P communication period sharing indication frame to STA 3 (740) to enable STA 3 (740) to share the P2P communication period shared by STA 1 (720), but the present disclosure is not limited to such embodiments.

Instead of transmitting a frame immediately (e.g., after a SIFS or PIFS duration) upon receiving the communication period sharing indication frame, the STA may need to perform a channel access operation (e.g., EDCA backoff). A STA that receives the communication period sharing indication frame and successfully completes the channel access operation may transmit a P2P frame. The channel access operation may be performed using minimized EDCA parameters (e.g., CWmin[AC], CWmax[AC], AIFSN[AC]). The minimized EDCA parameters may be obtained through a beacon frame transmitted by AP 1 (710). The minimized EDCA parameters may have values smaller than the normal EDCA parameter values; In an embodiment, when channel access is performed using minimized EDCA parameters in which CWmin[AC] and CWmax[AC] are set to values smaller than CWmin[AC] and CWmax[AC] of the normal EDCA parameters, the channel access time may be shorter than when channel access is performed using the normal (or default) EDCA parameters.

P2P communication may be performed among STA 1 (720), STA 2 (730), and STA 3 (740) constituting the P2P group. Depending on the P2P traffic of STA 1 (720), STA 2 (730), and STA 3 (740), P2P communication may be performed both within and outside the P2P group.

In addition, In an embodiment, when AP 1 (710) selects target STAs (e.g., STA 1, STA 2, STA 3) to which frames are to be transmitted for the aforementioned P2P communication period allocation, AP 1 (710) may use the machine learning unit and machine learning algorithm of FIG. 3 and FIG. 4. In an embodiment, AP 1 (710) may always receive buffer status reports (BSRs) from STAs and may check queue information for data to be transmitted by the STAs. That is, AP 1 (710) may be aware of P2P traffic information of the STAs. Alternatively, AP 1 (710) may overhear the traffic information of the STAs. AP 1 (710) may monitor the RA and TA fields of frames transmitted by the STAs, and may determine whether the STAs are performing P2P communication. Additionally, a machine learning algorithm may infer information such as the P2P communication cycle and duration of the STAs. AP 1 (710) may use the information as input to a machine learning algorithm (e.g., deep reinforcement learning (DRL)). That is, AP 1 (710) may utilize the traffic information as a state obtained from the environment of the DRL algorithm. The operation of AP 1 (710) of “scheduling P2P communication periods to STAs” is regarded as an action of the DRL algorithm. That is, AP 1 (710) may schedule P2P communication periods. More specifically, the operation of AP 1 (710) of allocating P2P communication periods to specific STAs within the P2P communication period and adjusting the length of the P2P communication period of specific STAs may constitute an action. In addition, AP 1 (710) may schedule frames to the STAs and subsequently collect traffic information. The collected traffic information of AP 1 (710) may be regarded as a reward of the DRL algorithm. AP 1 (710) may train the agent of AP 1 (710) (i.e., the agent of the DRL algorithm) in a direction that maximizes the reward. Here, maximizing the reward may mean appropriate scheduling of traffic, and AP 1 (710) may perform optimal multi-user P2P scheduling operations (e.g., selection of the optimal STA to be scheduled and selection of the P2P communication period duration).

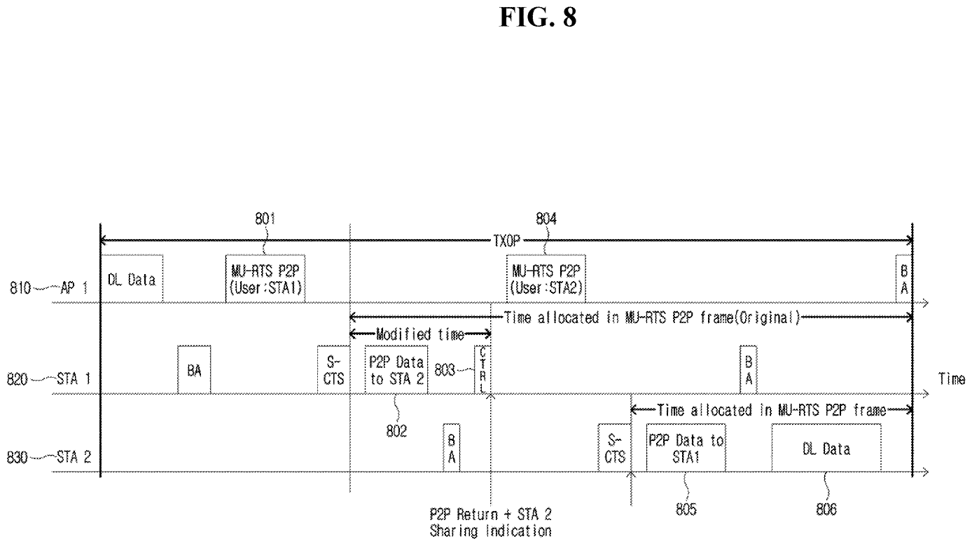

FIG. 8 is a diagram illustrating a multi-user direct communication method in a wireless LAN to which the present disclosure is applied. Referring to FIG. 8, an environment in which AP 1 (810), STA 1 (820), and STA 2 (830) operate in a wireless LAN network may be considered. However, this is for convenience of explanation only and is not limited thereto, and the same may be equally applicable to other cases.

AP 1 (810) may perform an Enhanced Distributed Channel Access (EDCA) backoff, and may transmit a frame upon successfully completing the backoff and occupying the channel. In the EDCA backoff procedure, EDCA functions (EDCAFs) associated with each access category (AC) (e.g., AC_VO EDCAF, AC_VI EDCAF, AC_BE EDCAF, AC_BK EDCAF) may determine a random backoff counter value, and the EDCAFs may decrement the backoff counter. When the backoff counter reaches zero, the EDCAF may perform frame transmission at the slot boundary at which the backoff counter reaches zero. When the EDCAF of AP 1 (810) determines frame transmission, an EDCA transmission opportunity (TXOP) may be granted to the EDCAF of AP 1 (810). The TXOP may be a time period during which an AP (or STA) may transmit one or more frames.

AP 1 (810) may transmit downlink data (e.g., downlink frames) to STAs (STA 1 through STA 3) within the TXOP. In an embodiment, AP 1 (810) may transmit a downlink frame to STA 1 (820) within the TXOP. As another embodiment, AP 1 (810) may transmit a clear to send (CTS) frame instead of transmitting a downlink frame to STA 1 (820). The CTS frame transmitted by AP 1 (810) may be a CTS-to-Self frame in which the receiver address (RA) is set to the medium access control (MAC) address of AP 1 (810).

After AP 1 (810) transmits a downlink frame to STA 1 (820), AP 1 (810) may allocate a period within the TXOP of AP 1 (810) during which STAs may perform peer-to-peer (P2P) communication. As another embodiment, AP 1 (810) may allocate a period during which P2P communication may be performed without transmitting a downlink frame within the TXOP, and the present disclosure may not be limited to any specific form. Here, P2P communication may refer to direct communication in which STAs communicate directly with one another.

Here, AP 1 (810) may transmit a multi-user request to send (MU-RTS) P2P control frame (801) to allocate a period during which P2P communication may be performed. In an embodiment, the MU-RTS P2P control frame (801) may be a variant of an MU-RTS trigger frame. Prior to transmitting the MU-RTS P2P control frame (801), AP 1 (810) may transmit a buffer status report poll (BSRP) frame to check the traffic conditions of the STAs that are required to perform P2P communication (e.g., the size of data stored in the transmission buffers of the STAs), and may receive frames including a buffer status report (BSR) from the STAs. The BSR may indicate buffer information of each STA. The BSR may include information on P2P data to be transmitted by the STAs (e.g., the size of P2P data stored in the buffer). Based on the BSRs of the STAs, AP 1 (810) may transmit the MU-RTS P2P control frame (801) to the STAs to which a period enabling P2P communication should be allocated. The MU-RTS P2P control frame (801) includes at least one of: an indicator capable of identifying one STA that may perform P2P communication (e.g., at least one of an AID and a MAC address); a time period during which the STA may perform P2P communication; and an indicator indicating whether the P2P communication period may be shared. In an embodiment, the MU-RTS P2P control frame (801) transmitted by AP 1 (810) may include a user information field capable of identifying STA 1 (820). The user information field may include information indicating an individual P2P communication period available to STA 1 (820). In an embodiment, the information indicating the individual P2P communication period available to STA 1 (820) may be P2P duration information. The P2P duration information may be a time indicated in units of μs, but is not limited to such embodiments.

AP 1 (810) may allocate a P2P communication period to STA 1 (820). STA 1 (820) may transmit a P2P data frame (805) to STA 2 (830) during the P2P communication period. Thereafter, when STA 1 (820) has completed transmission of the P2P data frame (805), STA 1 (820) may enable STA 2 (830) to perform P2P operation. Here, a P2P communication period sharing indication frame (e.g., CTRL frame, 803) may be transmitted to enable STA 2 (830) to perform P2P transmission. The P2P communication period sharing indication frame (803) may be a QoS Null frame, and the QoS Null frame may set the RDG bit of the HT control field (e.g., CAS control) included in the MAC header to 1, thereby indicating the sharing of the P2P communication period to another STA. Additionally, the QoS Null frame may include at least one of: information capable of identifying STA 2 (830) (e.g., at least one of an AID and a MAC address); and P2P resource information required by STA 2 (830) (e.g., time duration, access category, delay bound).

When AP 1 (810) receives the P2P communication period sharing indication frame (803) transmitted by STA 1 (820), AP 1 (810) may terminate the P2P communication period of STA 1 (820). Thereafter, AP 1 (810) may check the information of STA 2 (830) included in the P2P communication period sharing indication frame (803), and may transmit an MU-RTS P2P control frame (804) to STA 2 (830). STA 2 (830) may transmit a P2P data frame (805) to STA 1 (820) during the P2P communication period indicated by the MU-RTS P2P control frame (804), and may transmit an uplink data frame (806) to AP 1 (810). Through the aforementioned methods, delays and inefficiencies due to channel access when a plurality of STAs perform P2P operation may be reduced.

In addition, In an embodiment, when AP 1 (810) and STA 1 (820) select target STAs (e.g., STA 1, STA 2) to which frames are to be transmitted for the P2P communication period allocation, AP 1 (810) and STA 1 (820) may use the machine learning unit and machine learning algorithm of FIG. 3 and FIG. 4. In an embodiment, AP 1 (810) and STA 1 (820) may always receive buffer status reports (BSRs) from STAs and may check queue information for data to be transmitted by the STAs. That is, AP 1 (810) and STA 1 (820) may be aware of P2P traffic information of the STAs. Alternatively, AP 1 (810) may overhear the traffic information of the STAs. AP 1 (810) and STA 1 (820) may monitor the RA and TA fields of frames transmitted by the STAs, and may determine whether the STAs are performing P2P communication.

Additionally, a machine learning algorithm may infer information such as the P2P communication cycle and duration of the STAs. AP 1 (810) and STA 1 (820) may use the information as input to a machine learning algorithm (e.g., deep reinforcement learning (DRL)). That is, AP 1 (810) and STA 1 (820) may utilize the traffic information as a state obtained from the environment of the DRL algorithm. The operation of AP 1 (810) and STA 1 (820) of “scheduling P2P communication periods to STAs” is regarded as an action of the DRL algorithm. That is, AP 1 (810) and STA 1 (820) may schedule P2P communication periods. More specifically, the operation of AP 1 (810) and STA 1 (820) of allocating P2P communication periods to specific STAs within the P2P communication period and adjusting the length of the P2P communication period of specific STAs may constitute an action. In addition, AP 1 (810) and STA 1 (820) may schedule frames to the STAs and subsequently collect traffic information. The collected traffic information of AP 1 (810) and STA 1 (820) may be regarded as a reward of the DRL algorithm. AP 1 (810) and STA 1 (820) may train the agents of AP 1 (810) and STA 1 (820) (i.e., the agents of the DRL algorithm) in a direction that maximizes the reward. Here, maximizing the reward may mean appropriate scheduling of traffic, and AP 1 (810) and STA 1 (820) may perform optimal multi-user P2P scheduling operations (e.g., selection of the optimal STA to be scheduled and selection of the P2P communication period duration).

In an embodiment, WLAN terminals in a wireless LAN network may support TXOP sharing. However, the detailed operations of TXOP sharing in the TXOP sharing operation may not be defined. Here, the conventional TXOP sharing operation may be performed in a unidirectional manner. Accordingly, in order to transmit data bidirectionally, a plurality of channel access procedures must be performed, and the TXOP sharing operation in a WLAN may be inefficient due to delays caused by the channel access procedure. A method for improving this is described below.

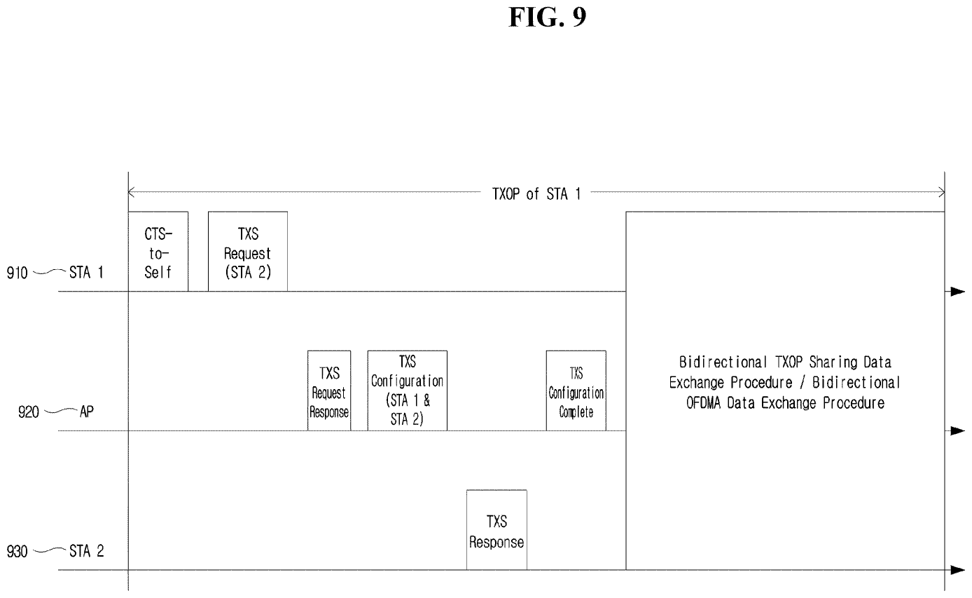

FIG. 9 is a diagram illustrating a bidirectional TXOP sharing configuration method in a wireless LAN to which the present disclosure is applied. Referring to FIG. 9, an AP and WLAN terminals connected to the AP may operate in a wireless LAN network. The WLAN terminals connected to the AP may be non-AP STA 1 and non-AP STA 2. Non-AP STA 1 and non-AP STA 2 are referred to as STA 1 (910) and STA 2 (930), respectively. STA 1 (910) and STA 2 (930) may perform data communication (e.g., uplink data communication, downlink data communication) with the AP (920). The AP (920), STA 1 (910), and STA 2 (930) may operate on the same wireless LAN channel. The same wireless LAN channel may refer to the same wireless LAN link. That is, the AP (920), STA 1 (910), and STA 2 (930) may operate on the same wireless LAN link. STA 1 (910) performs a channel access operation on the wireless LAN channel. The channel access operation is an enhanced distributed channel access (EDCA) backoff operation. The EDCA backoff operation may also be referred to as a backoff operation or procedure. In the backoff operation, EDCA functions (EDCAFs) for each access category (AC) may select a backoff counter within a contention window prior to transmitting a frame, and may decrement the backoff counter at a slot boundary prior to transmitting a frame. The EDCAF performs frame transmission at the slot boundary at which the backoff counter reaches zero. That is, this indicates that the EDCAF has determined frame transmission. When the EDCAF determines frame transmission, a TXOP is granted to the EDCAF. Since a TXOP has been granted to the EDCAF of STA 1 (910), a TXOP has been granted to STA 1 (910). This may mean that STA 1 (910) has acquired the TXOP, and STA 1 (910) is the TXOP holder. STA 1 (910) may transmit a plurality of frames within the TXOP. The TXOP is a time period during which one or more frames may be transmitted, as indicated by the duration field included in the MAC header of the frame transmitted after the EDCAF acquires the TXOP. STA 1 (910) may transmit a clear to send (CTS) frame as the first frame of the TXOP. The CTS frame may be a CTS-to-Self frame in which the receiver address (RA) indicated in the medium access control (MAC) header is STA 1 (910) itself. Alternatively, STA 1 (910) may transmit an uplink data frame transmitted to the AP (920) as the first frame of the TXOP. The duration field of the MAC header of the frame transmitted within the TXOP may indicate the length of the entire TXOP, and STAs that receive the frame transmitted within the TXOP set the network allocation vector (NAV) to the length of the TXOP indicated in the duration field. When the NAV is set, the virtual carrier sensing of the STAs is detected as busy. Accordingly, the STAs regard the channel as occupied and do not transmit frames while the NAV is set. Exceptionally, when the bidirectional TXOP sharing configuration procedure described below is performed, STAs participating in bidirectional TXOP sharing (e.g., STA 1 (910), STA 2 (930)) and the AP (920) may transmit frames even when the NAV is set, or may release the NAV and transmit frames.

STA 1 (910) may transmit the first frame of the TXOP, i.e., acquire the TXOP, and transmit a TXOP sharing (TXS) request frame to the AP (920). As another embodiment, STA 1 (910) may alternatively transmit the TXS request frame as the first frame of the TXOP. The TXS request frame may be a multi-user request to send (MU-RTS) trigger frame. Alternatively, the TXS request frame may be a frame in various formats indicating a TXS request. The receiver address (RA) of the TXS request frame may be a broadcast address or the MAC address of the AP (920). The TXS request frame may include an identifier for STA 2 (930), which is the target of the TXS operation. When a STA transmits a TXS request frame including an identifier of another STA to request TXOP sharing from the AP (920), this may constitute a request to configure bidirectional TXOP sharing via the AP (920) with the indicated other terminal. Bidirectional TXOP sharing via the AP (920) permits the AP (920) and STA 2 (930) to transmit and receive frames within the TXOP time acquired and shared by STA 1 (910). The identifier for STA 2 (930) may include all or part of the MAC address of STA 2 (930), the association identifier (AID) of STA 2 (930), an internet protocol (IP) address, and the like. The TXS request frame may include a scrambler seed (e.g., a SCRAMBLER_INITIAL_VALUE value) to enable STAs to transmit simultaneous-CTS (S-CTS) frames. The AP (920) receives the TXS request frame of STA 1 (910) and transmits a TXS request response frame to STA 1 (910). The TXS request response frame may be a CTS frame (e.g., an S-CTS frame). Alternatively, the TXS request response frame may be an acknowledgement (ACK) frame. The AP (920) may recognize that STA 1 (910) intends to perform a bidirectional TXOP sharing operation with STA 2 (930).

After receiving the TXS request frame, the AP (920) may transmit a TXS configuration frame, which is a frame for configuring bidirectional TXOP sharing between STA 1 (910) and STA 2 (930). The TXS configuration frame may be an MU-RTS trigger frame. Alternatively, the TXS configuration frame may be a frame in various formats for configuring bidirectional TXOP sharing. The TXS configuration frame may be transmitted in a broadcast manner. A frame transmitted in a broadcast manner means that the receiver address (RA) of the MAC header of the frame is set to a broadcast address, and therefore all STAs in the wireless LAN network are the intended recipients of the frame. The TXS configuration frame may include an identifier indicating STA 1 (910) and/or STA 2 (930). Alternatively, the TXS configuration frame may be transmitted in a unicast manner (e.g., transmitted to STA 2). A frame transmitted in a unicast manner means that the receiver address of the MAC header of the frame indicates the address of a specific wireless LAN STA. Accordingly, the specific wireless LAN STA is the intended recipient of the frame. Instead of transmitting the TXS request response frame, the AP (920) may transmit the TXS configuration frame. That is, the TXS configuration frame may simultaneously perform the function of the TXS configuration response frame.

In addition, STA 2 (930) receives the TXS configuration frame of the AP (920) and confirms that the identifier of STA 2 (930) is included in the TXS configuration frame. STA 2 (930) may transmit a TXS response frame to respond to the TXS configuration frame of the AP (920). The TXS response frame may be a CTS frame (e.g., an S-CTS frame) or an ACK frame. The transmission of the TXS response frame by STA 2 (930) indicates that STA 2 (930) accepts the bidirectional TXOP sharing operation with STA 1 (910). The TXS response frame may be transmitted not only by STA 2 (930) but also by STA 1 (910). That is, the TXS response frame may be simultaneously transmitted to the AP (920) by STA 1 (910) and STA 2 (930).

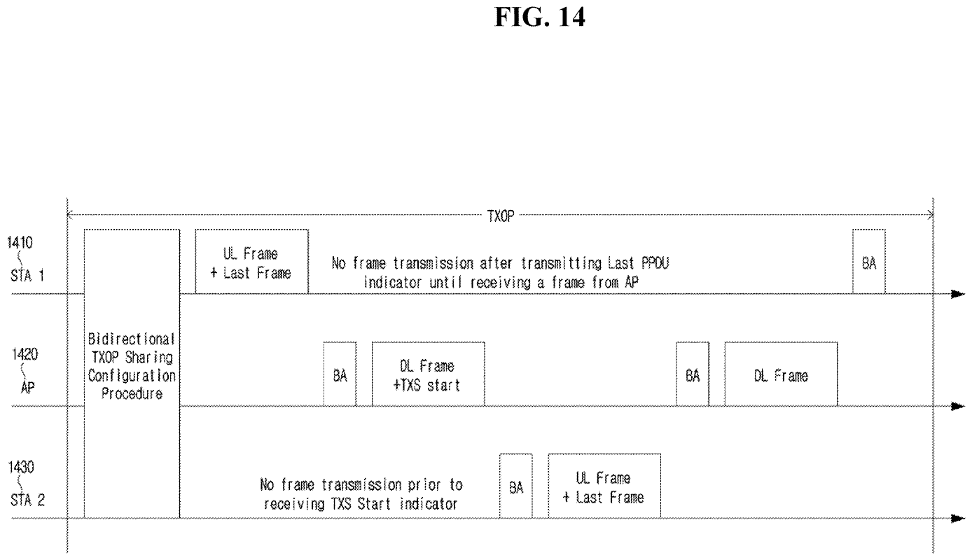

The AP (920) may receive the TXS response frame from STA 2 (930) and transmit a TXS configuration complete frame. The TXS configuration complete frame may be a frame that finally confirms that the bidirectional TXOP sharing operation between STA 1 (910) and STA 2 (930) has been configured. Since the TXS configuration complete frame is transmitted by the AP (920), STA 1 (910) and STA 2 (930) that are not hidden nodes with respect to the AP (920) may be able to receive the TXS configuration complete frame. Accordingly, even when STA 1 (910) and STA 2 (930) are hidden nodes with respect to each other, it can be confirmed that the bidirectional TXOP sharing operation between STA 1 (910) and STA 2 (930) has been configured. The TXS configuration complete frame includes the identifiers of STA 1 (910) and STA 2 (930), and STA 1 (910). The TXS configuration complete frame may be a CTS frame, and a CTS frame with STA 1 (910) as the receiver address and a CTS frame with STA 2 (930) as the receiver address may be transmitted consecutively at SIFS intervals. Alternatively, the TXS configuration complete frame may be a separate control frame, the receiver address of the MAC header may be a broadcast address, and the frame may include the identifiers of STA 1 (910) and STA 2 (930). After STA 1 (910) and STA 2 (930) receive the TXS configuration complete frame, STA 1 and STA 2 (930) may perform a bidirectional TXOP sharing data transmission procedure or a bidirectional OFDMA transmission procedure within the TXOP of the STA according to the embodiments illustrated in FIG. 14 through FIG. 21.

The TXS configuration complete frame may be omitted when STA 1 (910) and STA 2 (930) are not hidden nodes (e.g., nodes that cannot determine whether each other is transmitting), which are nodes that cannot transmit or receive frames to and from each other. To confirm that STA 1 (910) and STA 2 (930) are not hidden nodes, the machine learning unit described above with reference to FIG. 3 and FIG. 4 may be used. In an embodiment, STA 1 (910) and STA 2 (930) may use the addresses of received frames as input. The machine learning unit may determine whether STA 1 (910) and STA 2 (930) are hidden nodes based on the type of received frame, the modulation and coding scheme (MCS), the transmitter address, and the receiver address of the frame.

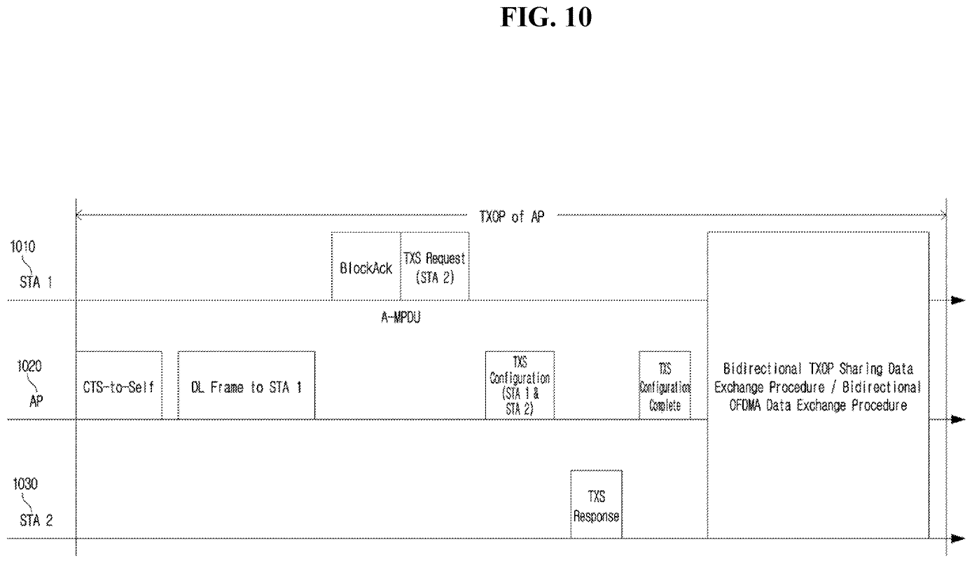

FIG. 10 is a diagram illustrating a bidirectional TXOP sharing configuration method in a wireless LAN to which the present disclosure is applied. Referring to FIG. 10, an AP and WLAN terminals connected to the AP may operate in a wireless LAN network. The WLAN terminals connected to the AP may be non-AP STA 1 and non-AP STA 2. Non-AP STA 1 and non-AP STA 2 are referred to as STA 1 (1010) and STA 2 (1030), respectively. STA 1 (1010) and STA 2 (1030) may perform data communication (e.g., uplink data communication, downlink data communication) with the AP (1020). The AP (1020), STA 1 (1010), and STA 2 (1030) may operate on the same wireless LAN channel. The same wireless LAN channel may refer to the same wireless LAN link. That is, the AP (1020), STA 1 (1010), and STA 2 (1030) may operate on the same wireless LAN link.

The AP (1020) performs a channel access operation on the wireless LAN channel. The channel access operation is an enhanced distributed channel access (EDCA) backoff operation. The EDCA backoff operation may also be referred to as a backoff operation or procedure. In the backoff operation, EDCA functions (EDCAFs) for each access category (AC) may select a backoff counter within a contention window prior to transmitting a frame, and may decrement the backoff counter at a slot boundary prior to transmitting a frame. The EDCAF performs frame transmission at the slot boundary at which the backoff counter reaches zero. That is, this indicates that the EDCAF has determined frame transmission. When the EDCAF determines frame transmission, a TXOP is granted to the EDCAF. Since a TXOP has been granted to the EDCAF of the AP (1020), a TXOP has been granted to the AP (1020). This may mean that the AP (1020) has acquired the TXOP, and the AP (1020) is the TXOP holder. The AP (1020) may transmit a plurality of frames within the TXOP. The TXOP is a time period during which one or more frames may be transmitted, as indicated by the duration field included in the MAC header of the frame transmitted after the EDCAF acquires the TXOP. The AP (1020) may transmit a clear to send (CTS) frame as the first frame of the TXOP. The CTS frame may be a CTS-to-Self frame in which the receiver address (RA) indicated in the medium access control (MAC) header is the AP (1020) itself. Alternatively, the AP (1020) may transmit a downlink data frame transmitted to a STA (e.g., STA 1) as the first frame of the TXOP. The duration field of the MAC header of the frame transmitted within the TXOP may indicate the length of the entire TXOP, and STAs that receive the frame transmitted within the TXOP set the network allocation vector (NAV) to the length of the TXOP indicated in the duration field. When the NAV is set, the virtual carrier sensing of the STAs is detected as busy. Accordingly, the STAs regard the channel as occupied and do not transmit frames while the NAV is set. Exceptionally, when the bidirectional TXOP sharing configuration procedure described below is performed, STAs participating in bidirectional TXOP sharing (e.g., STA 1, STA 2) and the AP (1020) may transmit frames even when the NAV is set, or may release the NAV and transmit frames.

The AP (1020) may transmit a downlink data frame to a STA (e.g., STA 1). That is, after the AP (1020) acquires the TXOP, STA 1 (1010) may transmit a TXOP sharing (TXS) request frame to the AP (1020). The TXS request frame may be a multi-user request to send (MU-RTS) trigger frame. Alternatively, the TXS request frame may be a frame in various formats indicating a TXS request (e.g., a block acknowledgment (BA) frame including an indicator indicating a TXS request, a quality of service (QoS) null frame including an indicator indicating a TXS request, or an aggregated MAC protocol data unit (A-MPDU) in which a BA frame and a QoS Null frame are configured in A-MPDU format and at least one of the BA frame and the QoS Null frame includes an indicator indicating a TXS request). The receiver address (RA) of the TXS request frame may be a broadcast address or the MAC address of the AP (1020). The TXS request frame may include an identifier for STA 2 (1030), which is the target of the TXS operation. When a STA transmits a TXS request frame including an identifier of another STA to request TXOP sharing from the AP (1020), this may constitute a request to configure bidirectional TXOP sharing via the AP (1020) with the indicated other terminal. Bidirectional TXOP sharing via the AP (1020) permits the AP (1020) and STA 2 (1030) to transmit and receive frames within the TXOP time acquired and shared by STA 1 (1010). The identifier for STA 2 (1030) may include all or part of the MAC address of STA 2 (1030), the association identifier (AID) of STA 2 (1030), an internet protocol (IP) address, and the like. The TXS request frame may include a scrambler seed (e.g., a SCRAMBLER_INITIAL_VALUE value) to enable STAs to transmit simultaneous-CTS (S-CTS) frames with identical content. The AP (1020) receives the TXS request frame of STA 1 (1010) and transmits a TXS request response frame to STA 1 (1010). The TXS request response frame may be a CTS frame (e.g., a simultaneous-CTS (S-CTS) frame). As another embodiment, the TXS request response frame may be an acknowledgement (ACK) frame. The AP (1020) may recognize that STA 1 (1010) intends to perform a bidirectional TXOP sharing operation with STA 2 (1030).

After receiving the TXS request frame, the AP (1020) may transmit a TXS configuration frame, which is a frame for configuring bidirectional TXOP sharing between STA 1 (1010) and STA 2 (1030). The TXS configuration frame may be an MU-RTS trigger frame. As another embodiment, the TXS configuration frame may be a frame in various formats for configuring bidirectional TXOP sharing. The TXS configuration frame may be transmitted in a broadcast manner. A frame transmitted in a broadcast manner means that the receiver address (RA) of the MAC header of the frame is set to a broadcast address, and therefore all STAs in the wireless LAN network are the intended recipients of the frame. The TXS configuration frame may include an identifier indicating STA 1 (1010) and/or STA 2 (1030). As another embodiment, the TXS configuration frame may be transmitted in a unicast manner (e.g., transmitted to STA 2). A frame transmitted in a unicast manner means that the receiver address of the MAC header of the frame indicates the address of a specific wireless LAN STA. Accordingly, the specific wireless LAN STA is the intended recipient of the frame. Instead of transmitting the TXS request response frame, the AP (1020) may transmit the TXS configuration frame. That is, the TXS configuration frame may simultaneously perform the function of the TXS configuration response frame.

STA 2 (1030) receives the TXS configuration frame of the AP (1020) and confirms that the identifier of STA 2 (1030) is included in the TXS configuration frame. STA 2 (1030) may transmit a TXS response frame to respond to the TXS configuration frame of the AP (1020). The TXS response frame may be a CTS frame (e.g., an S-CTS frame) or an ACK frame. The transmission of the TXS response frame by STA 2 (1030) indicates that STA 2 (1030) accepts the bidirectional TXOP sharing operation with STA 1 (1010). The TXS response frame may be transmitted not only by STA 2 (1030) but also by STA 1 (1010). That is, the TXS response frame may be simultaneously transmitted to the AP (1020) by STA 1 (1010) and STA 2 (1030).

The AP (1020) receives the TXS response frame from STA 2 (1030) and transmits a TXS configuration complete frame. The TXS configuration complete frame is a frame that finally confirms that the bidirectional TXOP sharing operation between STA 1 (1010) and STA 2 (1030) has been configured. Since the TXS configuration complete frame is transmitted by the AP (1020), STA 1 (1010) and STA 2 (1030) that are not hidden nodes with respect to the AP (1020) may receive the TXS configuration complete frame. Accordingly, even when STA 1 (1010) and STA 2 (1030) are hidden nodes with respect to each other, it can be confirmed that the bidirectional TXOP sharing operation between STA 1 (1010) and STA 2 (1030) has been configured. The TXS configuration complete frame includes the identifiers of STA 1 (1010) and STA 2 (1030), and STA 1 (1010). The TXS configuration complete frame may be a CTS frame, and a CTS frame with STA 1 (1010) as the receiver address and a CTS frame with STA 2 (1030) as the receiver address may be transmitted consecutively at SIFS intervals. Alternatively, the TXS configuration complete frame may be a separate control frame, the receiver address of the MAC header may be a broadcast address, and the frame may include the identifiers of STA 1 (1010) and/or STA 2 (1030). After STA 1 (1010) and STA 2 (1030) receive the TXS configuration complete frame, STA 1 (1010) and STA 2 (1030) may perform a bidirectional TXOP sharing data transmission procedure or a bidirectional OFDMA transmission procedure within the TXOP of the STA according to the embodiments illustrated in FIG. 14 through FIG. 21.

The TXS configuration complete frame may be omitted when STA 1 (1010) and STA 2 (1030) are not hidden nodes (e.g., nodes that cannot determine whether each other is transmitting), which are nodes that cannot transmit or receive frames to and from each other. To confirm that STA 1 (1010) and STA 2 (1030) are not hidden nodes, the machine learning unit described above with reference to FIG. 3 and FIG. 4 may be used. In an embodiment, STA 1 (1010) and STA 2 (1030) may use the addresses of received frames as input. The machine learning unit may determine whether STA 1 (1010) and STA 2 (1030) are hidden nodes based on the type of received frame, the modulation and coding scheme (MCS), the transmitter address, and the receiver address of the frame.

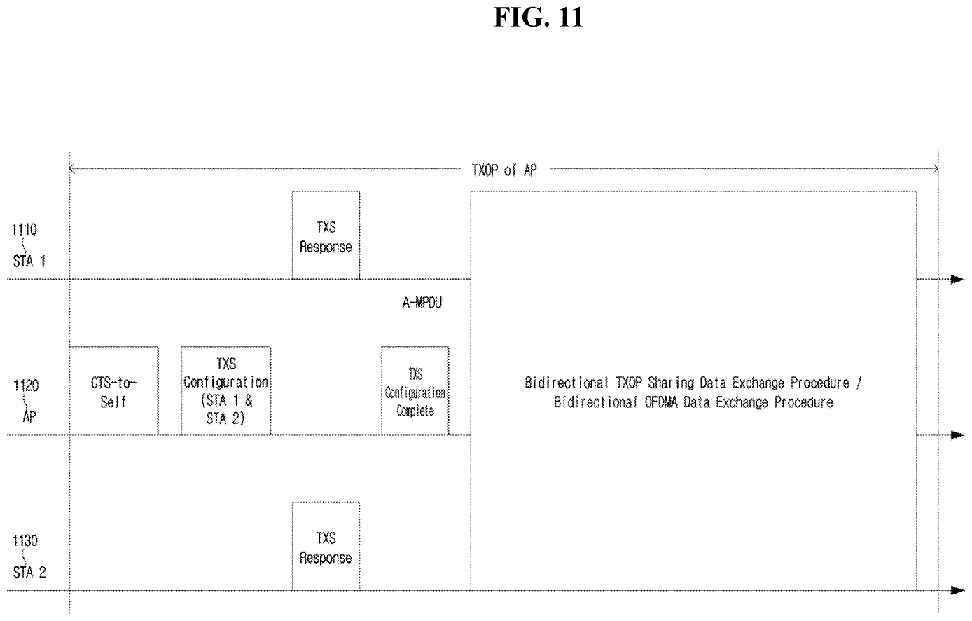

FIG. 11 is a diagram illustrating a bidirectional TXOP sharing configuration method in a wireless LAN to which the present disclosure is applied. Referring to FIG. 11, an AP and WLAN terminals connected to the AP may operate in a wireless LAN network. The WLAN terminals connected to the AP may be non-AP STA 1 and non-AP STA 2. Non-AP STA 1 and non-AP STA 2 are referred to as STA 1 (1110) and STA 2 (1130), respectively. STA 1 (1110) and STA 2 (1130) may perform data communication (e.g., uplink data communication, downlink data communication) with the AP (1120). The AP (1120), STA 1 (1110), and STA 2 (1130) may operate on the same wireless LAN channel. The same wireless LAN channel may refer to the same wireless LAN link. That is, the AP (1120), STA 1 (1110), and STA 2 (1130) may operate on the same wireless LAN link.

The AP (1120) performs a channel access operation on the wireless LAN channel. The channel access operation is an enhanced distributed channel access (EDCA) backoff operation. The EDCA backoff operation may also be referred to as a backoff operation or procedure. In the backoff operation, EDCA functions (EDCAFs) for each access category (AC) may select a backoff counter within a contention window prior to transmitting a frame, and may decrement the backoff counter at a slot boundary prior to transmitting a frame. The EDCAF performs frame transmission at the slot boundary at which the backoff counter reaches zero. That is, this indicates that the EDCAF has determined frame transmission. When the EDCAF determines frame transmission, a TXOP is granted to the EDCAF. Since a TXOP has been granted to the EDCAF of the AP (1120), a TXOP has been granted to the AP (1120). This may mean that the AP (1120) has acquired the TXOP, and the AP (1120) is the TXOP holder. The AP (1120) may transmit a plurality of frames within the TXOP. The TXOP is a time period during which one or more frames may be transmitted, as indicated by the duration field included in the MAC header of the frame transmitted after the EDCAF acquires the TXOP. The AP (1120) may transmit a clear to send (CTS) frame as the first frame of the TXOP. The CTS frame may be a CTS-to-Self frame in which the receiver address (RA) indicated in the medium access control (MAC) header is the AP (1120) itself. Alternatively, the AP (1120) may transmit a downlink data frame transmitted to a STA (e.g., STA 1) or a TXS configuration frame as the first frame of the TXOP. The duration field of the MAC header of the frame transmitted within the TXOP may indicate the length of the entire TXOP, and STAs that receive the frame transmitted within the TXOP set the network allocation vector (NAV) to the length of the TXOP indicated in the duration field. When the NAV is set, the virtual carrier sensing of the STAs is detected as busy. Accordingly, the STAs regard the channel as occupied and do not transmit frames while the NAV is set. Exceptionally, when the bidirectional TXOP sharing configuration procedure described below is performed, STAs participating in bidirectional TXOP sharing (e.g., STA 1, STA 2) and the AP (1120) may transmit frames even when the NAV is set, or may release the NAV and transmit frames.

The TXS configuration frame may be transmitted for bidirectional TXOP sharing. The TXS configuration frame may be a multi-user request to send (MU-RTS) trigger frame. The receiver address (RA) of the TXS configuration frame may be a broadcast address. The TXS configuration frame may include identifiers for TXS STA 1 (1110) and STA 2 (1130). The identifiers may include all or part of the MAC addresses of the STAs, the association identifiers (AIDs) of the STAs, internet protocol (IP) addresses, and the like. The inclusion of the identifiers of STA 1 (1110) and STA 2 (1130) in the TXS configuration frame indicates that a bidirectional TXOP sharing operation is being configured between STA 1 (1110) and STA 2 (1130). Alternatively, the TXS configuration frame may include a separate indicator indicating a bidirectional TXOP sharing operation among a plurality of STAs (STA 1, STA 2) whose identifiers are separately included. The indicator may be included in the form of a subfield, field, or indication bit. The TXS configuration frame may specify the order in which STAs (STA 1 and STA 2) are to transmit in the bidirectional TXOP sharing operation. In an embodiment, the order in which the identifiers of STA 1 (1110) and STA 2 (1130) are included in the TXS configuration frame may indicate this. When the identifier of STA 1 (1110) is included first followed by the identifier of STA 2 (1130) in the TXS configuration frame, STA 1 (1110) transmits data first within the bidirectional TXOP sharing procedure, followed by STA 2 (1130). Alternatively, a separate indicator specifying the order of STAs to transmit in the bidirectional TXOP sharing operation may be included in the TXS configuration frame. The TXS configuration frame may include a scrambler seed (e.g., a SCRAMBLER_INITIAL_VALUE value) to enable STAs to transmit simultaneous-CTS (S-CTS) frames with identical content. STA 1 (1110) and STA 2 (1130) may transmit a TXS response frame to the AP (1120) in response to the TXS configuration frame. When the TXS configuration frame is an MU-RTS frame, the TXS response frame is a CTS frame (e.g., an S-CTS frame simultaneously transmitted from a plurality of STAs). Alternatively, the TXS response frame may be a frame in various formats indicating normal reception of the TXS configuration frame, such as an ACK frame. The AP (1120) may receive the TXS response frame from the STAs. Upon receiving the TXS response frame, the AP (1120) transmits a TXS configuration complete frame. The TXS configuration complete frame is a frame that finally confirms that the bidirectional TXOP sharing operation between STA 1 (1110) and STA 2 (1130) has been configured. Since the TXS configuration complete frame is transmitted by the AP (1120), STA 1 (1110) and STA 2 (1130) that are not hidden nodes with respect to the AP (1120) may receive the TXS configuration complete frame. Accordingly, even when STA 1 (1110) and STA 2 (1130) are hidden nodes with respect to each other, it can be confirmed that the bidirectional TXOP sharing operation between STA 1 (1110) and STA 2 (1130) has been configured. The TXS configuration complete frame includes the identifiers of STA 1 (1110) and STA 2 (1130), and STA 1 (1110). The TXS configuration complete frame may be a CTS frame, and a CTS frame with STA 1 (1110) as the receiver address and a CTS frame with STA 2 (1130) as the receiver address may be transmitted consecutively at SIFS intervals. Alternatively, the TXS configuration complete frame may be a separate control frame, the receiver address of the MAC header may be a broadcast address, and the frame may include the identifiers of STA 1 (1110) and/or STA 2 (1130). After STA 1 (1110) and STA 2 (1130) receive the TXS configuration complete frame, STA 1 (1110) and STA 2 (1130) may perform a bidirectional TXOP sharing data transmission procedure or a bidirectional OFDMA transmission procedure within the TXOP of the STA according to the embodiments illustrated in FIG. 14 through FIG. 21.

The TXS configuration complete frame may be omitted when STA 1 (1110) and STA 2 (1130) are not hidden nodes (e.g., nodes that cannot determine whether each other is transmitting), which are nodes that cannot transmit or receive frames to and from each other. To confirm that STA 1 (1110) and STA 2 (1130) are not hidden nodes, the machine learning unit described above with reference to FIG. 3 and FIG. 4 may be used. In an embodiment, STA 1 (1110) and STA 2 (1130) may use the addresses of received frames as input. The machine learning unit may determine whether STA 1 (1110) and STA 2 (1130) are hidden nodes based on the type of received frame, the modulation and coding scheme (MCS), the transmitter address, and the receiver address of the frame.

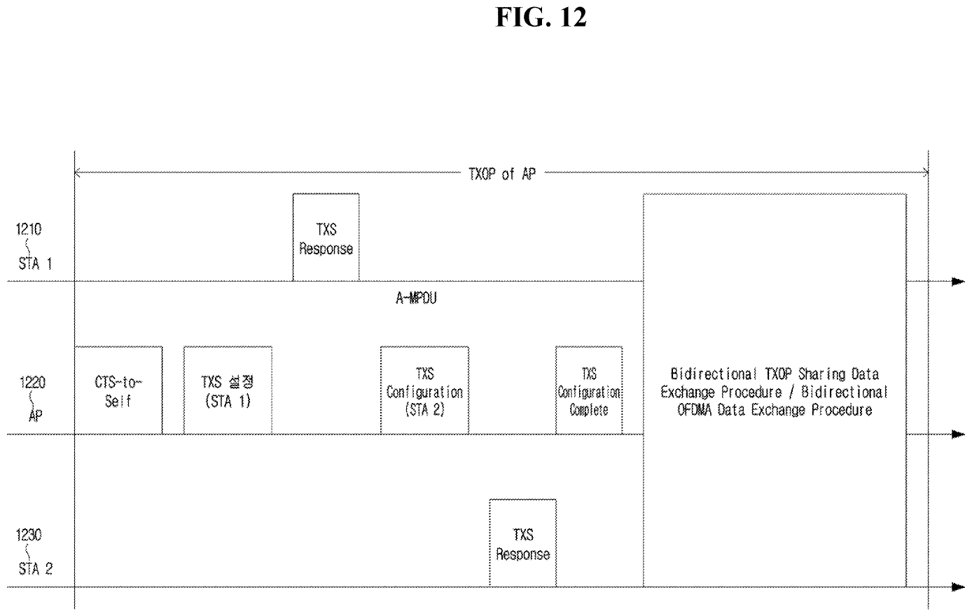

FIG. 12 is a diagram illustrating a bidirectional TXOP sharing configuration method in a wireless LAN to which the present disclosure is applied. Referring to FIG. 12, an AP and WLAN terminals connected to the AP may operate in a wireless LAN network. The WLAN terminals connected to the AP may be non-AP STA 1 and non-AP STA 2. Non-AP STA 1 and non-AP STA 2 are referred to as STA 1 (1210) and STA 2 (1230), respectively. STA 1 (1210) and STA 2 (1230) may perform data communication (e.g., uplink data communication, downlink data communication) with the AP (1220). The AP (1220), STA 1 (1210), and STA 2 (1230) may operate on the same wireless LAN channel. The same wireless LAN channel may refer to the same wireless LAN link. That is, the AP (1220), STA 1 (1210), and STA 2 (1230) may operate on the same wireless LAN link.

The AP (1220) performs a channel access operation on the wireless LAN channel. The channel access operation is an enhanced distributed channel access (EDCA) backoff operation. The EDCA backoff operation may also be referred to as a backoff operation or procedure. In the backoff operation, EDCA functions (EDCAFs) for each access category (AC) may select a backoff counter within a contention window prior to transmitting a frame, and may decrement the backoff counter at a slot boundary prior to transmitting a frame. The EDCAF performs frame transmission at the slot boundary at which the backoff counter reaches zero. That is, this indicates that the EDCAF has determined frame transmission. When the EDCAF determines frame transmission, a TXOP is granted to the EDCAF. Since a TXOP has been granted to the EDCAF of the AP (1220), a TXOP has been granted to the AP (1220). This may mean that the AP (1220) has acquired the TXOP, and the AP (1220) is the TXOP holder. The AP (1220) may transmit a plurality of frames within the TXOP. The TXOP is a time period during which one or more frames may be transmitted, as indicated by the duration field included in the MAC header of the frame transmitted after the EDCAF acquires the TXOP. The AP (1220) may transmit a clear to send (CTS) frame as the first frame of the TXOP. The CTS frame may be a CTS-to-Self frame in which the receiver address (RA) indicated in the medium access control (MAC) header is the AP (1220) itself. Alternatively, the AP (1220) may transmit a downlink data frame transmitted to a STA (e.g., STA 1) or a TXS configuration frame as the first frame of the TXOP. The duration field of the MAC header of the frame transmitted within the TXOP may indicate the length of the entire TXOP, and STAs that receive the frame transmitted within the TXOP set the network allocation vector (NAV) to the length of the TXOP indicated in the duration field. When the NAV is set, the virtual carrier sensing of the STAs is detected as busy. Accordingly, the STAs regard the channel as occupied and do not transmit frames while the NAV is set. Exceptionally, when the bidirectional TXOP sharing configuration procedure described below is performed, STAs participating in bidirectional TXOP sharing (e.g., STA 1, STA 2) and the AP (1220) may transmit frames even when the NAV is set, or may release the NAV and transmit frames. The TXS configuration frame may be a multi-user request to send (MU-RTS) trigger frame. The TXS configuration frame is transmitted for bidirectional TXOP sharing configuration, and the TXS configuration frame for bidirectional TXOP sharing may be transmitted to STA 1 (1210) and STA 2 (1230) respectively. In an embodiment, the TXS configuration frame may be transmitted to STA 1 (1210) first, and then to STA 2 (1230). The receiver address (RA) of the TXS configuration frame transmitted to STA 1 (1210) may be a broadcast address or the MAC address of STA 1 (1210). The receiver address (RA) of the TXS configuration frame transmitted to STA 2 (1230) may be a broadcast address or the MAC address of STA 2 (1230). The first TXS configuration frame includes an identifier for STA 1 (1210) participating in the bidirectional TXOP sharing operation. The identifier may include all or part of the MAC address of STA 1 (1210), the association identifier (AID) of STA 1 (1210), an internet protocol (IP) address, and the like. The TXS configuration frame may include a separate indicator indicating a bidirectional TXOP sharing operation among a plurality of STAs (STA 1, STA 2) whose identifiers are separately included. The indicator may be included in the form of a subfield, field, or indication bit. STA 1 (1210) may transmit a TXS response frame to the AP (1220) in response to the TXS configuration frame. When the TXS configuration frame is an MU-RTS frame, the TXS response frame is a CTS frame (e.g., a simultaneous-CTS (S-CTS) frame simultaneously transmitted from a plurality of STAs). Alternatively, the TXS response frame may be a frame in various formats indicating normal reception of the TXS configuration frame, such as an ACK frame. The second TXS configuration frame includes an identifier for STA 2 (1230) participating in the bidirectional TXOP sharing operation. The identifier may include all or part of the MAC address of STA 2 (1230), the association identifier (AID) of STA 2 (1230), an internet protocol (IP) address, and the like. The TXS configuration frame may include a separate indicator indicating a bidirectional TXOP sharing operation among a plurality of STAs (STA 1, STA 2) whose identifiers are separately included. The indicator may be included in the form of a subfield, field, or indication bit. STA 2 (1230) may transmit a TXS response frame to the AP (1220) in response to the TXS configuration frame. When the TXS configuration frame is an MU-RTS frame, the TXS response frame is a CTS frame (e.g., a simultaneous-CTS (S-CTS) frame simultaneously transmitted from a plurality of STAs). Alternatively, the TXS response frame may be a frame in various formats indicating normal reception of the TXS configuration frame, such as an ACK frame. The TXS configuration frames may specify the order in which STAs (STA 1 and STA 2) are to transmit in the bidirectional TXOP sharing operation. In an embodiment, the order in which the identifiers of STA 1 (1210) and STA 2 (1230) are included in the TXS configuration frame may indicate this. When the identifier of STA 1 (1210) is included first followed by the identifier of STA 2 (1230) in the TXS configuration frame, STA 1 (1210) transmits data first within the bidirectional TXOP sharing procedure, followed by STA 2 (1230). Alternatively, a separate indicator specifying the order of STAs to transmit in the bidirectional TXOP sharing operation may be included in the TXS configuration frame. The TXS configuration frame may include a scrambler seed (e.g., a SCRAMBLER_INITIAL_VALUE value) to enable STAs to transmit simultaneous-CTS (S-CTS) frames with identical content.

The AP (1220) may receive each TXS response frame for each TXS configuration frame from each STA. Upon receiving the TXS response frames, the AP (1220) transmits a TXS configuration complete frame. The TXS configuration complete frame is a frame that finally confirms that the bidirectional TXOP sharing operation between STA 1 (1210) and STA 2 (1230) has been configured. Since the TXS configuration complete frame is transmitted by the AP (1220), STA 1 (1210) and STA 2 (1230) that are not hidden nodes with respect to the AP (1220) may receive the TXS configuration complete frame. Accordingly, even when STA 1 (1210) and STA 2 (1230) are hidden nodes with respect to each other, it can be confirmed that the bidirectional TXOP sharing operation between STA 1 (1210) and STA 2 (1230) has been configured. The TXS configuration complete frame includes the identifiers of STA 1 (1210) and STA 2 (1230), and STA 1 (1210). The TXS configuration complete frame may be a CTS frame, and a CTS frame with STA 1 (1210) as the receiver address and a CTS frame with STA 2 (1230) as the receiver address may be transmitted consecutively at SIFS intervals. Alternatively, the TXS configuration complete frame may be a separate control frame, the receiver address of the MAC header may be a broadcast address, and the frame may include the identifiers of STA 1 (1210) and/or STA 2 (1230). After STA 1 (1210) and STA 2 (1230) receive the TXS configuration complete frame, STA 1 (1210) and STA 2 (1230) may perform a bidirectional TXOP sharing data transmission procedure or a bidirectional OFDMA transmission procedure within the TXOP of the STA according to the embodiments illustrated in FIG. 14 through FIG. 21. The TXS configuration complete frame may be omitted when STA 1 (1210) and STA 2 (1230) are not hidden nodes (e.g., nodes that cannot determine whether each other is transmitting), which are nodes that cannot transmit or receive frames to and from each other. To confirm that STA 1 (1210) and STA 2 (1230) are not hidden nodes, the machine learning unit described above with reference to FIG. 3 and FIG. 4 may be used. In an embodiment, STA 1 (1210) and STA 2 (1230) may use the addresses of received frames as input. The machine learning unit may determine whether STA 1 (1210) and STA 2 (1230) are hidden nodes based on the type of received frame, the modulation and coding scheme (MCS), the transmitter address, and the receiver address of the frame.

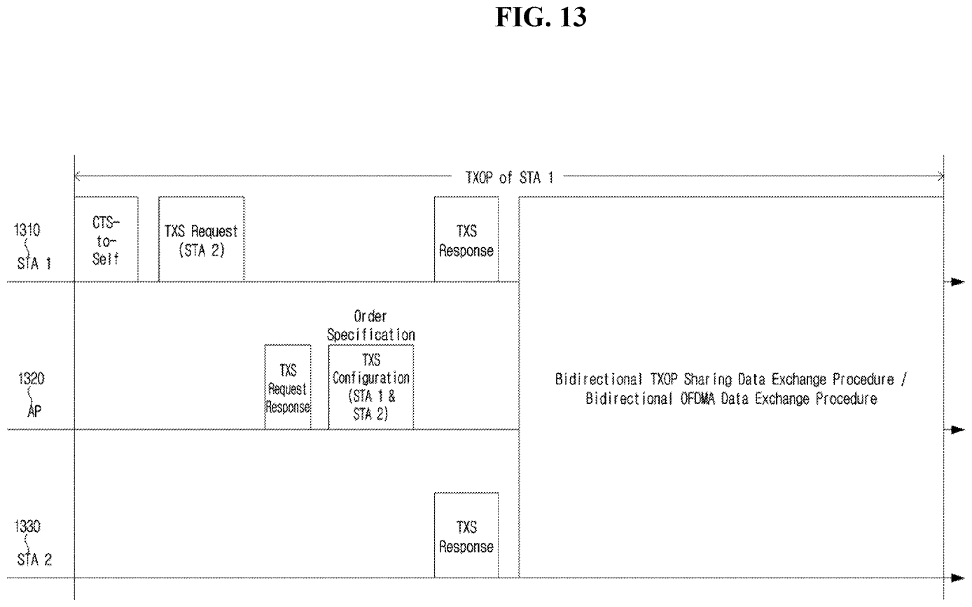

FIG. 13 is a diagram illustrating a bidirectional TXOP sharing configuration method in a wireless LAN to which the present disclosure is applied. Referring to FIG. 13, an AP and WLAN terminals connected to the AP may operate in a wireless LAN network. The WLAN terminals connected to the AP may be non-AP STA 1 and non-AP STA 2. Non-AP STA 1 and non-AP STA 2 are referred to as STA 1 (1310) and STA 2 (1330), respectively. STA 1 (1310) and STA 2 (1330) may perform data communication (e.g., uplink data communication, downlink data communication) with the AP (1320). The AP (1320), STA 1 (1310), and STA 2 (1330) may operate on the same wireless LAN channel. The same wireless LAN channel may refer to the same wireless LAN link. That is, the AP (1320), STA 1 (1310), and STA 2 (1330) may operate on the same wireless LAN link.

STA 1 (1310) performs a channel access operation on the wireless LAN channel. The channel access operation is an enhanced distributed channel access (EDCA) backoff operation. The EDCA backoff operation may also be referred to as a backoff operation or procedure. In the backoff operation, EDCA functions (EDCAFs) for each access category (AC) may select a backoff counter within a contention window prior to transmitting a frame, and may decrement the backoff counter at a slot boundary prior to transmitting a frame. The EDCAF performs frame transmission at the slot boundary at which the backoff counter reaches zero. That is, this indicates that the EDCAF has determined frame transmission. When the EDCAF determines frame transmission, a TXOP is granted to the EDCAF. Since a TXOP has been granted to the EDCAF of STA 1 (1310), a TXOP has been granted to STA 1 (1310). This may mean that STA 1 (1310) has acquired the TXOP, and STA 1 (1310) is the TXOP holder. STA 1 (1310) may transmit a plurality of frames within the TXOP. The TXOP is a time period during which one or more frames may be transmitted, as indicated by the duration field included in the MAC header of the frame transmitted after the EDCAF acquires the TXOP. STA 1 (1310) may transmit a clear to send (CTS) frame as the first frame of the TXOP. The CTS frame may be a CTS-to-Self frame in which the receiver address (RA) indicated in the medium access control (MAC) header is STA 1 (1310) itself. Alternatively, STA 1 (1310) may transmit an uplink data frame transmitted to the AP (1320) or a TXS request frame described below as the first frame of the TXOP. The duration field of the MAC header of the frame transmitted within the TXOP may indicate the length of the entire TXOP, and STAs that receive the frame transmitted within the TXOP set the network allocation vector (NAV) to the length of the TXOP indicated in the duration field. When the NAV is set, the virtual carrier sensing of the STAs is detected as busy. Accordingly, the STAs regard the channel as occupied and do not transmit frames while the NAV is set. Exceptionally, when the bidirectional TXOP sharing configuration procedure described below is performed, STAs participating in bidirectional TXOP sharing (e.g., STA 1, STA 2) and the AP (1320) may transmit frames even when the NAV is set, or may release the NAV and transmit frames.

STA 1 (1310) may transmit a TXS request frame to the AP (1320) as the first frame of the TXOP or within the TXOP. The receiver address (RA) of the TXS request frame may be a broadcast address or the MAC address of the AP (1320). The TXS request frame is a frame requesting bidirectional TXOP sharing configuration from the AP (1320), and may include the identifier of STA 2 (1330), which is the target of bidirectional TXOP sharing. When a STA transmits a TXS request frame including an identifier of another STA to request TXOP sharing from the AP (1320), this may constitute a request to configure bidirectional TXOP sharing via the AP (1320) with the indicated other terminal. Bidirectional TXOP sharing via the AP (1320) permits the AP (1320) and STA 2 (1330) to transmit and receive frames within the TXOP time acquired and shared by STA 1 (1310). The TXS request frame transmitted by STA 1 (1310) includes the identifier of STA 2 (1330). The identifier may include all or part of the MAC address of STA 2 (1330), the association identifier (AID) of STA 2 (1330), an internet protocol (IP) address, and the like. The AP (1320) may receive the TXS request frame of the STA and transmit a TXS configuration frame. The TXS configuration frame may be a multi-user request to send (MU-RTS) trigger frame. The receiver address (RA) of the TXS configuration frame may be a broadcast address. The duration field of the MAC header of the frame transmitted within the TXOP may indicate the length of the entire TXOP, and STAs that receive the frame transmitted within the TXOP set the network allocation vector (NAV) to the length of the TXOP indicated in the duration field. When the NAV is set, the virtual carrier sensing of the STAs is detected as busy. Accordingly, the STAs regard the channel as occupied and do not transmit frames while the NAV is set. Exceptionally, when the bidirectional TXOP sharing configuration procedure described below is performed, STAs participating in bidirectional TXOP sharing (e.g., STA 1, STA 2) and the AP (1320) may transmit frames even when the NAV is set, or may release the NAV and transmit frames.

The TXS configuration frame may be transmitted for bidirectional TXOP sharing. The TXS configuration frame may be a multi-user request to send (MU-RTS) trigger frame. The receiver address (RA) of the TXS configuration frame may be a broadcast address. The TXS configuration frame may include identifiers for TXS STA 1 (1310) and STA 2 (1330). The identifiers may include all or part of the MAC addresses of the STAs, the association identifiers (AIDs) of the STAs, internet protocol (IP) addresses, and the like. The inclusion of the identifiers of STA 1 (1310) and/or STA 2 (1330) in the TXS configuration frame indicates that a bidirectional TXOP sharing operation is being configured between STA 1 (1310) and STA 2 (1330). Alternatively, the TXS configuration frame may include a separate indicator indicating a bidirectional TXOP sharing operation among a plurality of STAs (STA 1, STA 2) whose identifiers are separately included. The indicator may be included in the form of a subfield, field, or indication bit. The TXS configuration frame may specify the order in which STAs (STA 1 and STA 2) are to transmit in the bidirectional TXOP sharing operation. In an embodiment, the order in which the identifiers of STA 1 (1310) and STA 2 (1330) are included in the TXS configuration frame may indicate this. When the identifier of STA 1 (1310) is included first followed by the identifier of STA 2 (1330) in the TXS configuration frame, STA 1 (1310) transmits data first within the bidirectional TXOP sharing procedure, followed by STA 2 (1330). Alternatively, a separate indicator specifying the order of STAs to transmit in the bidirectional TXOP sharing operation may be included in the TXS configuration frame. The TXS configuration frame may include a scrambler seed (e.g., a SCRAMBLER_INITIAL_VALUE value) to enable STAs to transmit simultaneous-CTS (S-CTS) frames with identical content. STA 1 (1310) and STA 2 (1330) may transmit a TXS response frame to the AP (1320) in response to the TXS configuration frame. When the TXS configuration frame is an MU-RTS frame, the TXS response frame is a CTS frame (e.g., a simultaneous-CTS (S-CTS) frame simultaneously transmitted from a plurality of STAs). Alternatively, the TXS response frame may be a frame in various formats indicating normal reception of the TXS configuration frame, such as an ACK frame. The AP (1320) may receive the TXS response frame from the STAs. Upon receiving the TXS response frame, the AP (1320) transmits a TXS configuration complete frame. The TXS configuration complete frame is a frame that finally confirms that the bidirectional TXOP sharing operation between STA 1 (1310) and STA 2 (1330) has been configured. Since the TXS configuration complete frame is transmitted by the AP (1320), STA 1 (1310) and STA 2 (1330) that are not hidden nodes with respect to the AP (1320) may receive the TXS configuration complete frame. Accordingly, even when STA 1 (1310) and STA 2 (1330) are hidden nodes with respect to each other, it can be confirmed that the bidirectional TXOP sharing operation between STA 1 (1310) and STA 2 (1330) has been configured. The TXS configuration complete frame includes the identifiers of STA 1 (1310) and STA 2 (1330), and STA 1 (1310). The TXS configuration complete frame may be a CTS frame, and a CTS frame with STA 1 (1310) as the receiver address and a CTS frame with STA 2 (1330) as the receiver address may be transmitted consecutively at SIFS intervals. Alternatively, the TXS configuration complete frame may be a separate control frame, the receiver address of the MAC header may be a broadcast address, and the frame may include the identifiers of STA 1 (1310) and/or STA 2 (1330). After STA 1 (1310) and STA 2 (1330) receive the TXS configuration complete frame, STA 1 (1310) and STA 2 (1330) may perform a bidirectional TXOP sharing data transmission procedure or a bidirectional OFDMA transmission procedure within the TXOP of the STA according to the embodiments illustrated in FIG. 14 through FIG. 21.

As another embodiment, the TXS configuration frame for bidirectional TXOP sharing may be transmitted to STA 1 (1310) and STA 2 (1330) respectively. In an embodiment, the TXS configuration frame may be transmitted to STA 1 (1310) first, and then to STA 2 (1330). The receiver address (RA) of the TXS configuration frame transmitted to STA 1 (1310) may be a broadcast address or the MAC address of STA 1 (1310). The receiver address (RA) of the TXS configuration frame transmitted to STA 2 (1330) may be a broadcast address or the MAC address of STA 2 (1330). The first TXS configuration frame includes an identifier for STA 1 (1310) participating in the bidirectional TXOP sharing operation. The identifier may include all or part of the MAC address of STA 1 (1310), the association identifier (AID) of STA 1 (1310), an internet protocol (IP) address, and the like. The TXS configuration frame may include a separate indicator indicating a bidirectional TXOP sharing operation among a plurality of STAs (STA 1, STA 2) whose identifiers are separately included. The indicator may be included in the form of a subfield, field, or indication bit. STA 1 (1310) may transmit a TXS response frame to the AP (1320) in response to the TXS configuration frame. When the TXS configuration frame is an MU-RTS frame, the TXS response frame is a CTS frame (e.g., a simultaneous-CTS (S-CTS) frame simultaneously transmitted from a plurality of STAs). Alternatively, the TXS response frame may be a frame in various formats indicating normal reception of the TXS configuration frame, such as an ACK frame. The second TXS configuration frame includes an identifier for STA 2 (1330) participating in the bidirectional TXOP sharing operation. The identifier may include all or part of the MAC address of STA 2 (1330), the association identifier (AID) of STA 2 (1330), an internet protocol (IP) address, and the like. The TXS configuration frame may include a separate indicator indicating a bidirectional TXOP sharing operation among a plurality of STAs (STA 1, STA 2) whose identifiers are separately included. The indicator may be included in the form of a subfield, field, or indication bit. STA 2 (1330) may transmit a TXS response frame to the AP (1320) in response to the TXS configuration frame. When the TXS configuration frame is an MU-RTS frame, the TXS response frame is a CTS frame (e.g., a simultaneous-CTS (S-CTS) frame simultaneously transmitted from a plurality of STAs). Alternatively, the TXS response frame may be a frame in various formats indicating normal reception of the TXS configuration frame, such as an ACK frame. The TXS configuration frames may specify the order in which STAs (STA 1 and STA 2) are to transmit in the bidirectional TXOP sharing operation. In an embodiment, the order in which the identifiers of STA 1 (1310) and/or STA 2 (1330) are included in the TXS configuration frame may indicate this. When the identifier of STA 1 (1310) is included first followed by the identifier of STA 2 (1330) in the TXS configuration frame, STA 1 (1310) transmits data first within the bidirectional TXOP sharing procedure, followed by STA 2 (1330). Alternatively, a separate indicator specifying the order of STAs to transmit in the bidirectional TXOP sharing operation may be included in the TXS configuration frame. The TXS configuration frame may include a scrambler seed (e.g., a SCRAMBLER_INITIAL_VALUE value) to enable STAs to transmit simultaneous-CTS (S-CTS) frames with identical content. The AP (1320) may receive each TXS response frame for each TXS configuration frame from each STA. Upon receiving the TXS response frames, the AP (1320) transmits a TXS configuration complete frame. The TXS configuration complete frame is a frame that finally confirms that the bidirectional TXOP sharing operation between STA 1 (1310) and STA 2 (1330) has been configured. Since the TXS configuration complete frame is transmitted by the AP (1320), STA 1 (1310) and STA 2 (1330) that are not hidden nodes with respect to the AP (1320) may receive the TXS configuration complete frame. Accordingly, even when STA 1 (1310) and STA 2 (1330) are hidden nodes with respect to each other, it can be confirmed that the bidirectional TXOP sharing operation between STA 1 (1310) and STA 2 (1330) has been configured. The TXS configuration complete frame includes the identifiers of STA 1 (1310) and STA 2 (1330), and STA 1 (1310). The TXS configuration complete frame may be a CTS frame, and a CTS frame with STA 1 (1310) as the receiver address and a CTS frame with STA 2 (1330) as the receiver address may be transmitted consecutively at SIFS intervals. Alternatively, the TXS configuration complete frame may be a separate control frame, the receiver address of the MAC header may be a broadcast address, and the frame may include the identifiers of STA 1 (1310) and/or STA 2 (1330). After STA 1 (1310) and STA 2 (1330) receive the TXS configuration complete frame, STA 1 (1310) and STA 2 (1330) may perform a bidirectional TXOP sharing data transmission procedure or a bidirectional OFDMA transmission procedure within the TXOP of the STA according to the embodiments illustrated in FIG. 14 through FIG. 21.

The TXS configuration complete frame may be omitted when STA 1 (1310) and STA 2 (1330) are not hidden nodes (e.g., nodes that cannot determine whether each other is transmitting), which are nodes that cannot transmit or receive frames to and from each other. To confirm that STA 1 (1310) and STA 2 (1330) are not hidden nodes, the machine learning unit described above with reference to FIG. 3 and FIG. 4 may be used. In an embodiment, STA 1 (1310) and STA 2 (1330) may use the addresses of received frames as input. The machine learning unit may determine whether STA 1 (1310) and STA 2 (1330) are hidden nodes based on the type of received frame, the modulation and coding scheme (MCS), the transmitter address, and the receiver address of the frame.

FIG. 14 is a diagram illustrating a bidirectional TXOP sharing data transmission method in a wireless LAN to which the present disclosure is applied. Referring to FIG. 14, STA 1 (1410), STA 2 (1430), and the AP (1420) have performed the bidirectional TXOP sharing configuration procedure within the TXOP in the same or similar manner as the embodiments of FIG. 9 through FIG. 13, and bidirectional TXOP sharing between STA 1 (1410) and STA 2 (1430) has been configured. When the bidirectional TXOP sharing configuration procedure has been performed, the bidirectional TXOP sharing data transmission procedure of the present embodiment is performed. STA 1 (1410) may be configured to transmit data first, and STA 2 (1430) to transmit data thereafter.

STA 1 (1410) transmits an uplink (UL) frame to the AP (1420). The final destination of the uplink frame is STA 2 (1430). The uplink frame is delivered to STA 2 (1430) via the AP (1420). STA 1 (1410) sets the MAC header of the uplink frame as shown in [Table 2].

TABLE 2

| | Field | | | | |
|---|---|---|---|---|---|
| | | | Address 1 Field | Address 2 Field | Address 3 Field |
| | | | (Receiver | (Transmitter | (Destination |
| | Frame Control Field | | Address) | Address) | Address) |
| | Subfield | | | | |
| | To DS | From DS | N/A | N/A | N/A |
| Value | 1 | 0 | AP Address | STA 1 Address | STA 2 Address |

STA 1 (1410) may transmit the uplink frame as the last frame. Accordingly, the uplink frame includes a last frame indicator. The last frame indicator indicates to the AP (1420) the last frame transmitted by the terminal in the bidirectional TXOP sharing. When STA 1 (1410) transmits the last frame indicator to the AP (1420), STA 1 (1410) may not transmit frames until the AP (1420) transmits to STA 1 (1410). The last frame indicator may be an indicator in which the more data bit included in the MAC header of the frame is set to 0, a specific value is indicated in the address 4 field, or an indicator included in the A-control field of the HT control field. The last frame indicator may be more diverse, e.g., it may be a separate frame. That is, a frame including the last frame indicator may be transmitted separately.

Upon completing reception of the uplink frame of STA 1 (1410), the AP (1420) may transmit a response frame after a SIFS duration. The response frame may be a block acknowledgment (BA) frame. The AP (1420) may transmit a downlink frame to STA 2 (1430) after a SIFS duration from the completion of transmission of the response frame to STA 1 (1410). The downlink frame may be a frame that forwards the uplink frame transmitted by STA 1 (1410) to the AP (1420) to STA 2 (1430). The AP (1420) sets the MAC header of the downlink frame as shown in [Table 3].

TABLE 3

| | Field | | | | |
|---|---|---|---|---|---|
| | | | Address 1 Field | Address 2 Field | Address 3 Field |
| | | | (Receiver | (Transmitter | (Source |
| | Frame Control Field | | Address) | Address) | Address) |
| | Subfield | | | | |
| | To DS | From DS | N/A | N/A | N/A |
| Value | 0 | 1 | STA 2 Address | AP Address | STA 1 Address |

The AP (1420) may transmit the downlink frame as the last frame transmitted to STA 2 (1430). The AP (1420) may include a TXS start indicator in the downlink frame transmitted to STA 2 (1430), indicating that STA 2 (1430) is to initiate transmission in the bidirectional TXOP sharing. The TXS start indicator may be an indicator in which the more data bit included in the MAC header of the frame is set to 0, a specific value is indicated in the address 4 field, or an indicator included in the A-control field of the HT control field. The TXS start indicator may be more diverse and may be a separate frame. That is, a frame including the TXS start indicator may be transmitted separately.

STA 2 (1430) may receive the downlink frame from the AP (1420) and may identify that the original transmitter of the received frame is STA 1 (1410). STA 2 (1430) transmits a response frame to the AP (1420) after a SIFS duration from the completion of reception of the downlink frame. STA 2 (1430) may check the TXS start indicator present in the downlink frame and may recognize that STA 2 (1430) is able to perform uplink transmission. STA 2 (1430) does not perform uplink transmission to the AP (1420) until receiving the TXS start indicator. STA 2 (1430) may transmit an uplink frame to the AP (1420) after a SIFS duration from the completion of transmission of the response frame. The final destination of the uplink frame is STA 1 (1410). The uplink frame is delivered to STA 1 (1410) via the AP (1420). STA 2 (1430) sets the MAC header of the uplink data frame as shown in [Table 4].

TABLE 4

| | Field | | | | |
|---|---|---|---|---|---|
| | | | Address 1 Field | Address 2 Field | Address 3 Field |
| | | | (Receiver | (Transmitter | (Destination |
| | Frame Control Field | | Address) | Address) | Address) |
| | Subfield | | | | |
| | To DS | From DS | N/A | N/A | N/A |
| Value | 1 | 0 | AP Address | STA 2 Address | STA 1 Address |

STA 2 (1430) may transmit the uplink frame as the last frame. Accordingly, the uplink frame includes a last frame indicator. Upon completing reception of the uplink frame of STA 2 (1430), the AP (1420) may transmit a response frame after a SIFS duration. The response frame may be a block acknowledgment (BA) frame. The AP (1420) may transmit a downlink frame to STA 1 (1410) after a SIFS duration from the completion of transmission of the response frame to STA 2 (1430). The downlink frame may be a frame that forwards the uplink frame transmitted by STA 2 (1430) to the AP (1420) to STA 1 (1410). The AP (1420) sets the MAC header of the downlink frame as shown in [Table 5].

TABLE 5

| | Field | | | | |
|---|---|---|---|---|---|
| | | | Address 1 Field | Address 2 Field | |
| | | | (Receiver | (Transmitter | Address 3 Field |
| | Frame Control Field | | Address) | Address) | (Source Address) |
| | Subfield | | | | |
| | To DS | From DS | N/A | N/A | N/A |
| Value | 0 | 1 | STA 1 Address | AP Address | STA 2 Address |

STA 1 (1410) may receive the downlink frame from the AP (1420) and may identify that the original transmitter of the received frame is STA 2 (1430). STA 1 (1410) transmits a response frame to the AP (1420) after a SIFS duration from the completion of reception of the downlink frame. The bidirectional TXOP sharing may be completed.

After the bidirectional TXOP procedure is completed, a remaining period may exist in the TXOP. When the TXOP holder is a STA (e.g., STA 1 (1410)), the STA may transmit an uplink data frame to the AP (1420), or the STA may restart the bidirectional TXOP sharing procedure (e.g., the bidirectional TXOP sharing configuration procedure or the bidirectional TXOP sharing data transmission procedure). Alternatively, the STA may transmit a contention free (CF)-End frame to terminate the TXOP. When the TXOP is terminated, the NAV corresponding to the length of the TXOP is released. When the TXOP holder is the AP (1420), the AP (1420) may transmit a downlink data frame to a STA (e.g., STA 1), or the AP (1420) may restart the bidirectional TXOP sharing procedure (e.g., the bidirectional TXOP sharing configuration procedure or the bidirectional TXOP sharing data transmission procedure). Alternatively, the AP (1420) may transmit a contention free (CF)-End frame to terminate the TXOP. When the TXOP is terminated, the NAV corresponding to the length of the TXOP is released.

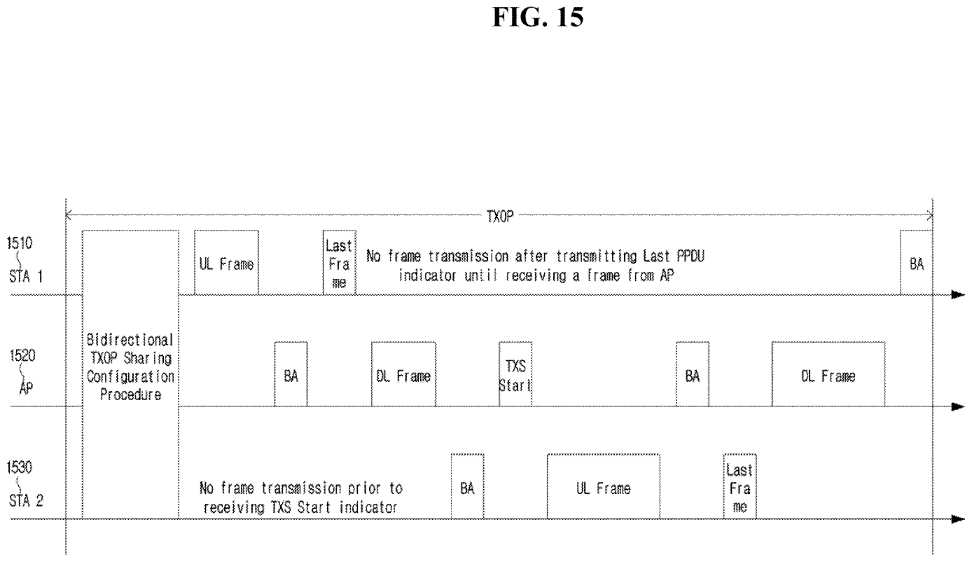

FIG. 15 is a diagram illustrating a bidirectional TXOP sharing data transmission method in a wireless LAN to which the present disclosure is applied. Referring to FIG. 15, STA 1 (1510), STA 2 (1530), and the AP (1520) have performed the bidirectional TXOP sharing configuration procedure within the TXOP in the same or similar manner as the embodiments of FIG. 9 through FIG. 13, and bidirectional TXOP sharing between STA 1 (1510) and STA 2 (1530) has been configured. When the bidirectional TXOP sharing configuration procedure has been performed, the bidirectional TXOP sharing data transmission procedure of the present embodiment is performed. STA 1 (1510) may be configured to transmit data first, and STA 2 (1530) to transmit data thereafter.

STA 1 (1510) transmits an uplink (UL) frame to the AP (1520). The final destination of the uplink frame is STA 2 (1530). The uplink frame is delivered to STA 2 (1530) via the AP (1520). STA 1 (1510) sets the MAC header of the uplink frame as shown in [Table 2]. Upon completing reception of the uplink frame of STA 1 (1510), the AP (1520) may transmit a response frame after a SIFS duration. The response frame may be a block acknowledgment (BA) frame. The uplink frame of STA 1 (1510) may be the last frame. Accordingly, after receiving the response frame of the AP (1520), STA 1 (1510) transmits a frame including the last frame indicator (last frame indication frame) to the AP (1520) after a SIFS duration. The last frame indicator indicates to the AP (1520) the last frame transmitted by the terminal in the bidirectional TXOP sharing. When STA 1 (1510) transmits the last frame indicator to the AP (1520), STA 1 (1510) may not transmit frames until the AP (1520) transmits to STA 1 (1510). The last frame indicator may be an indicator in which the more data bit included in the MAC header of the frame is set to 0, a specific value is indicated in the address 4 field, or an indicator included in the A-control field of the HT control field. The last frame indicator may be defined by the frame format itself. That is, a specific frame format or a specific frame may be the last frame indicator.

The AP (1520) may transmit a downlink frame to STA 2 (1530) after a SIFS duration from the completion of reception of the last frame indication frame from STA 1 (1510). The downlink frame may be a frame that forwards the uplink frame transmitted by STA 1 (1510) to the AP (1520) to STA 2 (1530). The AP (1520) sets the MAC header of the downlink frame as shown in [Table 3]. STA 2 (1530) may receive the downlink frame from the AP (1520) and may identify that the original transmitter of the received frame is STA 1 (1510). STA 2 (1530) transmits a response frame to the AP (1520) after a SIFS duration from the completion of reception of the downlink frame.

The AP (1520) may transmit the downlink frame as the last frame transmitted to STA 2 (1530). After receiving the response frame of STA 2 (1530), the AP (1520) may transmit a frame including a TXS start indicator (TXS start indication frame) after a SIFS duration, indicating that STA 2 (1530) is to initiate transmission in the bidirectional TXOP sharing. The TXS start indicator may be an indicator in which the more data bit included in the MAC header of the frame is set to 0, a specific value is indicated in the address 4 field, or an indicator included in the A-control field of the HT control field. The TXS start indicator may be more diverse. The TXS start indicator may be defined by the frame format itself. That is, a specific frame format or a specific frame may be the TXS start indicator.

STA 2 (1530) receives the TXS start indication frame and may confirm the TXS start indicator, thereby recognizing that STA 2 (1530) is able to perform uplink transmission. STA 2 (1530) does not perform uplink transmission to the AP (1520) until receiving the TXS start indicator. STA 2 (1530) may transmit an uplink frame to the AP (1520) after a SIFS duration from the completion of reception of the TXS start indication frame. The final destination of the uplink frame is STA 1 (1510). The uplink frame is delivered to STA 1 (1510) via the AP (1520). STA 2 (1530) sets the MAC header of the uplink data frame as shown in [Table 4].

Upon completing reception of the uplink frame of STA 2 (1530), the AP (1520) may transmit a response frame after a SIFS duration. The response frame may be a block acknowledgment (BA) frame. The uplink frame of STA 2 (1530) may be the last frame. Accordingly, after receiving the response frame of the AP (1520), STA 2 (1530) transmits a frame indicating the last frame.

The AP (1520) receives the frame indicating the last frame from STA 2 (1530) and may recognize that STA 2 (1530) has completed data frame transmission. Accordingly, the AP (1520) may transmit a downlink frame to STA 1 (1510) after a SIFS duration from the completion of reception of the frame indicating the last frame. The downlink frame may be a frame that forwards the uplink frame transmitted by STA 2 (1530) to the AP (1520) to STA 1 (1510). The AP (1520) sets the MAC header of the downlink frame as shown in [Table 5].

STA 1 (1510) may receive the downlink frame from the AP (1520) and may identify that the original transmitter of the received frame is STA 2 (1530). STA 1 (1510) transmits a response frame to the AP (1520) after a SIFS duration from the completion of reception of the downlink frame. The bidirectional TXOP sharing may be completed. After the bidirectional TXOP procedure is completed, a remaining period may exist in the TXOP. When the TXOP holder is a STA (e.g., STA 1), the STA may transmit an uplink data frame to the AP (1520), or the STA may restart the bidirectional TXOP sharing procedure (e.g., the bidirectional TXOP sharing configuration procedure or the bidirectional TXOP sharing data transmission procedure). Alternatively, the STA may transmit a contention free (CF)-End frame to terminate the TXOP. When the TXOP is terminated, the NAV corresponding to the length of the TXOP is released. When the TXOP holder is the AP (1520), the AP (1520) may transmit a downlink data frame to a STA (e.g., STA 1), or the AP (1520) may restart the bidirectional TXOP sharing procedure (e.g., the bidirectional TXOP sharing configuration procedure or the bidirectional TXOP sharing data transmission procedure). Alternatively, the AP (1520) may transmit a contention free (CF)-End frame to terminate the TXOP. When the TXOP is terminated, the NAV corresponding to the length of the TXOP is released.

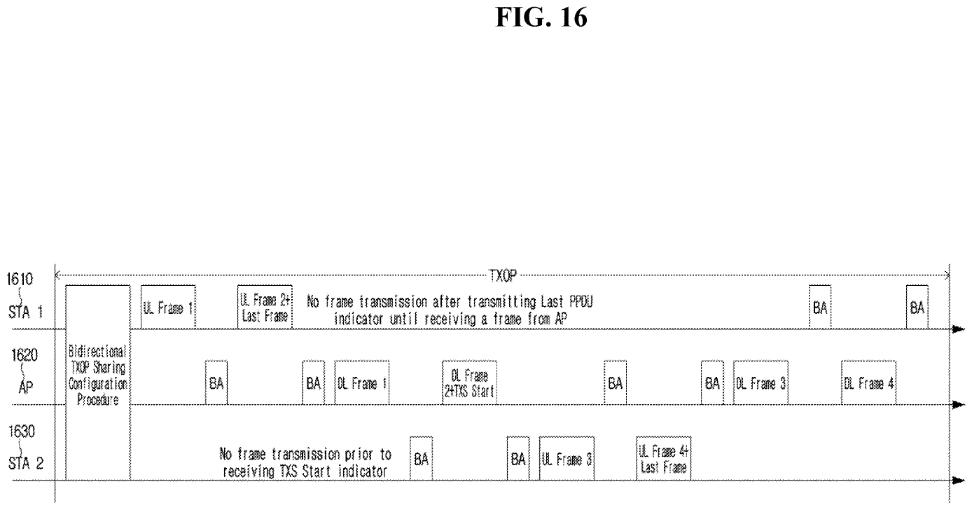

FIG. 16 is a diagram illustrating a bidirectional TXOP sharing data transmission method in a wireless LAN to which the present disclosure is applied. Referring to FIG. 16, STA 1 (1610), STA 2 (1630), and the AP (1620) have performed the bidirectional TXOP sharing configuration procedure within the TXOP in the same or similar manner as the embodiments of FIG. 9 through FIG. 13, and bidirectional TXOP sharing between STA 1 (1610) and STA 2 (1630) has been configured. When the bidirectional TXOP sharing configuration procedure has been performed, the bidirectional TXOP sharing data transmission procedure of the present embodiment is performed. STA 1 (1610) may be configured to transmit data first, and STA 2 (1630) to transmit data thereafter.

STA 1 (1610) transmits a plurality (one or more) of uplink (UL) frames to the AP (1620). The final destination of the uplink frames is STA 2 (1630). The uplink frames are delivered to STA 2 (1630) via the AP (1620). STA 1 (1610) sets the MAC header of the uplink frames as shown in [Table 2].

In an embodiment, STA 1 (1610) may transmit two uplink frames. The first uplink frame (UL Frame 1) may not be the last frame transmitted in the bidirectional TXOP sharing operation of STA 1 (1610). Accordingly, the first uplink frame does not include the last frame indicator described below. Alternatively, an indicator indicating that the frame is not the last frame may be included in the first uplink frame. The AP (1620) receives the first uplink frame of STA 1 (1610) and confirms that the first uplink frame of STA 1 (1610) is not the last frame. Accordingly, the AP (1620) may recognize that there are more frames to be received from STA 1 (1610) and does not perform downlink frame transmission. The AP (1620) transmits a response frame to STA 1 (1610) after a SIFS duration from the completion of reception of the first uplink frame of STA 1 (1610). The response frame may be a block acknowledgment (BA) frame. STA 1 (1610) transmits the second uplink frame, UL Frame 2, to the AP (1620) after a SIFS duration from the completion of reception of the response frame for the first uplink frame. The second uplink frame (UL Frame 2) transmitted by STA 1 (1610) is the last frame transmitted in the bidirectional TXOP sharing operation of STA 1 (1610). Accordingly, the second uplink frame includes the last frame indicator. The last frame indicator indicates to the AP (1620) the last frame transmitted by the terminal in the bidirectional TXOP sharing. When STA 1 (1610) transmits the last frame indicator to the AP (1620), STA 1 (1610) may not transmit frames until the AP (1620) transmits to STA 1 (1610). The last frame indicator may be an indicator in which the more data bit included in the MAC header of the frame is set to 0, a specific value is indicated in the address 4 field, or an indicator included in the A-control field of the HT control field. The last frame indicator may be more diverse and may be a separate frame. That is, a frame including the last frame indicator may be transmitted separately.

Upon completing reception of the second uplink frame, UL Frame 2, of STA 1 (1610), the AP (1620) may transmit a response frame after a SIFS duration. The AP (1620) may transmit a plurality of downlink frames to STA 2 (1630) after a SIFS duration from the completion of transmission of the response frame to STA 1 (1610). The downlink frames may be frames that forward the uplink frames transmitted by STA 1 (1610) to the AP (1620) to STA 2 (1630). The AP (1620) sets the MAC header of the downlink frames as shown in [Table 3].

In an embodiment, the AP (1620) may transmit two downlink frames destined for STA 2 (1630). The first downlink frame of the AP (1620), DL Frame 1, may not be the last frame transmitted by the AP (1620) to STA 2 (1630). Accordingly, the AP (1620) does not include the TXS start indicator described below in the first downlink frame transmitted to STA 2 (1630) so that STA 2 (1630) does not initiate transmission in the bidirectional TXOP sharing. Alternatively, an indicator indicating that the frame is not the last frame may be included in the first downlink frame. STA 2 (1630) receives the first downlink frame from the AP (1620) and may recognize that there are more frames to be received. Accordingly, STA 2 (1630) does not perform uplink frame transmission. STA 2 (1630) transmits a response frame to the AP (1620) after a SIFS duration from the completion of reception of the first uplink frame. The AP (1620) transmits the second downlink frame, DL Frame 2, to STA 2 (1630) after a SIFS duration from the completion of reception of the response frame from STA 2 (1630). The second downlink frame of the AP (1620) may be the last frame transmitted to STA 2 (1630). The AP (1620) may include a TXS start indicator in the downlink frame transmitted to STA 2 (1630), indicating that STA 2 (1630) is to initiate transmission in the bidirectional TXOP sharing. The TXS start indicator may be an indicator in which the more data bit included in the MAC header of the frame is set to 0, a specific value is indicated in the address 4 field, or an indicator included in the A-control field of the HT control field. The TXS start indicator may be more diverse and may be a separate frame. That is, a frame including the TXS start indicator may be transmitted separately.

In addition, STA 2 (1630) may receive the second downlink frame, DL Frame 2, from the AP (1620), and STA 2 (1630) transmits a response frame to the AP (1620) after a SIFS duration from the completion of reception of the downlink frame. STA 2 (1630) may identify that the original transmitter of the received frames is STA 1 (1610). STA 2 (1630) may check the TXS start indicator present in the downlink frame and may recognize that STA 2 (1630) is able to perform uplink transmission. STA 2 (1630) does not perform uplink transmission to the AP (1620) until receiving the TXS start indicator. STA 2 (1630) may transmit a plurality of uplink frames to the AP (1620) after a SIFS duration from the completion of transmission of the response frame. The final destination of the uplink frames is STA 1 (1610). The uplink frames are delivered to STA 1 (1610) via the AP (1620). STA 2 (1630) sets the MAC header of the uplink data frames as shown in [Table 4].

In an embodiment, STA 2 (1630) may transmit two uplink frames. The first uplink frame (UL Frame 3) may not be the last frame transmitted in the bidirectional TXOP sharing operation of STA 2 (1630). Accordingly, the first uplink frame does not include the last frame indicator described below. Alternatively, an indicator indicating that the frame is not the last frame may be included in the first uplink frame. The AP (1620) receives the first uplink frame of STA 2 (1630) and confirms that the first uplink frame of STA 2 (1630) is not the last frame. Accordingly, the AP (1620) may recognize that there are more frames to be received from STA 2 (1630) and does not perform downlink frame transmission. The AP (1620) transmits a response frame to STA 2 (1630) after a SIFS duration from the completion of reception of the first uplink frame of STA 2 (1630). STA 2 (1630) transmits the second uplink frame, UL Frame 4, to the AP (1620) after a SIFS duration from the completion of reception of the response frame for the first uplink frame. The second uplink frame (UL Frame 4) transmitted by STA 2 (1630) is the last frame transmitted in the bidirectional TXOP sharing operation of STA 2 (1630). Accordingly, the second uplink frame includes the last frame indicator. After receiving the second uplink frame, UL Frame 4, including the last frame indicator, the AP (1620) transmits a response frame to STA 2 (1630) after a SIFS duration. The AP (1620) may transmit downlink frames (DL Frame 3, DL Frame 4) to STA 1 (1610) after a SIFS duration from the transmission of the response frame for UL Frame 4. The downlink frames may be frames that forward the uplink frames transmitted by STA 2 (1630) to the AP (1620) to STA 1 (1610). The AP (1620) sets the MAC header of the downlink frames as shown in [Table 5].

STA 1 (1610) may receive the downlink frames from the AP (1620) and may identify that the original transmitter of the received frames is STA 2 (1630). STA 1 (1610) transmits a response frame to the AP (1620) after a SIFS duration from the completion of reception of the downlink frames. The bidirectional TXOP sharing may be completed. After the bidirectional TXOP procedure is completed, a remaining period may exist in the TXOP. When the TXOP holder is a STA (e.g., STA 1), the STA may transmit an uplink data frame to the AP (1620), or the STA may restart the bidirectional TXOP sharing procedure (e.g., the bidirectional TXOP sharing configuration procedure or the bidirectional TXOP sharing data transmission procedure). Alternatively, the STA may transmit a contention free (CF)-End frame to terminate the TXOP. When the TXOP is terminated, the NAV corresponding to the length of the TXOP is released. When the TXOP holder is the AP (1620), the AP (1620) may transmit a downlink data frame to a STA (e.g., STA 1), or the AP (1620) may restart the bidirectional TXOP sharing procedure (e.g., the bidirectional TXOP sharing configuration procedure or the bidirectional TXOP sharing data transmission procedure). Alternatively, the AP (1620) may transmit a contention free (CF)-End frame to terminate the TXOP. When the TXOP is terminated, the NAV corresponding to the length of the TXOP is released.

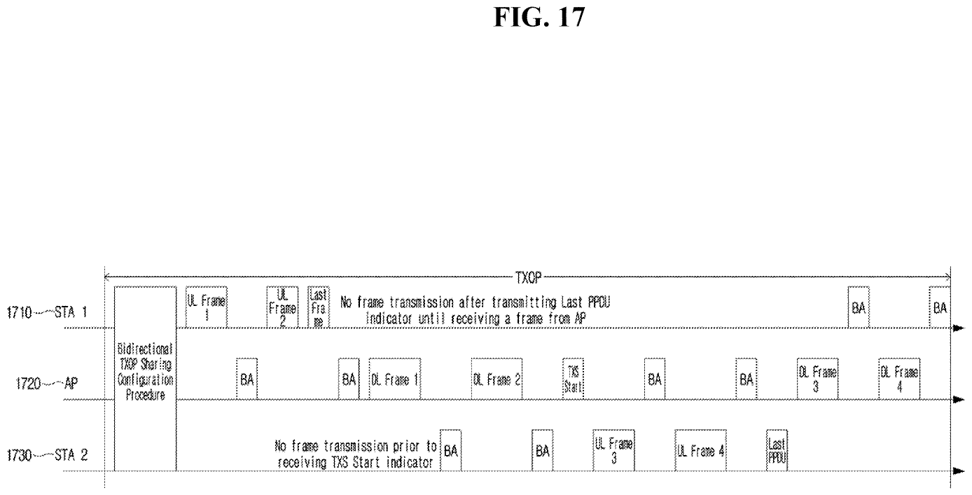

FIG. 17 is a diagram illustrating a bidirectional TXOP sharing data transmission method in a wireless LAN to which the present disclosure is applied.

Referring to FIG. 17, STA 1 (1710), STA 2 (1730), and the AP (1720) have performed the bidirectional TXOP sharing configuration procedure within the TXOP in the same or similar manner as the embodiments of FIG. 9 through FIG. 13, and bidirectional TXOP sharing between STA 1 (1710) and STA 2 (1730) has been configured. When the bidirectional TXOP sharing configuration procedure has been performed, the bidirectional TXOP sharing data transmission procedure of the present embodiment is performed. STA 1 (1710) may be configured to transmit data first, and STA 2 (1730) to transmit data thereafter.

STA 1 (1710) transmits a plurality (one or more) of uplink (UL) frames to the AP (1720). The final destination of the uplink frames is STA 2 (1730). The uplink frames are delivered to STA 2 (1730) via the AP (1720). STA 1 (1710) sets the MAC header of the uplink frames as shown in [Table 2].

In an embodiment, STA 1 (1710) may transmit two uplink frames. The first uplink frame (UL Frame 1) may not be the last frame transmitted in the bidirectional TXOP sharing operation of STA 1 (1710). Accordingly, the first uplink frame does not include the last frame indicator described below. Alternatively, an indicator indicating that the frame is not the last frame may be included in the first uplink frame. The AP (1720) receives the first uplink frame of STA 1 (1710) and confirms that the first uplink frame of STA 1 (1710) is not the last frame. Accordingly, the AP (1720) may recognize that there are more frames to be received from STA 1 (1710) and does not perform downlink frame transmission. The AP (1720) transmits a response frame to STA 1 (1710) after a SIFS duration from the completion of reception of the first uplink frame of STA 1 (1710). The response frame may be a block acknowledgment (BA) frame. STA 1 (1710) transmits the second uplink frame, UL Frame 2, to the AP (1720) after a SIFS duration from the completion of reception of the response frame for the first uplink frame.

Upon completing reception of the second uplink frame, UL Frame 2, of STA 1 (1710), the AP (1720) may transmit a response frame after a SIFS duration. The second uplink frame, UL Frame 2, of STA 1 (1710) may be the last frame. Accordingly, after receiving the response frame of the AP (1720), STA 1 (1710) transmits a frame including the last frame indicator (last frame indication frame) to the AP (1720) after a SIFS duration. The last frame indicator indicates to the AP (1720) the last frame transmitted by the terminal in the bidirectional TXOP sharing. When STA 1 (1710) transmits the last frame indicator to the AP (1720), STA 1 (1710) may not transmit frames until the AP (1720) transmits to STA 1 (1710). The last frame indicator may be an indicator in which the more data bit included in the MAC header of the frame is set to 0, a specific value is indicated in the address 4 field, or an indicator included in the A-control field of the HT control field. The last frame indicator may be defined by the frame format itself. That is, a specific frame format or a specific frame may be the last frame indicator.

The AP (1720) may transmit a plurality of downlink frames to STA 2 (1730) after a SIFS duration from the completion of reception of the last frame indication frame from STA 1 (1710). The downlink frames may be frames that forward the uplink frames transmitted by STA 1 (1710) to the AP (1720) to STA 2 (1730). The AP (1720) sets the MAC header of the downlink frames as shown in [Table 3].

In addition, In an embodiment, the AP (1720) may transmit two downlink frames destined for STA 2 (1730). The first downlink frame of the AP (1720), DL Frame 1, may not be the last frame transmitted by the AP (1720) to STA 2 (1730). Accordingly, the AP (1720) does not include the TXS start indicator described below in the first downlink frame transmitted to STA 2 (1730) so that STA 2 (1730) does not initiate transmission in the bidirectional TXOP sharing. Alternatively, an indicator indicating that the frame is not the last frame may be included in the first downlink frame. STA 2 (1730) receives the first downlink frame from the AP (1720) and may recognize that there are more frames to be received. Accordingly, STA 2 (1730) does not perform uplink frame transmission. STA 2 (1730) transmits a response frame to the AP (1720) after a SIFS duration from the completion of reception of the first uplink frame. The AP (1720) transmits the second downlink frame, DL Frame 2, to STA 2 (1730) after a SIFS duration from the completion of reception of the response frame from STA 2 (1730). STA 2 (1730) may receive the second downlink frame, DL Frame 2, from the AP (1720), and STA 2 (1730) transmits a response frame to the AP (1720) after a SIFS duration from the completion of reception of the downlink frame. STA 2 (1730) may identify that the original transmitter of the received frames is STA 1 (1710).

The second downlink frame of the AP (1720), DL Frame 2, may be the last frame transmitted to STA 2 (1730). After receiving the response frame of STA 2 (1730), the AP (1720) may transmit a frame including a TXS start indicator (TXS start indication frame) after a SIFS duration to the downlink frame transmitted to STA 2 (1730), indicating that STA 2 (1730) is to initiate transmission in the bidirectional TXOP sharing. The TXS start indicator may be an indicator in which the more data bit included in the MAC header of the frame is set to 0, a specific value is indicated in the address 4 field, or an indicator included in the A-control field of the HT control field. The TXS start indicator may be more diverse. The TXS start indicator may be defined by the frame format itself. That is, a specific frame format or a specific frame may be the TXS start indicator.

STA 2 (1730) receives the TXS start indication frame and may confirm the TXS start indicator, thereby recognizing that STA 2 (1730) is able to perform uplink transmission. STA 2 (1730) does not perform uplink transmission to the AP (1720) until receiving the TXS start indicator. STA 2 (1730) may transmit a plurality of uplink frames to the AP (1720) after a SIFS duration from the completion of reception of the TXS start indication frame. The final destination of the uplink frames is STA 1 (1710). The uplink frames are delivered to STA 1 (1710) via the AP (1720). STA 2 (1730) sets the MAC header of the uplink data frames as shown in [Table 4].

In an embodiment, STA 2 (1730) may transmit two uplink frames. The first uplink frame (UL Frame 3) may not be the last frame transmitted in the bidirectional TXOP sharing operation of STA 2 (1730). Accordingly, the first uplink frame does not include the last frame indicator described below. Alternatively, an indicator indicating that the frame is not the last frame may be included in the first uplink frame. The AP (1720) receives the first uplink frame of STA 2 (1730) and confirms that the first uplink frame of STA 2 (1730) is not the last frame. Accordingly, the AP (1720) may recognize that there are more frames to be received from STA 2 (1730) and does not perform downlink frame transmission. The AP (1720) transmits a response frame to STA 1 (1710) after a SIFS duration from the completion of reception of the first uplink frame of STA 2 (1730). STA 2 (1730) transmits the second uplink frame, UL Frame 4, to the AP (1720) after a SIFS duration from the completion of reception of the response frame for the first uplink frame. After receiving UL Frame 4, the AP transmits a response frame to STA 2 (1730) after a SIFS duration.

The second uplink frame (UL Frame 4) transmitted by STA 2 (1730) is the last frame transmitted in the bidirectional TXOP sharing operation of STA 2 (1730). Accordingly, after receiving the response frame of the AP (1720), STA 2 (1730) transmits a frame including the last frame indicator (last frame indication frame) to the AP (1720) after a SIFS duration.

The AP (1720) may transmit downlink frames (DL Frame 3, DL Frame 4) to STA 1 (1710) after a SIFS duration from the reception of the last frame indication frame. The downlink frames may be frames that forward the uplink frames transmitted by STA 2 (1730) to the AP (1720) to STA 1 (1710). The AP (1720) sets the MAC header of the downlink frames as shown in [Table 5].

STA 1 (1710) may receive the downlink frames from the AP (1720) and may identify that the original transmitter of the received frames is STA 2 (1730). STA 1 (1710) transmits a response frame to the AP (1720) after a SIFS duration from the completion of reception of the downlink frames. The bidirectional TXOP sharing may be completed. After the bidirectional TXOP procedure is completed, a remaining period may exist in the TXOP. When the TXOP holder is a STA (e.g., STA 1), the STA may transmit an uplink data frame to the AP (1720), or the STA may restart the bidirectional TXOP sharing procedure (e.g., the bidirectional TXOP sharing configuration procedure or the bidirectional TXOP sharing data transmission procedure). Alternatively, the STA may transmit a contention free (CF)-End frame to terminate the TXOP. When the TXOP is terminated, the NAV corresponding to the length of the TXOP is released. When the TXOP holder is the AP (1720), the AP (1720) may transmit a downlink data frame to a STA (e.g., STA 1), or the AP (1720) may restart the bidirectional TXOP sharing procedure (e.g., the bidirectional TXOP sharing configuration procedure or the bidirectional TXOP sharing data transmission procedure). Alternatively, the AP (1720) may transmit a contention free (CF)-End frame to terminate the TXOP. When the TXOP is terminated, the NAV corresponding to the length of the TXOP is released.

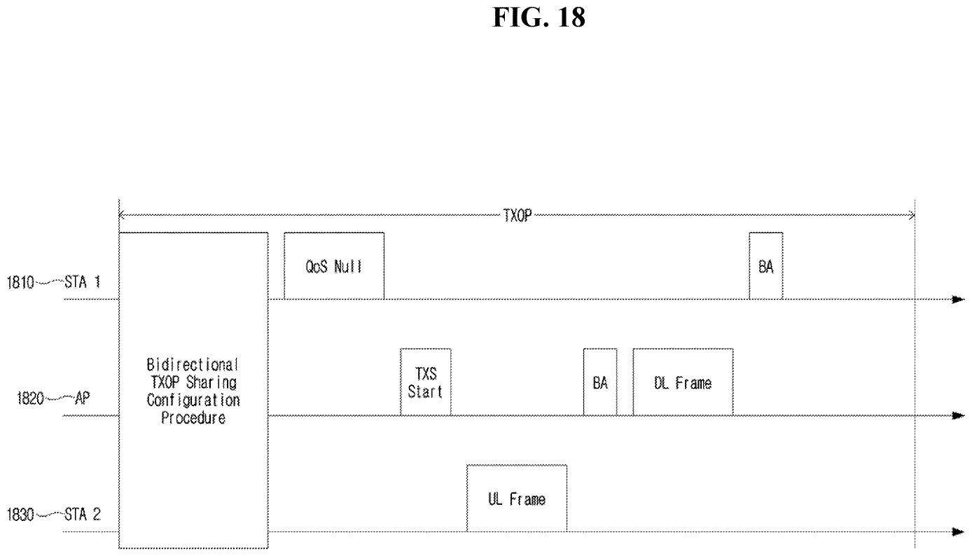

FIG. 18 is a diagram illustrating a bidirectional TXOP sharing data transmission method in a wireless LAN to which the present disclosure is applied. Referring to FIG. 18, STA 1 (1810), STA 2 (1830), and the AP (1820) have performed the bidirectional TXOP sharing configuration procedure within the TXOP in the same or similar manner as the embodiments of FIG. 9 through FIG. 13, and bidirectional TXOP sharing between STA 1 (1810) and STA 2 (1830) has been configured. When the bidirectional TXOP sharing configuration procedure has been performed, the bidirectional TXOP sharing data transmission procedure of the present embodiment is performed. In the bidirectional TXOP sharing procedure, STA 1 (1810) may be configured to transmit data first, and STA 2 (1830) to transmit data thereafter.

STA 1 (1810) transmits an uplink (UL) frame to the AP (1820). The final destination of the uplink frame is STA 2 (1830). The uplink frame is delivered to STA 2 (1830) via the AP (1820). STA 1 (1810) sets the MAC header of the uplink frame as shown in [Table 2]. Alternatively, the uplink frame of STA 1 (1810) may have no data to be transmitted to STA 2 (1830), and the MAC header of the uplink frame may be set as shown in [Table 6] so that the destination of the uplink frame is the AP (1820).

TABLE 6

| | Field | | | | |
|---|---|---|---|---|---|
| | | | Address 1 Field | Address 2 Field | Address 3 Field |
| | | | (Receiver | (Transmitter | (Destination |
| | Frame Control Field | | Address) | Address) | Address) |
| | Subfield | | | | |
| | To DS | From DS | N/A | N/A | N/A |
| Value | 1 | 0 | AP Address | STA 1 Address | AP Address |

The uplink frame of STA 1 (1810) may be a QoS Null frame, which is a frame with no MAC frame body. That is, STA 1 (1810) may have no frame (data) to transmit to STA 2 (1830). The ACK policy of the QoS Null frame of STA 1 (1810) may be set to block acknowledgment (BlockAck). When the ACK policy of the QoS Null frame of STA 1 (1810) is BlockAck, the AP (1820) does not need to transmit a response frame to the QoS Null frame of STA 1 (1810). The ACK policy of the QoS Null frame of STA 1 (1810) may be set to implicit BAR (block acknowledgment request), or the ACK policy may be set to normal ACK. AP (1820) responds with a BA frame when the ACK policy of the QoS Null frame is implicit BAR, and with an ACK frame when it is normal ACK. To indicate that STA 1 (1810) has no frame to transmit, the QoS Null frame may include a last frame indicator indicating that it is the last frame of STA 1 (1810) in the same or similar manner as the embodiment of FIG. 14. Alternatively, STA 1 (1810) may transmit a last frame indication frame in the same or similar manner as the embodiment of FIG. 15.

When STA 1 (1810) transmits a QoS Null frame, the AP (1820) may enable STA 2 (1830) to perform uplink transmission. The AP (1820) may transmit a frame including a TXS start indicator (TXS start indication frame) indicating that STA 2 (1830) is to initiate transmission in the bidirectional TXOP sharing. The transmission of the frame including the TXS start indicator may be the same as or similar to the embodiment of FIG. 15.

STA 2 (1830) receives the TXS start indication frame and may confirm the TXS start indicator, thereby recognizing that STA 2 (1830) is able to perform uplink transmission. STA 2 (1830) does not perform uplink transmission to the AP (1820) until receiving the TXS start indicator. STA 2 (1830) may transmit an uplink frame to the AP (1820) after a SIFS duration from the completion of reception of the TXS start indication frame. The final destination of the uplink frame is STA 1 (1810). The uplink frame is delivered to STA 1 (1810) via the AP (1820). STA 2 (1830) sets the MAC header of the uplink data frame as shown in [Table 4].

Upon completing reception of the uplink frame of STA 2 (1830), the AP (1820) may transmit a response frame after a SIFS duration. The response frame may be a block acknowledgment (BA) frame. The uplink frame of STA 2 (1830) may be the last frame. STA 2 (1830) may include an indicator indicating the last frame in the uplink frame in the same or similar manner as the embodiment of FIG. 14, or may transmit a separate frame indicating the last frame in the same or similar manner as the embodiment of FIG. 15.

The AP (1820) may transmit a downlink frame to STA 1 (1810) after a SIFS duration from the completion of reception of the frame indicating the last frame, or from the transmission of the response frame after receiving the uplink frame of STA 2 (1830) including the indicator indicating the last frame. The downlink frame may be a frame that forwards the uplink frame transmitted by STA 2 (1830) to the AP (1820) to STA 1 (1810). The AP (1820) sets the MAC header of the downlink frame as shown in [Table 5].

STA 1 (1810) may receive the downlink frame from the AP (1820) and may identify that the original transmitter of the received frame is STA 2 (1830). STA 1 (1810) transmits a response frame to the AP (1820) after a SIFS duration from the completion of reception of the downlink frame. The bidirectional TXOP sharing may be completed. After the bidirectional TXOP procedure is completed, a remaining period may exist in the TXOP. When the TXOP holder is a STA (e.g., STA 1), the STA may transmit an uplink data frame to the AP (1820), or the STA may restart the bidirectional TXOP sharing procedure (e.g., the bidirectional TXOP sharing configuration procedure or the bidirectional TXOP sharing data transmission procedure). Alternatively, the STA may transmit a contention free (CF)-End frame to terminate the TXOP. When the TXOP is terminated, the NAV corresponding to the length of the TXOP is released. When the TXOP holder is the AP (1820), the AP (1820) may transmit a downlink data frame to a STA (e.g., STA 1), or the AP (1820) may restart the bidirectional TXOP sharing procedure (e.g., the bidirectional TXOP sharing configuration procedure or the bidirectional TXOP sharing data transmission procedure). Alternatively, the AP (1820) may transmit a contention free (CF)-End frame to terminate the TXOP. When the TXOP is terminated, the NAV corresponding to the length of the TXOP is released.

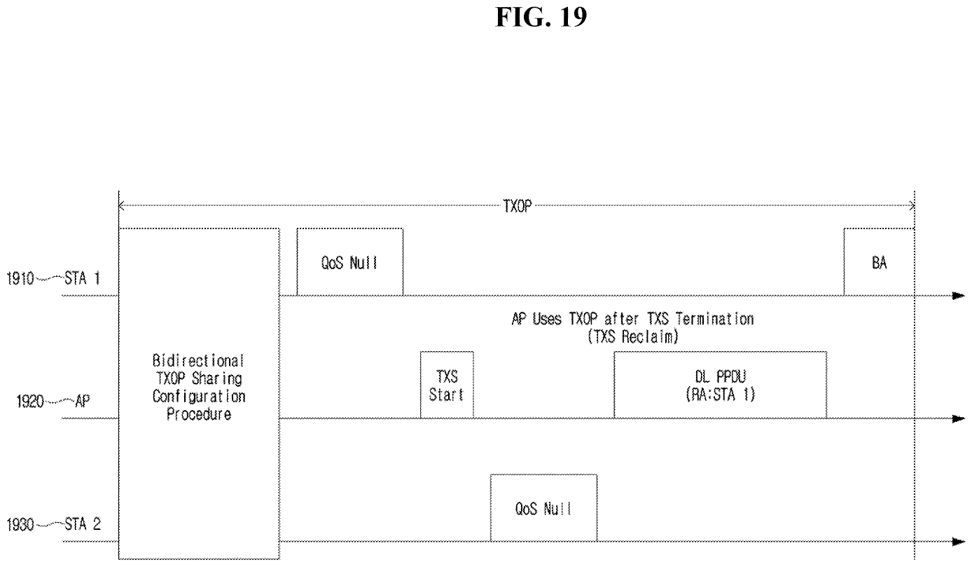

FIG. 19 is a diagram illustrating a bidirectional TXOP sharing data transmission method in a wireless LAN to which the present disclosure is applied.

Referring to FIG. 19, STA 1 (1910), STA 2 (1930), and the AP (1920) have performed the bidirectional TXOP sharing configuration procedure within the TXOP in the same or similar manner as the embodiments of FIG. 9 through FIG. 13, and bidirectional TXOP sharing between STA 1 (1910) and STA 2 (1930) has been configured. When the bidirectional TXOP sharing configuration procedure has been performed, the bidirectional TXOP sharing data transmission procedure of the present embodiment is performed. In the bidirectional TXOP sharing procedure, STA 1 (1910) may be configured to transmit data first, and STA 2 (1930) to transmit data thereafter.

STA 1 (1910) transmits an uplink (UL) frame to the AP (1920). The final destination of the uplink frame is STA 2 (1930). The uplink frame is delivered to STA 2 (1930) via the AP (1920). STA 1 (1910) sets the MAC header of the uplink frame as shown in [Table 2]. Alternatively, the uplink frame of STA 1 (1910) may have no data to be transmitted to STA 2 (1930), and the MAC header of the uplink frame may be set as shown in [Table 6] so that the destination of the uplink frame is the AP (1920).

The uplink frame of STA 1 (1910) may be a QoS Null frame, which is a frame with no MAC frame body. That is, STA 1 (1910) may have no frame (data) to transmit to STA 2 (1930). The ACK policy of the QoS Null frame of STA 1 (1910) may be set to block acknowledgment (BlockAck). When the ACK policy of the QoS Null frame of STA 1 (1910) is BlockAck, the AP (1920) does not need to transmit a response frame to the QoS Null frame of STA 1 (1910). The ACK policy of the QoS Null frame of STA 1 (1910) may be set to implicit BAR (block acknowledgment request), or the ACK policy may be set to normal ACK. AP (1920) responds with a BA frame when the ACK policy of the QoS Null frame is implicit BAR, and with an ACK frame when it is normal ACK. To indicate that STA 1 (1910) has no frame to transmit, the QoS Null frame may include a last frame indicator indicating that it is the last frame of STA 1 (1910) in the same or similar manner as the embodiment of FIG. 14. Alternatively, STA 1 (1910) may transmit a last frame indication frame in the same or similar manner as the embodiment of FIG. 15.

When STA 1 (1910) transmits a QoS Null frame, the AP (1920) may enable STA 2 (1930) to perform uplink transmission. The AP (1920) may transmit a frame including a TXS start indicator (TXS start indication frame) indicating that STA 2 (1930) is to initiate transmission in the bidirectional TXOP sharing. The transmission of the frame including the TXS start indicator may be the same as or similar to the embodiment of FIG. 15.

STA 2 (1930) receives the TXS start indication frame and may confirm the TXS start indicator, thereby recognizing that STA 2 (1930) is able to perform uplink transmission. STA 2 (1930) does not perform uplink transmission to the AP (1920) until receiving the TXS start indicator. STA 2 (1930) may transmit an uplink frame to the AP (1920) after a SIFS duration from the completion of reception of the TXS start indication frame. The final destination of the uplink frame is STA 1 (1910). The uplink frame is delivered to STA 1 (1910) via the AP (1920). STA 2 (1930) sets the MAC header of the uplink data frame as shown in [Table 4]. Alternatively, the uplink frame of STA 2 (1930) may have no data to be transmitted to STA 1 (1910), and the MAC header of the uplink frame may be set as shown in [Table 7] so that the destination of the uplink frame is the AP (1920).

TABLE 7

| | Field | | | | |
|---|---|---|---|---|---|
| | | | Address 1 Field | Address 2 Field | Address 3 Field |
| | | | (Receiver | (Transmitter | (Destination |
| | Frame Control Field | | Address) | Address) | Address) |
| | Subfield | | | | |
| | To DS | From DS | N/A | N/A | N/A |
| Value | 1 | 0 | AP Address | STA 1 Address | AP Address |

The uplink frame of STA 2 (1930) may be a QoS Null frame, which is a frame with no MAC frame body. That is, STA 2 (1930) may have no frame (data) to transmit to STA 1 (1910). The ACK policy of the QoS Null frame of STA 2 (1930) may be set to block acknowledgment (BlockAck). When the ACK policy of the QoS Null frame of STA 2 (1930) is BlockAck, the AP (1920) does not need to transmit a response frame to the QoS Null frame of STA 1 (1910). The ACK policy of the QoS Null frame of STA 2 (1930) may be set to implicit BAR (block acknowledgment request), or the ACK policy may be set to normal ACK. The AP (1920) responds with a BA frame when the ACK policy of the QoS Null frame is implicit BAR, and with an ACK frame when it is normal ACK. To indicate that STA 2 (1930) has no frame to transmit, the QoS Null frame may include a last frame indicator indicating that it is the last frame of STA 2 (1930) in the same or similar manner as the embodiment of FIG. 14. Alternatively, STA 2 (1930) may transmit a last frame indication frame in the same or similar manner as the embodiment of FIG. 15.

When the AP (1920) receives QoS Null frames from both STA 1 (1910) and STA 2 (1930), the AP (1920) terminates (completes) the bidirectional TXOP sharing operation. After the bidirectional TXOP procedure is completed, a remaining period may exist in the TXOP. When the TXOP holder is a STA (e.g., STA 1), the STA may transmit an uplink data frame to the AP (1920), or the STA may restart the bidirectional TXOP sharing procedure (e.g., the bidirectional TXOP sharing configuration procedure or the bidirectional TXOP sharing data transmission procedure). Alternatively, the STA may transmit a contention free (CF)-End frame to terminate the TXOP. When the TXOP is terminated, the NAV corresponding to the length of the TXOP is released. When the TXOP holder is the AP (1920), the AP (1920) may transmit a downlink data frame to a STA (e.g., STA 1), or the AP (1920) may restart the bidirectional TXOP sharing procedure (e.g., the bidirectional TXOP sharing configuration procedure or the bidirectional TXOP sharing data transmission procedure). Alternatively, the AP (1920) may transmit a contention free (CF)-End frame to terminate the TXOP. When the TXOP is terminated, the NAV corresponding to the length of the TXOP is released.

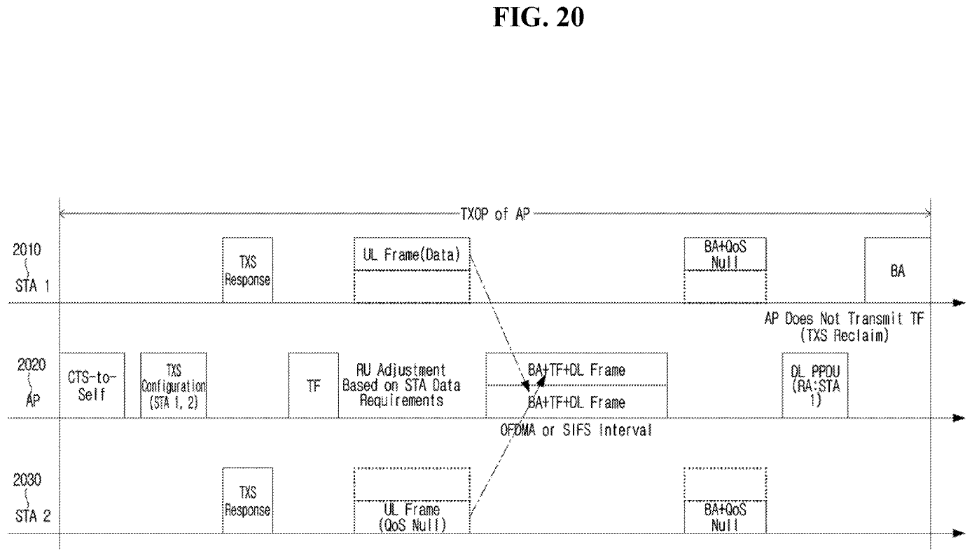

FIG. 20 is a diagram illustrating a bidirectional OFDMA transmission method in a wireless LAN to which the present disclosure is applied. Referring to FIG. 20, a TXOP sharing configuration procedure for bidirectional orthogonal frequency division multiple access (OFDMA) transmission (bidirectional TXOP sharing configuration procedure) is performed. This may be the same as or similar to the procedure related to the embodiments of FIG. 9 through FIG. 13. In the embodiment of FIG. 20, the TXOP sharing configuration procedure may be a procedure corresponding to FIG. 11. That is, within the TXOP of the AP (2020), the AP (2020) transmits a TXS configuration frame (e.g., an MU-RTS trigger frame) including the identifiers of STA 1 (2010) and/or STA 2 (2030), and STA 1 (2010) and STA 2 (2030) may transmit a TXS response frame (e.g., an S-CTS frame or a CTS frame) in response to the TXS configuration frame. Through the procedure, STA 1 (2010) and STA 2 (2030) may transmit data bidirectionally. That is, bidirectional OFDMA transmission has been configured.

When bidirectional OFDMA transmission is configured, the bidirectional OFDMA transmission procedure begins. The AP (2020) transmits a trigger frame including the identifiers (e.g., AIDs) of STA 1 (2010) and STA 2 (2030) for which bidirectional OFDMA transmission has been configured. The trigger frame includes uplink resource allocation information for STA 1 (2010) and STA 2 (2030). The uplink resource allocation information includes resource unit (RU) information available to STA 1 (2010) and STA 2 (2030), and uplink length information. An RU may be a collection of tones, which are OFDMA subcarriers. AP (2020) has already received the buffer status reports (BSRs) transmitted by STA 1 (2010) and STA 2 (2030), or may transmit a BSRP trigger frame prior to transmitting the trigger frame to receive BSRs from STA 1 (2010) and STA 2 (2030), and may be aware of the traffic status of STA 1 (2010) and STA 2 (2030). The BSR may indicate the status of traffic stored in the transmission queue or buffer of STA 1 (2010) and STA 2 (2030) (e.g., the amount of stored traffic). Alternatively, the AP (2020) may be aware of the traffic status of STA 1 (2010) and STA 2 (2030) through the prediction of the machine learning unit of FIG. 3 and FIG. 4. In an embodiment, AP (2020) may predict the uplink traffic status of STA 1 (2010) and STA 2 (2030) by using the BSRs transmitted by STA 1 (2010) and STA 2 (2030) and the traffic patterns of STA 1 (2010) and STA 2 (2030) as input to the machine learning unit. When the AP (2020) is aware of the traffic status of STA 1 (2010) and STA 2 (2030), the AP (2020) may allocate uplink resources in accordance with the traffic conditions of STA 1 (2010) and STA 2 (2030). In an embodiment, when STA 1 (2010) has more traffic and STA 2 (2030) has relatively less traffic than STA 1 (2010), the AP (2020) may allocate more uplink resources (an RU with wider bandwidth) to STA 1 (2010), and the uplink resources allocated to STA 2 (2030) may be less than those allocated to STA 1 (2010). When the AP (2020) is not aware of the traffic status of STA 1 (2010) and STA 2 (2030), the AP (2020) may distribute uplink resources equally to STA 1 (2010) and STA 2 (2030). STA 1 (2010) and STA 2 (2030) receive the trigger frame transmitted by the AP (2020) and confirm the allocated uplink resources. STA 1 (2010) and STA 2 (2030) transmit uplink frames in a UL OFDMA manner according to the uplink resources allocated by the AP (2020). The uplink frame transmitted by STA 1 (2010) is destined for STA 2 (2030), and the frame transmitted by STA 2 (2030) is destined for STA 1 (2010). The AP (2020) receives the frames transmitted by STA 1 (2010) and STA 2 (2030) in the UL OFDMA manner, and may transmit a block acknowledgment (BA) frame, a trigger frame (TF), and a downlink frame (DL frame) to STA 1 (2010) and STA 2 (2030) after a SIFS duration from the completion of reception of the frames. The frames may be configured in the A-MPDU format and transmitted in the DL OFDMA manner. Alternatively, at least one of the three frames may not be configured as an A-MPDU. In an embodiment, the block acknowledgment frame may be replaced with a multi-STA block acknowledgment frame transmitted in the DL OFDMA manner or in a non-DL OFDMA manner. The downlink frame transmitted to STA 1 (2010) is a frame forwarded by the AP (2020) from the uplink frame transmitted by STA 2 (2030) to the AP (2020) in the UL OFDMA manner. The downlink frame transmitted to STA 2 (2030) is a frame forwarded by the AP (2020) from the uplink frame transmitted by STA 1 (2010) to the AP (2020) in the UL OFDMA manner.

STA 1 (2010) and STA 2 (2030) receive the block acknowledgment frame, trigger frame, and downlink frame received from the AP (2020) in the DL OFDMA manner. STA 1 (2010) and STA 2 (2030) confirm the trigger frame and confirm the uplink resources allocated to STA 1 (2010) and STA 2 (2030). STA 1 (2010) and STA 2 (2030) transmit block acknowledgment frames for the received downlink data frames and uplink frames in the UL OFDMA manner on the uplink resources confirmed in the trigger frame. STA 1 (2010) and STA 2 (2030) may have no more uplink frames to transmit. When STA 1 (2010) and STA 2 (2030) have no uplink frames to transmit, STA 1 (2010) and STA 2 (2030) may transmit QoS Null frames to the AP (2020). When the AP (2020) receives QoS Null frames from both STA 1 (2010) and STA 2 (2030), the AP (2020) terminates (completes) the bidirectional OFDMA transmission procedure. The AP (2020) may respond with block acknowledgment frames to the frames transmitted by STA 1 (2010) and STA 2 (2030) in the UL OFDMA manner, or may omit this when both STA 1 (2010) and STA 2 (2030) have transmitted QoS Null frames. Alternatively, STA 1 (2010) may not transmit a QoS Null frame to the AP (2020), while STA 2 (2030) may transmit a QoS Null frame to the AP (2020). The AP (2020) subsequently allocates uplink resources to STA 1 (2010) but no longer allocates resources to STA 2 (2030).

After the bidirectional OFDMA transmission procedure is completed, a remaining period may exist in the TXOP. The TXOP holder is the AP (2020). The AP (2020) may transmit a downlink data frame to a STA (e.g., STA 1), or the AP (2020) may restart the bidirectional TXOP sharing procedure (e.g., the bidirectional TXOP sharing configuration procedure or the bidirectional TXOP sharing data transmission procedure). Alternatively, the AP (2020) may transmit a contention free (CF)-End frame to terminate the TXOP. When the TXOP is terminated, the NAV corresponding to the length of the TXOP is released.

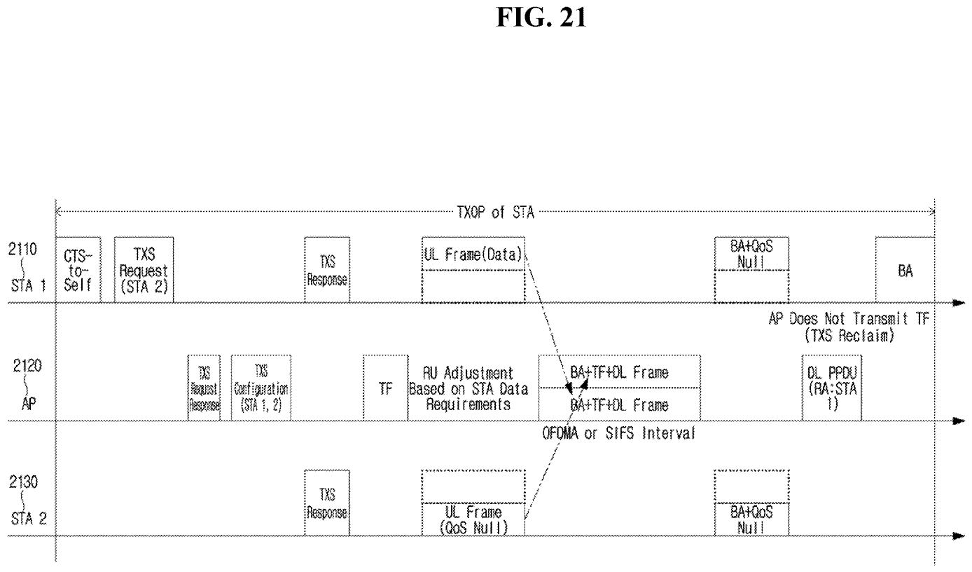

FIG. 21 is a diagram illustrating a bidirectional OFDMA transmission method in a wireless LAN to which the present disclosure is applied. Referring to FIG. 21, a TXOP sharing configuration procedure for bidirectional orthogonal frequency division multiple access (OFDMA) transmission (bidirectional TXOP sharing configuration procedure) is performed. This may be the same as or similar to the procedure related to the embodiments of FIG. 9 through FIG. 13. In the embodiment of FIG. 21, the TXOP sharing configuration procedure may be a procedure corresponding to FIG. 13. That is, within the TXOP of the STA, STA 1 (2110) transmits a TXS request frame to the AP (2120). The AP (2120) transmits a TXS request response frame in response to the TXS request frame and transmits a TXS configuration frame. The AP (2120) transmits a TXS configuration frame (e.g., an MU-RTS trigger frame) including the identifiers of STA 1 (2110) and/or STA 2 (2130), and STA 1 (2110) and STA 2 (2130) may transmit a TXS response frame (e.g., an S-CTS frame or a CTS frame) in response to the TXS configuration frame. Through the procedure, STA 1 (2110) and STA 2 (2130) may transmit data bidirectionally. That is, bidirectional OFDMA transmission has been configured.

When bidirectional OFDMA transmission is configured, the bidirectional OFDMA transmission procedure begins. The AP (2120) transmits a trigger frame including the identifiers (e.g., AIDs) of STA 1 (2110) and STA 2 (2130) for which bidirectional OFDMA transmission has been configured. The trigger frame includes uplink resource allocation information for STA 1 (2110) and STA 2 (2130). The uplink resource allocation information includes resource unit (RU) information available to STA 1 (2110) and STA 2 (2130), and uplink length information. An RU may be a collection of tones, which are OFDMA subcarriers. AP (2120) has already received the buffer status reports (BSRs) transmitted by STA 1 (2110) and STA 2 (2130), or may transmit a BSRP trigger frame prior to transmitting the trigger frame to receive BSRs from STA 1 (2110) and STA 2 (2130), and may be aware of the traffic status of STA 1 (2110) and STA 2 (2130). The BSR may indicate the status of traffic stored in the transmission queue or buffer of STA 1 (2110) and STA 2 (2130) (e.g., the amount of stored traffic).

As another embodiment, the AP (2120) may be aware of the traffic status of STA 1 (2110) and STA 2 (2130) through the prediction of the machine learning unit of FIG. 3 and FIG. 4. In an embodiment, the AP (2120) may predict the uplink traffic status of STA 1 (2110) and STA 2 (2130) by using the BSRs transmitted by STA 1 (2110) and STA 2 (2130) and the traffic patterns of STA 1 (2110) and STA 2 (2130) as input to the machine learning unit. When the AP (2120) is aware of the traffic status of STA 1 (2110) and STA 2 (2130), the AP (2120) may allocate uplink resources in accordance with the traffic conditions of STA 1 (2110) and STA 2 (2130). In an embodiment, when STA 1 (2110) has more traffic and STA 2 (2130) has relatively less traffic than STA 1 (2110), the AP (2120) may allocate more uplink resources (an RU with wider bandwidth) to STA 1 (2110), and the uplink resources allocated to STA 2 (2130) may be less than those allocated to STA 1 (2110). When the AP (2120) is not aware of the traffic status of STA 1 (2110) and STA 2 (2130), the AP (2120) may distribute uplink resources equally to STA 1 (2110) and STA 2 (2130). STA 1 (2110) and STA 2 (2130) receive the trigger frame transmitted by the AP (2120) and confirm the allocated uplink resources. STA 1 (2110) and STA 2 (2130) transmit uplink frames in a UL OFDMA manner according to the uplink resources allocated by the AP (2120). The uplink frame transmitted by STA 1 (2110) is destined for STA 2 (2130), and the frame transmitted by STA 2 (2130) is destined for STA 1 (2110). The AP (2120) receives the frames transmitted by STA 1 (2110) and STA 2 (2130) in the UL OFDMA manner, and may transmit a block acknowledgment (BA) frame, a trigger frame (TF), and a downlink frame (DL frame) to STA 1 (2110) and STA 2 (2130) after a SIFS duration from the completion of reception of the frames. The frames may be configured in the A-MPDU format and transmitted in the DL OFDMA manner. Alternatively, at least one of the three frames may not be configured as an A-MPDU. In an embodiment, the block acknowledgment frame may be replaced with a multi-STA block acknowledgment frame transmitted in the DL OFDMA manner or in a non-DL OFDMA manner. The downlink frame transmitted to STA 1 (2110) is a frame forwarded by the AP (2120) from the uplink frame transmitted by STA 2 (2130) to the AP (2120) in the UL OFDMA manner. The downlink frame transmitted to STA 2 (2130) is a frame forwarded by the AP (2120) from the uplink frame transmitted by STA 1 (2110) to the AP (2120) in the UL OFDMA manner.

STA 1 (2110) and STA 2 (2130) receive the block acknowledgment frame, trigger frame, and downlink frame received from the AP (2120) in the DL OFDMA manner. STA 1 (2110) and STA 2 (2130) confirm the trigger frame and confirm the uplink resources allocated to STA 1 (2110) and STA 2 (2130). STA 1 (2110) and STA 2 (2130) transmit block acknowledgment frames for the received downlink data frames and uplink frames in the UL OFDMA manner on the uplink resources confirmed in the trigger frame. STA 1 (2110) and STA 2 (2130) may have no more uplink frames to transmit. When STA 1 (2110) and STA 2 (2130) have no uplink frames to transmit, STA 1 (2110) and STA 2 (2130) may transmit QoS Null frames to the AP (2120). When the AP (2120) receives QoS Null frames from both STA 1 (2110) and STA 2 (2130), the AP (2120) terminates (completes) the bidirectional OFDMA transmission procedure. The AP (2120) may respond with block acknowledgment frames to the frames transmitted by STA 1 (2110) and STA 2 (2130) in the UL OFDMA manner, or may omit this when both STA 1 (2110) and STA 2 (2130) have transmitted QoS Null frames. Alternatively, STA 1 (2110) may not transmit a QoS Null frame to the AP (2120), while STA 2 (2130) may transmit a QoS Null frame to the AP (2120). The AP (2120) subsequently allocates uplink resources to STA 1 (2110) but no longer allocates resources to STA 2 (2130).

After the bidirectional OFDMA transmission procedure is completed, a remaining period may exist in the TXOP. The TXOP holder is STA 1 (2110). STA 1 (2110) may transmit an uplink data frame to the AP (2120), or STA 1 (2110) may restart the bidirectional TXOP sharing procedure (e.g., the bidirectional TXOP sharing configuration procedure or the bidirectional TXOP sharing data transmission procedure). Alternatively, STA 1 (2110) may transmit a contention free (CF)-End frame to terminate the TXOP. When the TXOP is terminated, the NAV corresponding to the length of the TXOP is released.

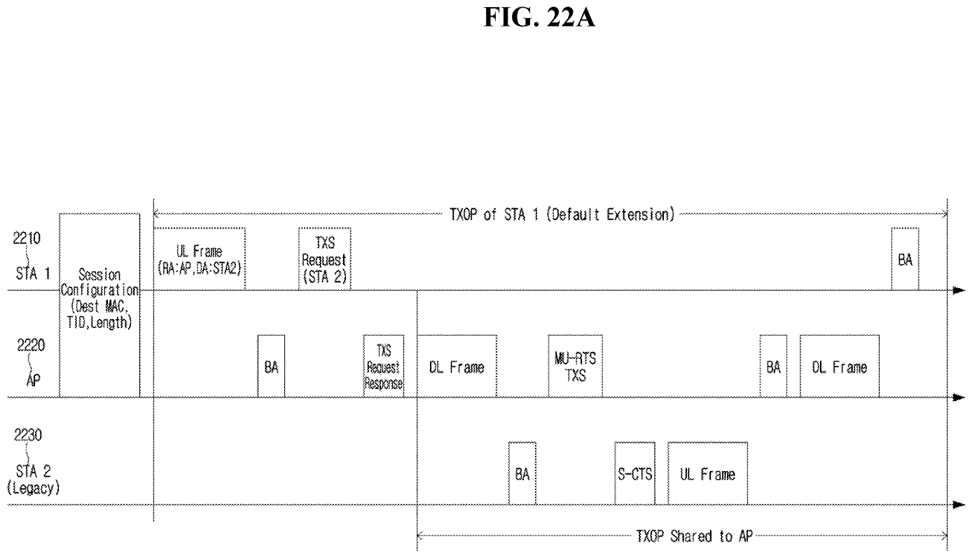

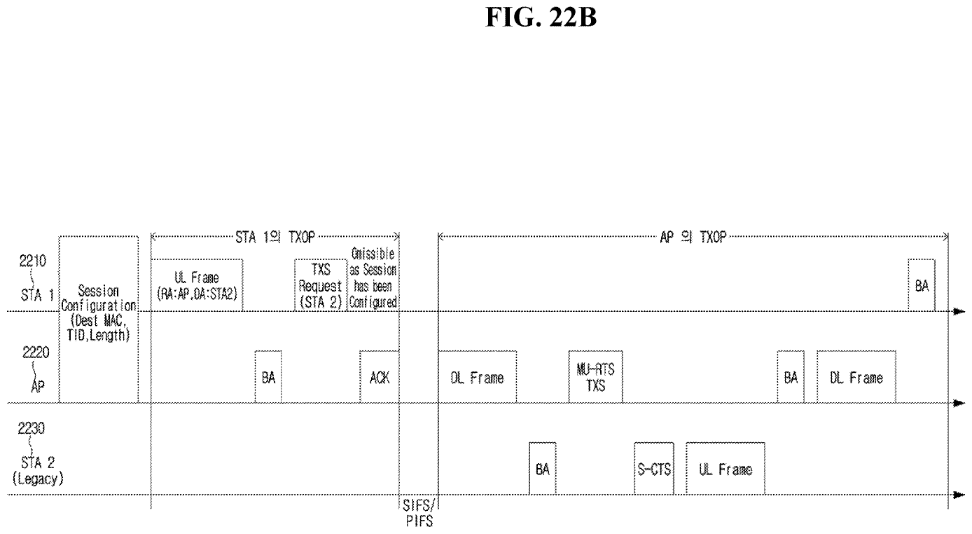

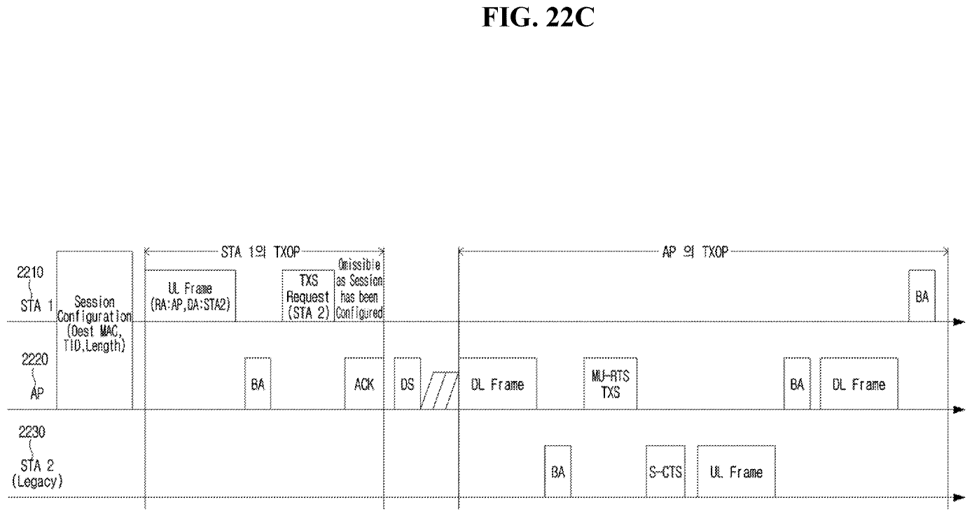

FIG. 22A through FIG. 22C are diagrams illustrating a proxy bidirectional TXOP sharing configuration method in a wireless LAN. Referring to FIG. 22A through FIG. 22C, an AP and WLAN terminals connected to the AP may operate in a wireless LAN network. The WLAN terminals connected to the AP may be non-AP STA 1 and non-AP STA 2. Non-AP STA 1 and non-AP STA 2 are referred to as STA 1 and STA 2, respectively. STA 1 (2210) and STA 2 (2230) may perform data communication (e.g., uplink data communication, downlink data communication) with the AP (2220). The AP (2220), STA 1 (2210), and STA 2 (2230) may operate on the same wireless LAN channel. The same wireless LAN channel may refer to the same wireless LAN link. That is, the AP (2220), STA 1 (2210), and STA 2 (2230) may operate on the same wireless LAN link. STA 1 (2210) and the AP (2220) may support a configuration procedure and/or a communication procedure for bidirectionally sharing communication resources. However, STA 2 (2230) may not support the configuration procedure and/or the communication procedure for bidirectionally sharing communication resources. An embodiment of the configuration procedure for bidirectionally sharing communication resources may consist of a step in which STA 1 (2210) performs a preliminary information exchange to share communication resources with the STA (e.g., STA 2) with which STA 1 (2210) intends to communicate within the transmission opportunity (TXOP), which is a communication resource enabling transmission of a plurality of frames by STA 1 (2210) or the AP (2220). An embodiment of the communication procedure for bidirectionally sharing communication resources may include: after completion of the configuration procedure for bidirectionally sharing communication resources, a step in which STA 1 (2210) transmits a data frame with STA 2 (2230) as the final destination to the AP (2220) within the TXOP of STA 1 (2210) or the AP (2220); a step in which the AP (2220) transmits the frame received from STA 1 (2210) to STA 2 (2230); a step in which STA 2 (2230) transmits a frame with STA 1 (2210) as the final destination to the AP (2220) within the TXOP; and a step in which the AP (2220) transmits the frame received from STA 2 (2230) to STA 1 (2210). However, STA 2 (2230) may not support at least one of the configuration procedure for bidirectionally sharing communication resources and the communication procedure for bidirectionally sharing communication resources, and the steps may not be supported by STA 2 (2230). In order to bidirectionally share communication resources, STA 1 (2210) and the AP (2220), which support the configuration procedure and/or the communication procedure for bidirectionally sharing communication resources, may use the proxy bidirectional transmission opportunity sharing method described below in the present embodiment for STA 2 (2230). By using the proxy bidirectional transmission opportunity sharing method, STA 2 (2230) may perform the communication procedure for bidirectionally sharing communication resources through STA 1 (2210) and the AP (2220) without supporting the above-described configuration procedure for bidirectionally sharing communication resources, and bidirectional data exchange between STA 1 (2210) and STA 2 (2230) may be performed.

STA 1 (2210) and the AP (2220) may perform configuration for performing proxy bidirectional transmission opportunity sharing. This is a proxy bidirectional TXOP sharing (PB-TXS) session configuration procedure. The PB-TXS session configuration may be initiated by STA 1 (2210). In this case, STA 1 (2210) is the session initiator. In the PB-TXS session configuration procedure, STA 1 (2210) may transmit information for PB-TXS session configuration to the AP (2220) to request configuration of the PB-TXS session. The information may include an identifier of the target terminal, TID information, resource length information, and the like. In an embodiment, STA 1 (2210) may transmit to the AP (2220) information on the target terminal (STA 2) with which bidirectional data exchange is to be performed. The information on the target terminal may be at least one of the MAC address of the target terminal and the AID of the target terminal. The information on the target terminal is indicated as Dest ID in the drawings. STA 1 (2210) may transmit traffic identifier (TID) information to the AP (2220). The TID information may be information mapped to the access categories (AC) of the frames transmitted by STA 1 (2210). STA 1 (2210) may transmit to the AP (2220) the resource length required for communication with the target STA. The resource length may be one of a time-unit length or a data length (e.g., the length of data bits). The information for PB-TXS session configuration may be included in a separate frame for configuring the PB-TXS session and transmitted by STA 1 (2210) to the AP (2220). In an embodiment, the separate frame for configuring the PB-TXS session may be exchanged as an action frame and transmitted by STA 1 (2210) to the AP (2220), and the AP (2220) may transmit a response frame (e.g., an ACK frame) to the frame transmitted by STA 1 (2210). The AP (2220) may also transmit a response action frame to STA 1 (2210) after transmitting the response frame. This may be for the purpose of the AP (2220) accepting or rejecting the PB-TXS configuration request of STA 1 (2210). When the AP (2220) has not transmitted a response frame to the action frame for configuring the PB-TXS session of STA 1 (2210), or when the AP (2220) has transmitted a response frame to the action frame for configuring the PB-TXS session of STA 1 (2210) and subsequently transmitted a response action frame to STA 1 (2210) and the response action frame indicates that the AP (2220) is rejecting the PB-TXS session configuration, the PB-TXS session is not configured between STA 1 (2210) and the AP (2220). When the AP (2220) has transmitted a response frame to the action frame for configuring the PB-TXS session of STA 1 (2210) and subsequently transmitted a response action frame to STA 1 (2210) and the response action frame indicates that the AP (2220) is accepting the PB-TXS session configuration, the PB-TXS session is configured between STA 1 (2210) and the AP (2220). When the PB-TXS session is configured, the PB-TXS communication operation described below may be performed. Alternatively, the PB-TXS session may be configured through a stream classification service (SCS) method. STA 1 (2210) may transmit an SCS request frame to the AP (2220). The SCS request frame of STA 1 (2210) includes an SCS descriptor element. STA 1 (2210) may set the request type to ‘ADD’ or ‘Change’ in the SCS descriptor element. The SCS descriptor element may include a QoS characteristics element indicating QoS information required by STA 1 (2210), and the QoS characteristics element may include at least one of an identifier of the target terminal, TID information, and resource length information for STA 1 (2210) to configure the PB-TXS session. The AP (2220) may receive the SCS request frame from STA 1 (2210) and transmit an SCS response frame to STA 1 (2210). When the Status field of the SCS Status duple of the SCS response frame transmitted by the AP (2220) is SUCCESS, an SCS stream is configured between the AP (2220) and STA 1 (2210). When the SCS stream is configured, this may be regarded as the PB-TXS session being configured.

Referring to FIG. 22A, the PB-TXS communication operation may be performed. STA 1 (2210) performs a channel access operation on the wireless LAN channel. The channel access operation is an enhanced distributed channel access (EDCA) backoff operation. The EDCA backoff operation may also be referred to as a backoff operation or procedure. In the backoff operation, EDCA functions (EDCAFs) for each access category (AC) may select a backoff counter within a contention window prior to transmitting a frame, and may decrement the backoff counter at a slot boundary prior to transmitting a frame. The EDCAF performs frame transmission at the slot boundary at which the backoff counter reaches zero. That is, this indicates that the EDCAF has determined frame transmission. When the EDCAF determines frame transmission, a TXOP is granted to the EDCAF. Since a TXOP has been granted to the EDCAF of STA 1 (2210), a TXOP has been granted to STA 1 (2210). This may mean that STA 1 (2210) has acquired the TXOP, and STA 1 (2210) is the TXOP holder. The TXOP is a time period during which one or more frames may be transmitted. When the PB-TXS session has been configured between STA 1 (2210) and the AP (2220), the TXOP of STA 1 (2210) may acquire a TXOP with an extended length when all of [Condition 1] is satisfied.

### [Condition 1]

1. When STA 1 needs to transmit a frame to the target terminal indicated in the PB-TXS session configuration procedure
2. When STA 1 needs to transmit a frame having the TID indicated in the PB-TXS session configuration procedure

Within the TXOP acquired by STA 1 (2210), STA 1 (2210) transmits an uplink (UL) frame to the AP (2220). The final destination of the uplink frame is STA 2 (2230). STA 2 (2230) is the STA indicated by STA 1 (2210) to the AP (2220) during the PB-TXS session configuration process. That is, the address fields of the MAC header may be configured so that the uplink frame is delivered to STA 2 (2230) via the AP (2220). STA 1 (2210) sets the fields of the MAC header of the uplink frame as shown in [Table 8].

TABLE 8

| | Field | | | | |
|---|---|---|---|---|---|
| | | | Address 1 Field | Address 2 Field | Address 3 Field |
| | | | (Receiver | (Transmitter | (Destination |
| | Frame Control Field | | Address) | Address) | Address) |
| | Subfield | | | | |
| | To DS | From DS | N/A | N/A | N/A |
| Value | 1 | 0 | AP Address | STA 1 Address | STA 2 Address |

STA 1 (2210) may transmit at least one uplink frame. When the transmission of the last uplink frame of STA 1 (2210) is completed, STA 1 (2210) may transmit a TXS request frame to the AP (2220). The TXS request frame is a frame requesting the AP (2220) to forward the frame of STA 1 (2210) to the target terminal (STA 2) and to receive a frame from the target terminal (STA 2) and forward it back to STA 1 (2210). The TXS request frame may be an action frame, or a QoS Null frame or a QoS data frame in which specific information is included in the MAC header in the A-control format. Alternatively, the TXS request frame may be the last uplink frame of STA 1 (2210). In this case, specific information may be indicated in the A-control format in the MAC header of the last uplink frame of STA 1 (2210). The TXS request frame may include at least one of an identifier of the target STA and time length information during which the AP (2220) is able to communicate.

Upon completing reception of the uplink frame of STA 1 (2210), the AP (2220) may transmit a response frame after a SIFS duration. The response frame may be a block acknowledgment (BA) frame or an ACK frame. The response frame may also be a TXS response frame, which may be in the same format as the TXS request frame. When the AP (2220) receives the TXS request frame from STA 1 (2210), the AP (2220) may transmit a response frame to STA 1 (2210). When the AP (2220) receives the TXS request frame from STA 1 (2210) and transmits a response frame, the AP (2220) may transmit data frames within the TXOP of STA 1 (2210). That is, the AP (2220) has been granted a share of the TXOP of STA 1 (2210). The AP (2220) may operate as the TXOP holder or similarly to the TXOP holder while being granted a share of the TXOP from STA 1 (2210). The AP (2220) may transmit a downlink frame to STA 2 (2230) after a SIFS duration from the completion of transmission of the response frame to STA 1 (2210). The downlink frame may be a frame that forwards the uplink frame transmitted by STA 1 (2210) to the AP (2220) to STA 2 (2230). The AP (2220) sets the MAC header of the downlink frame as shown in [Table 9].

TABLE 9

| | Field | | | | |
|---|---|---|---|---|---|
| | | | Address 1 Field | Address 2 Field | |
| | | | (Receiver | (Transmitter | Address 3 Field |
| | Frame Control Field | | Address) | Address) | (Source Address) |
| | Subfield | | | | |
| | To DS | From DS | N/A | N/A | N/A |
| Value | 0 | 1 | STA 2 Address | AP Address | STA 1 Address |

The AP (2220) may transmit at least one downlink frame to STA 2 (2230), and when STA 2 (2230) receives the downlink frame of the AP (2220), STA 2 (2230) may transmit a response frame (BA frame or ACK frame) to the AP (2220). When the AP (2220) has completed downlink frame transmission and received the response frame from STA 2 (2230), the AP (2220) may transmit a trigger frame including the user information field of STA 2 (2230). The trigger frame of the AP (2220) may be transmitted to request uplink transmission from STA 2 (2230). The trigger frame of the AP (2220) may be a basic trigger frame. In this case, STA 2 (2230) may transmit an uplink frame after a SIFS duration from the completion of reception of the trigger frame, and the physical layer format of the uplink frame may be a trigger-based (TB) physical layer protocol data unit (PPDU). The trigger frame of the AP (2220) may be a multi-user request to send (MU-RTS) TXOP sharing (TXS) trigger frame. The MU-RTS TXS frame allocates a separate transmission period to STA 2 (2230) during which a non-TB PPDU may be transmitted. The MU-RTS TXS frame may include a TXS mode. When the TXS mode is indicated as 1, STA 2 (2230) may transmit an uplink frame to the AP (2220). When the TXS mode is indicated as 2, STA 2 (2230) may transmit an uplink frame to the AP (2220) or may directly transmit a data frame to another STA (e.g., STA 1 (2210)). STA 2 (2230) sets the MAC header of the uplink data frame as shown in [Table 10].

TABLE 10

| | Field | | | | |
|---|---|---|---|---|---|
| | | | Address 1 Field | Address 2 Field | Address 3 Field |
| | | | (Receiver | (Transmitter | (Destination |
| | Frame Control Field | | Address) | Address) | Address) |
| | Subfield | | | | |
| | To DS | From DS | N/A | N/A | N/A |
| Value | 1 | 0 | AP Address | STA 2 Address | STA 1 Address |

Upon completing reception of the uplink frame of STA 2 (2230), the AP (2220) may transmit a response frame after a SIFS duration. The response frame may be a block acknowledgment (BA) frame. STA 2 (2230) may have no uplink frames to transmit. In this case, when STA 2 (2230) receives a basic trigger frame from the AP (2220), STA 2 (2230) may transmit a QoS Null frame. The MAC header of the QoS Null frame may include a BSR (buffer status report) transmitted by STA 2 (2230) in the A-control format. When STA 2 (2230) has received an MU-RTS TXS trigger frame from the AP (2220) and the TXS mode is 2, STA 2 (2230) may include a command and status (CAS) control in the A-control format in the MAC header of the QoS Null frame or the QoS data frame. When the RDG/more PPDU bit included in the CAS control is indicated as 0, the AP (2220) may recognize that STA 2 (2230) has no more frames to transmit. When STA 2 (2230) has received an MU-RTS TXS trigger frame from the AP (2220) and the TXS mode is 1, STA 2 (2230) may not transmit on the medium for a PIFS duration. The AP (2220) may recognize that STA 2 (2230) has no more frames to transmit.

When the AP (2220) has transmitted a basic trigger frame to STA 2 (2230), the AP (2220) may transmit a downlink frame to STA 1 (2210) after a SIFS duration from the completion of transmission of the response frame to STA 2 (2230). When the AP (2220) has transmitted an MU-RTS TXS trigger frame to STA 2 (2230), the AP (2220) may transmit a downlink frame to STA 1 (2210) after a SIFS or PIFS duration from the end of the separate transmission period allocated to STA 2 (2230). The downlink frame may be a frame that forwards the uplink frame transmitted by STA 2 (2230) to the AP (2220) to STA 1 (2210). The AP (2220) sets the MAC header of the downlink frame as shown in [Table 11].

TABLE 11

| | Field | | | | |
|---|---|---|---|---|---|
| | | | Address 1 Field | Address 2 Field | |
| | | | (Receiver | (Transmitter | Address 3 Field |
| | Frame Control Field | | Address) | Address) | (Source Address) |
| | Subfield | | | | |
| | To DS | From DS | N/A | N/A | N/A |
| Value | 0 | 1 | STA 1 Address | AP Address | STA 2 Address |

STA 1 (2210) may receive the downlink frame from the AP (2220) and may identify that the original transmitter of the received frame is STA 2 (2230). STA 1 (2210) transmits a response frame to the AP (2220) after a SIFS duration from the completion of reception of the downlink frame. When STA 2 (2230) has no frame to transmit to the AP (2220), the AP (2220) may not transmit any frame to STA 1 (2210) or may transmit a QoS Null frame. The PB-TXS communication operation may be completed. After the PB-TXS communication operation is completed, a remaining period may exist in the TXOP. When the TXOP holder is a STA (e.g., STA 1 (2210)), the STA may transmit an uplink data frame to the AP (2220), or the STA may restart the PB-TXS communication procedure. Alternatively, the STA may transmit a contention free (CF)-End frame to terminate the TXOP. When the TXOP is terminated, the NAV corresponding to the length of the TXOP is released. After the PB-TXS communication operation is completed, a remaining period may exist in the TXOP. When the TXOP holder is a STA (e.g., STA 1), the STA may transmit an uplink data frame to the AP (2220), or the STA may restart the PB-TXS communication procedure. Alternatively, the STA may transmit a contention free (CF)-End frame to terminate the TXOP. When the TXOP is terminated, the NAV corresponding to the length of the TXOP is released.

Referring to FIG. 22B, the PB-TXS communication operation may be performed. STA 1 (2210) performs a channel access operation on the wireless LAN channel. The channel access operation is an enhanced distributed channel access (EDCA) backoff operation. The EDCA backoff operation may also be referred to as a backoff operation or procedure. In the backoff operation, EDCA functions (EDCAFs) for each access category (AC) may select a backoff counter within a contention window prior to transmitting a frame, and may decrement the backoff counter at a slot boundary prior to transmitting a frame. The EDCAF performs frame transmission at the slot boundary at which the backoff counter reaches zero. That is, this indicates that the EDCAF has determined frame transmission. When the EDCAF determines frame transmission, a TXOP is granted to the EDCAF. Since a TXOP has been granted to the EDCAF of STA 1 (2210), a TXOP has been granted to STA 1 (2210). This may mean that STA 1 (2210) has acquired the TXOP, and STA 1 (2210) is the TXOP holder. The TXOP is a time period during which one or more frames may be transmitted. Within the TXOP acquired by STA 1 (2210), STA 1 (2210) transmits an uplink (UL) frame to the AP (2220). The final destination of the uplink frame is STA 2 (2230). STA 2 (2230) is the STA indicated by STA 1 (2210) to the AP (2220) during the PB-TXS session configuration process. That is, the address fields of the MAC header may be configured so that the uplink frame is delivered to STA 2 (2230) via the AP (2220). STA 1 (2210) sets the fields of the MAC header of the uplink frame as shown in [Table 8]. STA 1 (2210) may transmit at least one uplink frame. When the transmission of the last uplink frame of STA 1 (2210) is completed, STA 1 (2210) may transmit a TXS request frame to the AP (2220). The TXS request frame is a frame requesting that after the TXOP of STA 1 (2210) ends, the AP (2220) forwards the frame of STA 1 (2210) to the target terminal (STA 2) and receives a frame from the target terminal (STA 2) and forwards it back to STA 1 (2210). The TXS request frame may be an action frame, or a QoS Null frame or a QoS data frame in which specific information is included in the MAC header in the A-control format. Alternatively, the TXS request frame may be the last uplink frame of STA 1 (2210). In this case, specific information may be indicated in the A-control format in the MAC header of the last uplink frame of STA 1 (2210). The TXS request frame may include an identifier of the target STA. Alternatively, since STA 1 (2210) and the AP (2220) have configured a PB-TXS session, the AP (2220) has received a frame from STA 1 (2210) whose destination is the target STA (STA 2), and the TID of the frame whose destination is STA 2 (2230) may be the same as the value indicated by STA 1 (2210) to the AP (2220) in the PB-TXS session. In this case, the AP (2220) may operate in the same manner as if it had received the TXS request frame even without actually receiving the TXS request frame from STA 1 (2210).

Upon completing reception of the uplink frame of STA 1 (2210), the AP (2220) may transmit a response frame after a SIFS duration. The response frame may be a block acknowledgment (BA) frame or an ACK frame. When the AP (2220) receives the TXS request frame from STA 1 (2210), the AP (2220) may transmit a response frame to STA 1 (2210). When the AP (2220) has received the TXS request frame from STA 1 (2210) and the TXOP of STA 1 (2210) has ended, the AP (2220) may acquire the TXOP of the AP (2220) and transmit data frames within the TXOP. Exceptionally, the AP (2220) may immediately acquire the TXOP after a predetermined duration (e.g., a SIFS or PIFS duration) from the end of the TXOP of STA 1 (2210). When the AP (2220) acquires the TXOP, it may transmit a downlink frame to STA 2 (2230). The downlink frame may be a frame that forwards the uplink frame transmitted by STA 1 (2210) to the AP (2220) to STA 2 (2230). The AP (2220) sets the MAC header of the downlink frame as shown in [Table 9]. The AP (2220) may transmit at least one downlink frame to STA 2 (2230) within the TXOP, and when STA 2 (2230) receives the downlink frame of the AP (2220), STA 2 (2230) may transmit a response frame (BA frame or ACK frame) to the AP (2220). When the AP (2220) has completed downlink frame transmission and received the response frame from STA 2 (2230), the AP (2220) may transmit a trigger frame including the user information field of STA 2 (2230). The trigger frame of the AP (2220) may be transmitted to request uplink transmission from STA 2 (2230). The trigger frame of the AP (2220) may be a basic trigger frame. In this case, STA 2 (2230) may transmit an uplink frame after a SIFS duration from the completion of reception of the trigger frame, and the physical layer format of the uplink frame may be a trigger-based (TB) physical layer protocol data unit (PPDU). The trigger frame of the AP (2220) may be a multi-user request to send (MU-RTS) TXOP sharing (TXS) trigger frame. The MU-RTS TXS frame allocates a separate transmission period to STA 2 (2230) during which a non-TB PPDU may be transmitted. The MU-RTS TXS frame may include a TXS mode. When the TXS mode is indicated as 1, STA 2 (2230) may transmit an uplink frame to the AP (2220). When the TXS mode is indicated as 2, STA 2 (2230) may transmit an uplink frame to the AP (2220) or may directly transmit a data frame to another STA (e.g., STA 1 (2210)). STA 2 (2230) sets the MAC header of the uplink data frame as shown in [Table 10]. Upon completing reception of the uplink frame of STA 2 (2230), the AP (2220) may transmit a response frame after a SIFS duration. The response frame may be a block acknowledgment (BA) frame. The length of the resources allocated in the trigger frame transmitted by the AP (2220) to STA 2 (2230) may be allocated based on the resource length indicated in the PB-TXS session configuration procedure. STA 2 (2230) may have no uplink frames to transmit. In this case, when STA 2 (2230) receives a basic trigger frame from the AP (2220), STA 2 (2230) may transmit a QoS Null frame. The MAC header of the QoS Null frame may include a BSR (buffer status report) transmitted by STA 2 (2230) in the A-control format. When STA 2 (2230) has received an MU-RTS TXS trigger frame from the AP (2220) and the TXS mode is 2, STA 2 (2230) may include a command and status (CAS) control in the A-control format in the MAC header of the QoS Null frame or the QoS data frame. When the RDG/more PPDU bit included in the CAS control is indicated as 0, the AP (2220) may recognize that STA 2 (2230) has no more frames to transmit. When STA 2 (2230) has received an MU-RTS TXS trigger frame from the AP (2220) and the TXS mode is 1, STA 2 (2230) may not transmit on the medium for a PIFS duration. The AP (2220) may recognize that STA 2 (2230) has no more frames to transmit.

When the AP (2220) has transmitted a basic trigger frame to STA 2 (2230), the AP (2220) may transmit a downlink frame to STA 1 (2210) after a SIFS duration from the completion of transmission of the response frame to STA 2 (2230). When the AP (2220) has transmitted an MU-RTS TXS trigger frame to STA 2 (2230), the AP (2220) may transmit a downlink frame to STA 1 (2210) after a SIFS or PIFS duration from the end of the separate transmission period allocated to STA 2 (2230). The downlink frame may be a frame that forwards the uplink frame transmitted by STA 2 (2230) to the AP (2220) to STA 1 (2210). The AP (2220) sets the MAC header of the downlink frame as shown in [Table 11]. STA 1 (2210) may receive the downlink frame from the AP (2220) and may identify that the original transmitter of the received frame is STA 2 (2230). STA 1 (2210) transmits a response frame to the AP (2220) after a SIFS duration from the completion of reception of the downlink frame. When STA 2 (2230) has no frame to transmit to the AP (2220), the AP (2220) may not transmit any frame to STA 1 (2210) or may transmit a QoS Null frame. The PB-TXS communication operation may be completed.

Referring to FIG. 22C, the PB-TXS communication operation may be performed. STA 1 (2210) performs a channel access operation on the wireless LAN channel. The channel access operation is an enhanced distributed channel access (EDCA) backoff operation. The EDCA backoff operation may also be referred to as a backoff operation or procedure. In the backoff operation, EDCA functions (EDCAFs) for each access category (AC) may select a backoff counter within a contention window prior to transmitting a frame, and may decrement the backoff counter at a slot boundary prior to transmitting a frame. The EDCAF performs frame transmission at the slot boundary at which the backoff counter reaches zero. That is, this indicates that the EDCAF has determined frame transmission. When the EDCAF determines frame transmission, a TXOP is granted to the EDCAF. Since a TXOP has been granted to the EDCAF of STA 1 (2210), a TXOP has been granted to STA 1 (2210). This may mean that STA 1 (2210) has acquired the TXOP, and STA 1 (2210) is the TXOP holder. The TXOP is a time period during which one or more frames may be transmitted. Within the TXOP acquired by STA 1 (2210), STA 1 (2210) transmits an uplink (UL) frame to the AP (2220). The final destination of the uplink frame is STA 2 (2230). STA 2 (2230) is the STA indicated by STA 1 (2210) to the AP (2220) during the PB-TXS session configuration process. That is, the address fields of the MAC header may be configured so that the uplink frame is delivered to STA 2 (2230) via the AP (2220). STA 1 (2210) sets the fields of the MAC header of the uplink frame as shown in [Table 8]. STA 1 (2210) may transmit at least one uplink frame. When the transmission of the last uplink frame of STA 1 (2210) is completed, STA 1 (2210) may transmit a TXS request frame to the AP (2220). The TXS request frame is a frame requesting that after the TXOP of STA 1 (2210) ends, the AP (2220) forwards the frame of STA 1 (2210) to the target terminal (STA 2) and receives a frame from the target terminal (STA 2) and forwards it back to STA 1 (2210). The TXS request frame may be an action frame, or a QoS Null frame or a QoS data frame in which specific information is included in the MAC header in the A-control format. Alternatively, the TXS request frame may be the last uplink frame of STA 1 (2210). In this case, specific information may be indicated in the A-control format in the MAC header of the last uplink frame of STA 1 (2210). The TXS request frame may include an identifier of the target STA. Alternatively, since STA 1 (2210) and the AP (2220) have configured a PB-TXS session, the AP (2220) has received a frame from STA 1 (2210) whose destination is the target STA (STA 2), and the TID of the frame whose destination is STA 2 (2230) may be the same as the value indicated by STA 1 (2210) to the AP (2220) in the PB-TXS session. In this case, the AP (2220) may operate in the same manner as if it had received the TXS request frame even without actually receiving the TXS request frame from STA 1 (2210).

Upon completing reception of the uplink frame of STA 1 (2210), the AP (2220) may transmit a response frame after a SIFS duration. The response frame may be a block acknowledgment (BA) frame or an ACK frame. When the AP (2220) receives the TXS request frame from STA 1 (2210), the AP (2220) may transmit a response frame to STA 1 (2210). When the AP (2220) has received the TXS request frame from STA 1 (2210) and the TXOP of STA 1 (2210) has ended, the AP (2220) may acquire the TXOP of the AP (2220) and transmit data frames within the TXOP. The AP (2220) performs a channel access operation (e.g., EDCA backoff operation) to acquire the TXOP, and acquires the TXOP upon successfully completing the channel access operation. Alternatively, the AP (2220) may perform a different channel access operation to acquire the TXOP. The AP (2220) may transmit a defer signal (DS) after a DIFS or AIFS[VO] duration from the end of the TXOP of STA 1 (2210) in order to gain priority in the channel access operation. The DS is a frame for restricting channel access of all or some of the STAs other than the AP (2220). The DS may be a frame consisting only of a PHY preamble, or may be a simultaneous-CTS (S-CTS) frame. The transmission of the DS by the AP (2220) is a preemption operation in which the AP (2220) intends to transmit with priority over the transmissions of other terminals (e.g., STAs). The AP (2220) performs a random backoff operation after transmitting the DS, and acquires the TXOP upon successfully completing the random backoff operation (e.g., when the backoff counter reaches zero). When the AP (2220) acquires the TXOP, it may transmit a downlink frame to STA 2 (2230). The downlink frame may be a frame that forwards the uplink frame transmitted by STA 1 (2210) to the AP (2220) to STA 2 (2230). The AP (2220) sets the MAC header of the downlink frame as shown in [Table 9]. The AP (2220) may transmit at least one downlink frame to STA 2 (2230) within the TXOP, and when STA 2 (2230) receives the downlink frame of the AP (2220), STA 2 (2230) may transmit a response frame (BA frame or ACK frame) to the AP (2220). When the AP (2220) has completed downlink frame transmission and received the response frame from STA 2 (2230), the AP (2220) may transmit a trigger frame including the user information field of STA 2 (2230). The trigger frame of the AP (2220) may be transmitted to request uplink transmission from STA 2 (2230). The trigger frame of the AP (2220) may be a basic trigger frame. In this case, STA 2 (2230) may transmit an uplink frame after a SIFS duration from the completion of reception of the trigger frame, and the physical layer format of the uplink frame may be a trigger-based (TB) physical layer protocol data unit (PPDU). The trigger frame of the AP (2220) may be a multi-user request to send (MU-RTS) TXOP sharing (TXS) trigger frame. The MU-RTS TXS frame allocates a separate transmission period to STA 2 (2230) during which a non-TB PPDU may be transmitted. The MU-RTS TXS frame may include a TXS mode. When the TXS mode is indicated as 1, STA 2 (2230) may transmit an uplink frame to the AP (2220). When the TXS mode is indicated as 2, STA 2 (2230) may transmit an uplink frame to the AP (2220) or may directly transmit a data frame to another STA (e.g., STA 1 (2210)). STA 2 (2230) sets the MAC header of the uplink data frame as shown in [Table 10]. Upon completing reception of the uplink frame of STA 2 (2230), the AP (2220) may transmit a response frame after a SIFS duration. The response frame may be a block acknowledgment (BA) frame. The length of the resources allocated in the trigger frame transmitted by the AP (2220) to STA 1 (2230) may be allocated based on the resource length indicated in the PB-TXS session configuration procedure. STA 2 (2230) may have no uplink frames to transmit. In this case, when STA 2 (2230) receives a basic trigger frame from the AP (2220), STA 2 (2230) may transmit a QoS Null frame. The MAC header of the QoS Null frame may include a BSR (buffer status report) transmitted by STA 2 (2230) in the A-control format. When STA 2 (2230) has received an MU-RTS TXS trigger frame from the AP (2220) and the TXS mode is 2, STA 2 (2230) may include a command and status (CAS) control in the A-control format in the MAC header of the QoS Null frame or the QoS data frame. When the RDG/more PPDU bit included in the CAS control is indicated as 0, the AP (2220) may recognize that STA 2 (2230) has no more frames to transmit. When STA 2 (2230) has received an MU-RTS TXS trigger frame from the AP (2220) and the TXS mode is 1, STA 2 (2230) may not transmit on the medium for a PIFS duration. The AP (2220) may recognize that STA 2 (2230) has no more frames to transmit.

When the AP (2220) has transmitted a basic trigger frame to STA 2 (2230), the AP (2220) may transmit a downlink frame to STA 1 (2210) after a SIFS duration from the completion of transmission of the response frame to STA 2 (2230). When the AP (2220) has transmitted an MU-RTS TXS trigger frame to STA 2 (2230), the AP (2220) may transmit a downlink frame to STA 1 (2210) after a SIFS or PIFS duration from the end of the separate transmission period allocated to STA 2 (2230). The downlink frame may be a frame that forwards the uplink frame transmitted by STA 2 (2230) to the AP (2220) to STA 1 (2210). The AP (2220) sets the MAC header of the downlink frame as shown in [Table 11]. STA 1 (2210) may receive the downlink frame from the AP (2220) and may identify that the original transmitter of the received frame is STA 2 (2230). STA 1 (2210) transmits a response frame to the AP (2220) after a SIFS duration from the completion of reception of the downlink frame. When STA 2 (2230) has no frame to transmit to the AP (2220), the AP (2220) may not transmit any frame to STA 1 (2210) or may transmit a QoS Null frame. The PB-TXS communication operation may be completed.

Referring to the embodiments of FIG. 22A through FIG. 22C, the queue operation of the AP (2220) may prioritize STA 1 (2210), which has configured the PB-TXS session, and STA 2 (2230), which is the target terminal of the PB-TXS session. In an embodiment, the AP (2220) may input data frames received from STA 1 (2210) and STA 2 (2230) into the output queue so that they are transmitted with priority in order to perform the PB-TXS communication operation. Alternatively, a dedicated queue for performing the PB-TXS communication operation may exist in the AP, and the AP may use the dedicated queue to perform the PB-TXS communication operation when performing the PB-TXS operation. In an embodiment, the AP may input data frames received from STA 1 (2210) and STA 2 (2230) into the dedicated queue to perform the PB-TXS communication operation, and may transmit frames present in the dedicated queue with priority. Referring to the embodiments of FIG. 22A through FIG. 22C, after STA 1 (2210) and the AP have configured the PB-TXS session, when the DA of the uplink frame transmitted by STA 1 (2210) to the AP (2220) is the MAC address of the target STA of the PB-TXS session (STA 2 (2230)) and the TID is the TID indicated in the PB-TXS session, the AP (2220) may perform the PB-TXS operation without STA 1 (2210) separately transmitting a TXS request frame to the AP (2220).

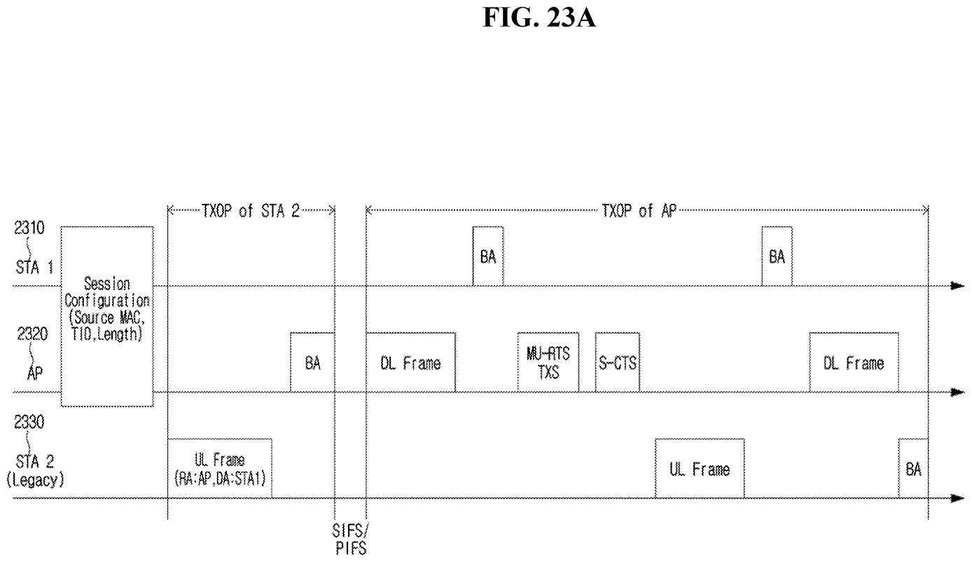

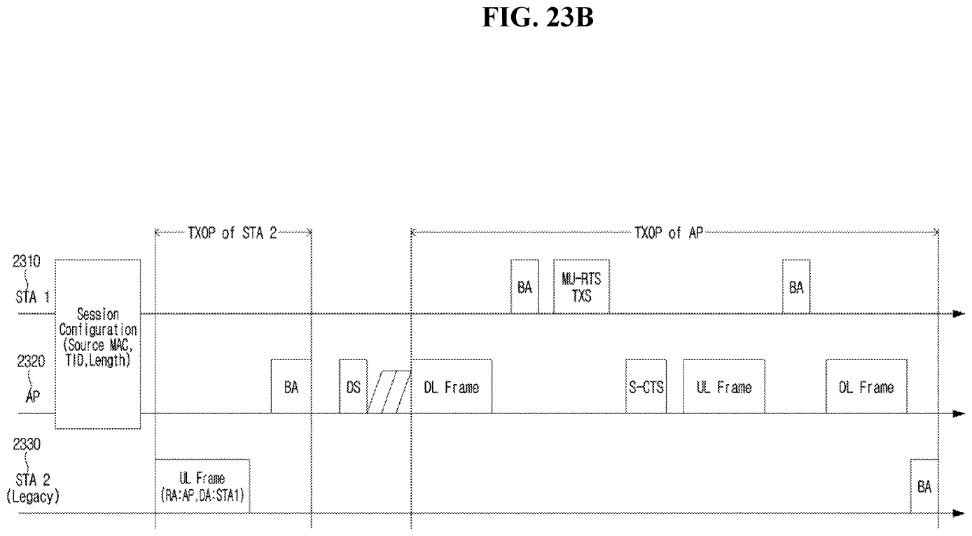

FIG. 23A and FIG. 23B are diagrams illustrating a proxy bidirectional TXOP sharing configuration method in a wireless LAN to which the present disclosure is applied.

Referring to FIG. 23A and FIG. 23B, an AP and WLAN terminals connected to the AP may operate in a wireless LAN network. The WLAN terminals connected to the AP may be non-AP STA 1 and non-AP STA 2. Non-AP STA 1 and non-AP STA 2 are referred to as STA 1 and STA 2, respectively. STA 1 (2310) and STA 2 may perform data communication (e.g., uplink data communication, downlink data communication) with the AP (2320). The AP (2320), STA 1 (2310), and STA 2 (2330) may operate on the same wireless LAN channel. The same wireless LAN channel may refer to the same wireless LAN link. That is, the AP (2320), STA 1 (2310), and STA 2 (2330) may operate on the same wireless LAN link. STA 1 (2310) and the AP (2320) may support a configuration procedure and/or a communication procedure for bidirectionally sharing communication resources. However, STA 2 (2330) may not support the configuration procedure and/or the communication procedure for bidirectionally sharing communication resources. An embodiment of the configuration procedure for bidirectionally sharing communication resources may consist of a step in which STA 1 (2310) performs a preliminary information exchange to share communication resources with the STA (e.g., STA 2 (2330)) with which STA 1 (2310) intends to communicate within the transmission opportunity (TXOP), which is a communication resource enabling transmission of a plurality of frames by STA 1 (2310) or the AP (2320). An embodiment of the communication procedure for bidirectionally sharing communication resources may include: after completion of the configuration procedure for bidirectionally sharing communication resources, a step in which STA 1 (2310) transmits a data frame with STA 2 (2330) as the final destination to the AP (2320) within the TXOP of STA 1 (2310) or the AP (2320); a step in which the AP (2320) transmits the frame received from STA 1 (2310) to STA 2 (2330); a step in which STA 2 (2330) transmits a frame with STA 1 (2310) as the final destination to the AP (2320) within the TXOP; and a step in which the AP (2320) transmits the frame received from STA 2 (2330) to STA 1 (2310). However, STA 2 (2330) may not support at least one of the configuration procedure for bidirectionally sharing communication resources and the communication procedure for bidirectionally sharing communication resources, and the steps may not be supported by STA 2 (2330). In order to bidirectionally share communication resources, STA 1 (2310) and the AP (2320), which support the configuration procedure and/or the communication procedure for bidirectionally sharing communication resources, may use the proxy bidirectional transmission opportunity sharing method described below in the present embodiment for STA 2 (2330). By using the proxy bidirectional transmission opportunity sharing method, STA 2 (2330) may perform the communication procedure for bidirectionally sharing communication resources through STA 1 (2310) and the AP (2320) without supporting the above-described configuration procedure for bidirectionally sharing communication resources, and bidirectional data exchange between STA 1 (2310) and STA 2 (2330) may be performed.

STA 1 (2310) and the AP (2320) may perform configuration for performing proxy bidirectional transmission opportunity sharing. This is a proxy bidirectional TXOP sharing (PB-TXS) session configuration procedure. The PB-TXS session configuration may be initiated by STA 1 (2310). In this case, STA 1 (2310) is the session initiator. In the PB-TXS session configuration procedure, STA 1 (2310) may transmit information for PB-TXS session configuration to the AP (2320) to request configuration of the PB-TXS session. In an embodiment, STA 1 (2310) may transmit to the AP (2320) information on the target terminal (STA 2) with which bidirectional data exchange is to be performed. The information on the target terminal may be at least one of the MAC address of the target terminal and the AID of the target terminal. The information on the target terminal is indicated as Source ID in the drawings. STA 1 (2310) may transmit traffic identifier (TID) information to the AP (2320). The TID information may be information mapped to the access categories (AC) of the frames transmitted by STA 1 (2310). STA 1 (2310) may transmit to the AP (2320) the resource length required for communication with the target STA. The resource length may be one of a time-unit length or a data length (e.g., the length of data bits). The information for PB-TXS session configuration may be included in a separate frame for configuring the PB-TXS session and transmitted by STA 1 (2310) to the AP (2320). In an embodiment, the separate frame for configuring the PB-TXS session may be exchanged as an action frame and transmitted by STA 1 (2310) to the AP (2320), and the AP (2320) may transmit a response frame (e.g., an ACK frame) to the frame transmitted by STA 1 (2310). The AP (2320) may also transmit a response action frame to STA 1 (2310) after transmitting the response frame. This may be for the purpose of the AP (2320) accepting or rejecting the PB-TXS configuration request of STA 1 (2310). When the AP (2320) has not transmitted a response frame to the action frame for configuring the PB-TXS session of STA 1 (2310), or when the AP (2320) has transmitted a response frame to the action frame for configuring the PB-TXS session of STA 1 (2310) and subsequently transmitted a response action frame to STA 1 (2310) and the response action frame indicates that the AP (2320) is rejecting the PB-TXS session configuration, the PB-TXS session is not configured between STA 1 (2310) and the AP (2320). When the AP (2320) has transmitted a response frame to the action frame for configuring the PB-TXS session of STA 1 (2310) and subsequently transmitted a response action frame to STA 1 (2310) and the response action frame indicates that the AP (2320) is accepting the PB-TXS session configuration, the PB-TXS session is configured between STA 1 (2310) and the AP (2320). When the PB-TXS session is configured, the PB-TXS communication operation described below may be performed. Alternatively, the PB-TXS session may be configured through a stream classification service (SCS) method. STA 1 (2310) may transmit an SCS request frame to the AP (2320). The SCS request frame of STA 1 (2310) includes an SCS descriptor element. STA 1 (2310) may set the request type to ‘ADD’ or ‘Change’ in the SCS descriptor element. The SCS descriptor element may include a QoS characteristics element indicating QoS information required by STA 1 (2310), and the QoS characteristics element may include at least one of identifiers of the target terminal, TID information, and resource length information for STA 1 (2310) to configure the PB-TXS session. The AP (2320) may receive the SCS request frame from STA 1 (2310) and transmit an SCS response frame to STA 1 (2310). When the Status field of the SCS Status duple of the SCS response frame transmitted by the AP (2320) is SUCCESS, an SCS stream is configured between the AP (2320) and STA 1 (2310). When the SCS stream is configured, this may be regarded as the PB-TXS session being configured.

Referring to FIG. 23A, the PB-TXS communication operation may be performed. STA 2 (2330) performs a channel access operation on the wireless LAN channel. The channel access operation is an enhanced distributed channel access (EDCA) backoff operation. The EDCA backoff operation may also be referred to as a backoff operation or procedure. In the backoff operation, EDCA functions (EDCAFs) for each access category (AC) may select a backoff counter within a contention window prior to transmitting a frame, and may decrement the backoff counter at a slot boundary prior to transmitting a frame. The EDCAF performs frame transmission at the slot boundary at which the backoff counter reaches zero. That is, this indicates that the EDCAF has determined frame transmission. When the EDCAF determines frame transmission, a TXOP is granted to the EDCAF. Since a TXOP has been granted to the EDCAF of STA 2 (2330), a TXOP has been granted to STA 2 (2330). This may mean that STA 2 (2330) has acquired the TXOP, and STA 2 (2330) is the TXOP holder. The TXOP is a time period during which one or more frames may be transmitted. Within the TXOP acquired by STA 2 (2330), STA 2 (2330) transmits an uplink (UL) frame to the AP (2320). The final destination of the uplink frame is STA 1 (2310). That is, the address fields of the MAC header may be configured so that the uplink frame is delivered to STA 1 (2310) via the AP (2320). STA 2 (2330) sets the fields of the MAC header of the uplink frame as shown in [Table 10]. STA 2 (2330) may transmit at least one uplink frame. When the transmission of the last uplink frame of STA 2 (2330) is completed, the TXOP of STA 2 (2330) may end.

Upon completing reception of the uplink frame from STA 2 (2330), the AP (2320) may transmit a response frame after a SIFS duration. The response frame may be a block acknowledgment (BA) frame or an ACK frame. When a PB-TXS session has been configured, the AP (2320) checks whether the received frame satisfies [Condition 2].

### [Condition 2]

Sub-condition 1: The transmitter of the received frame is the target STA of the PB-TXS session
Sub-condition 2: The destination of the received frame is the PB-TXS session initiator
Sub-condition 3: The TID of the received frame matches the TID indicated in the PB-TXS session

When at least sub-condition 1 and sub-condition 2 of [Condition 2] are satisfied and additionally sub-condition 3 is satisfied, the AP (2320) may perform the TXOP sharing procedure with STA 1 (2310). The AP (2320) may acquire the TXOP of the AP (2320) after the TXOP of STA 2 (2330) ends in order to transmit a data frame to STA 1 (2310) and perform the TXOP sharing procedure, and may transmit data frames within the TXOP. Exceptionally, the AP (2320) may immediately acquire the TXOP after a predetermined duration (e.g., a SIFS or PIFS duration) from the end of the TXOP of STA 2 (2330). When the AP (2320) acquires the TXOP, it may transmit a downlink frame to STA 1 (2310). The downlink frame may be a frame that forwards the uplink frame transmitted by STA 2 (2330) to the AP (2320) to STA 1 (2310). The AP (2320) sets the MAC header of the downlink frame as shown in [Table 11]. The AP (2320) may transmit at least one downlink frame to STA 1 (2310) within the TXOP, and when STA 1 (2310) receives the downlink frame of the AP (2320), STA 1 (2310) may transmit a response frame (BA frame or ACK frame) to the AP (2320). When the AP (2320) has completed downlink frame transmission and received the response frame from STA 1 (2310), the AP (2320) may transmit a trigger frame including the user information field of STA 2 (2330). The trigger frame of the AP (2320) may be transmitted to request uplink transmission from STA 1 (2310). The trigger frame of the AP (2320) may be a basic trigger frame. In this case, STA 1 (2310) may transmit an uplink frame after a SIFS duration from the completion of reception of the trigger frame, and the physical layer format of the uplink frame may be a trigger-based (TB) physical layer protocol data unit (PPDU). The trigger frame of the AP (2320) may be a multi-user request to send (MU-RTS) TXOP sharing (TXS) trigger frame. The MU-RTS TXS frame allocates a separate transmission period to STA 1 (2310) during which a non-TB PPDU may be transmitted. The MU-RTS TXS frame may include a TXS mode. When the TXS mode is indicated as 1, STA 1 (2310) may transmit an uplink frame to the AP (2320). When the TXS mode is indicated as 2, STA 1 (2310) may transmit an uplink frame to the AP (2320) or may directly transmit a data frame to another STA (e.g., STA 2 (2330)). STA 1 (2310) sets the MAC header of the uplink data frame as shown in [Table 8]. Upon completing reception of the uplink frame of STA 1 (2310), the AP (2320) may transmit a response frame after a SIFS duration. The response frame may be a block acknowledgment (BA) frame. The length of the resources allocated in the trigger frame transmitted by the AP (2320) to STA 1 (2310) may be allocated based on the resource length indicated in the PB-TXS session configuration procedure. STA 1 (2310) may have no uplink frames to transmit. In this case, when STA 1 (2310) receives a basic trigger frame from the AP (2320), STA 1 (2310) may transmit a QoS Null frame. The MAC header of the QoS Null frame may include a BSR (buffer status report) transmitted by STA 1 (2310) in the A-control format. When STA 1 (2310) has received an MU-RTS TXS trigger frame from the AP (2320) and the TXS mode is 2, STA 1 (2310) may include a command and status (CAS) control in the A-control format in the MAC header of the QoS Null frame or the QoS data frame. When the RDG/more PPDU bit included in the CAS control is indicated as 0, the AP (2320) may recognize that STA 1 (2310) has no more frames to transmit. When STA 1 (2310) has received an MU-RTS TXS trigger frame from the AP (2320) and the TXS mode is 1, STA 1 (2310) may not transmit on the medium for a PIFS duration. The AP (2320) may recognize that STA 1 (2310) has no more frames to transmit.

When the AP (2320) has transmitted a basic trigger frame to STA 1 (2310), the AP (2320) may transmit a downlink frame to STA 2 (2330) after a SIFS duration from the completion of transmission of the response frame to STA 1 (2310). When the AP (2320) has transmitted an MU-RTS TXS trigger frame to STA 1 (2310), the AP (2320) may transmit a downlink frame to STA 2 (2330) after a SIFS or PIFS duration from the end of the separate transmission period allocated to STA 1 (2310). The downlink frame may be a frame that forwards the uplink frame transmitted by STA 1 (2310) to the AP (2320) to STA 2 (2330). The AP (2320) sets the MAC header of the downlink frame as shown in [Table 9]. STA 2 (2330) may receive the downlink frame from the AP (2320) and may identify that the original transmitter of the received frame is STA 1 (2310). STA 2 transmits a response frame to the AP (2320) after a SIFS duration from the completion of reception of the downlink frame. When STA 1 (2310) has no frame to transmit to the AP (2320), the AP (2320) may not transmit any frame to STA 2 or may transmit a QoS Null frame. The PB-TXS communication operation may be completed.

Referring to FIG. 23B, the PB-TXS communication operation may be performed. STA 2 performs a channel access operation on the wireless LAN channel. The channel access operation is an enhanced distributed channel access (EDCA) backoff operation. The EDCA backoff operation may also be referred to as a backoff operation or procedure. In the backoff operation, EDCA functions (EDCAFs) for each access category (AC) may select a backoff counter within a contention window prior to transmitting a frame, and may decrement the backoff counter at a slot boundary prior to transmitting a frame. The EDCAF performs frame transmission at the slot boundary at which the backoff counter reaches zero. That is, this indicates that the EDCAF has determined frame transmission. When the EDCAF determines frame transmission, a TXOP is granted to the EDCAF. Since a TXOP has been granted to the EDCAF of STA 2 (2330), a TXOP has been granted to STA 2 (2330). This may mean that STA 2 (2330) has acquired the TXOP, and STA 2 (2330) is the TXOP holder. The TXOP is a time period during which one or more frames may be transmitted. Within the TXOP acquired by STA 2 (2330), STA 2 (2330) transmits an uplink (UL) frame to the AP (2320). The final destination of the uplink frame is STA 1 (2310). That is, the address fields of the MAC header may be configured so that the uplink frame is delivered to STA 1 (2310) via the AP (2320). STA 2 (2330) sets the fields of the MAC header of the uplink frame as shown in [Table 10]. STA 2 (2330) may transmit at least one uplink frame. When the transmission of the last uplink frame of STA 2 (2330) is completed, the TXOP of STA 2 (2330) may end.

Upon completing reception of the uplink frame from STA 2 (2330), the AP (2320) may transmit a response frame after a SIFS duration. The response frame may be a block acknowledgment (BA) frame or an ACK frame. When a PB-TXS session has been configured, the AP (2320) checks whether the received frame satisfies [Condition 2]. When at least sub-condition 1 and sub-condition 2 of [Condition 2] are satisfied and additionally sub-condition 3 is satisfied, the AP (2320) may perform the TXOP sharing procedure with STA 1 (2310). The AP (2320) may acquire the TXOP of the AP (2320) after the TXOP of STA 2 (2330) ends in order to transmit a data frame to STA 1 (2310) and perform the TXOP sharing procedure, and may transmit data frames within the TXOP. The AP (2320) performs a channel access operation (e.g., EDCA backoff operation) to acquire the TXOP, and acquires the TXOP upon successfully completing the channel access operation. Alternatively, the AP (2320) may perform a different channel access operation to acquire the TXOP. The AP (2320) may transmit a defer signal (DS) after a DIFS or AIFS [VO] duration from the end of the TXOP of STA 2 (2330) in order to gain priority in the channel access operation. The DS is a frame for restricting channel access of all or some of the STAs other than the AP (2320). The DS may be a frame consisting only of a PHY preamble, or may be a simultaneous-CTS (S-CTS) frame. The transmission of the DS by the AP (2320) is a preemption operation in which the AP (2320) intends to transmit with priority over the transmissions of other terminals (e.g., STAs). The AP (2320) performs a random backoff operation after transmitting the DS, and acquires the TXOP upon successfully completing the random backoff operation (e.g., when the backoff counter reaches zero). When the AP (2320) acquires the TXOP, it may transmit a downlink frame to STA 1 (2310). The downlink frame may be a frame that forwards the uplink frame transmitted by STA 2 (2330) to the AP (2320) to STA 1 (2310). The AP (2320) sets the MAC header of the downlink frame as shown in [Table 11]. The AP (2320) may transmit at least one downlink frame to STA 1 (2310) within the TXOP, and when STA 1 (2310) receives the downlink frame of the AP (2320), STA 1 (2310) may transmit a response frame (BA frame or ACK frame) to the AP (2320). When the AP (2320) has completed downlink frame transmission and received the response frame from STA 1 (2310), the AP (2320) may transmit a trigger frame including the user information field of STA 2 (2330). The trigger frame of the AP (2320) may be transmitted to request uplink transmission from STA 1 (2310). The trigger frame of the AP (2320) may be a basic trigger frame. In this case, STA 1 (2310) may transmit an uplink frame after a SIFS duration from the completion of reception of the trigger frame, and the physical layer format of the uplink frame may be a trigger-based (TB) physical layer protocol data unit (PPDU). The trigger frame of the AP (2320) may be a multi-user request to send (MU-RTS) TXOP sharing (TXS) trigger frame. The MU-RTS TXS frame allocates a separate transmission period to STA 1 (2310) during which a non-TB PPDU may be transmitted. The MU-RTS TXS frame may include a TXS mode. When the TXS mode is indicated as 1, STA 1 (2310) may transmit an uplink frame to the AP (2320). When the TXS mode is indicated as 2, STA 1 (2310) may transmit an uplink frame to the AP (2320) or may directly transmit a data frame to another STA (e.g., STA 2). STA 1 (2310) sets the MAC header of the uplink data frame as shown in [Table 8]. Upon completing reception of the uplink frame of STA 1 (2310), the AP (2320) may transmit a response frame after a SIFS duration. The response frame may be a block acknowledgment (BA) frame. The length of the resources allocated in the trigger frame transmitted by the AP (2320) to STA 1 (2310) may be allocated based on the resource length indicated in the PB-TXS session configuration procedure. STA 1 (2310) may have no uplink frames to transmit. In this case, when STA 1 (2310) receives a basic trigger frame from the AP (2320), STA 1 (2310) may transmit a QoS Null frame. The MAC header of the QoS Null frame may include a BSR (buffer status report) transmitted by STA 1 (2310) in the A-control format. When STA 1 (2310) has received an MU-RTS TXS trigger frame from the AP (2320) and the TXS mode is 2, STA 1 (2310) may include a command and status (CAS) control in the A-control format in the MAC header of the QoS Null frame or the QoS data frame. When the RDG/more PPDU bit included in the CAS control is indicated as 0, the AP (2320) may recognize that STA 1 (2310) has no more frames to transmit. When STA 1 (2310) has received an MU-RTS TXS trigger frame from the AP (2320) and the TXS mode is 1, STA 1 (2310) may not transmit on the medium for a PIFS duration. The AP (2320) may recognize that STA 1 (2310) has no more frames to transmit.

When the AP (2320) has transmitted a basic trigger frame to STA 1 (2310), the AP (2320) may transmit a downlink frame to STA 2 (2330) after a SIFS duration from the completion of transmission of the response frame to STA 1 (2310). When the AP (2320) has transmitted an MU-RTS TXS trigger frame to STA 1 (2310), the AP (2320) may transmit a downlink frame to STA 2 (2330) after a SIFS or PIFS duration from the end of the separate transmission period allocated to STA 1 (2310). The downlink frame may be a frame that forwards the uplink frame transmitted by STA 1 (2310) to the AP (2320) to STA 2 (2330). The AP (2320) sets the MAC header of the downlink frame as shown in [Table 9]. STA 2 (2330) may receive the downlink frame from the AP (2320) and may identify that the original transmitter of the received frame is STA 1 (2310). STA 2 (2330) transmits a response frame to the AP (2320) after a SIFS duration from the completion of reception of the downlink frame. When STA 1 (2310) has no frame to transmit to the AP (2320), the AP (2320) may not transmit any frame to STA 2 (2330) or may transmit a QoS Null frame. The PB-TXS communication operation may be completed.

Referring to FIG. 22A through FIG. 22C and FIG. 23A and FIG. 23B, the queue operation of the AP (2320) may prioritize STA 1 (2310), which has configured the PB-TXS session, and STA 2 (2330), which is the target terminal of the PB-TXS session. In an embodiment, the AP (2320) may input data frames received from STA 1 (2310) and STA 2 (2330) into the output queue so that they are transmitted with priority in order to perform the PB-TXS communication operation. Alternatively, a dedicated queue for performing the PB-TXS communication operation may exist in the AP (2320), and the AP (2320) may use the dedicated queue to perform the PB-TXS communication operation when performing the PB-TXS operation. In addition, In an embodiment, the AP (2320) may input data frames received from STA 1 (2310) and STA 2 (2330) into the dedicated queue to perform the PB-TXS communication operation, and may transmit frames present in the dedicated queue with priority.

Referring to FIG. 22A through FIG. 22C and FIG. 23A and FIG. 23B, the machine learning algorithm and machine learning unit illustrated in FIG. 3 and FIG. 4 may be used for STA 1 (2310) to determine the TID and resource length of the PB-TXS session. In an embodiment, STA 1 (2310) may use the length and AC of traffic transmitted by the target STA, STA 2 (2330), to STA 1 (2310), or transmitted by STA 2 (2330) to STA 1 (2310), as input to the machine learning algorithm. Based on this, the machine learning algorithm of STA 1 (2310) may determine the resource length and TID to be indicated in the PB-TXS session. The machine learning algorithm of STA 1 (2310) may also confirm whether the resource length and TID configured in the PB-TXS session are inappropriate. In this case, the machine learning algorithm of STA 1 (2310) may continuously update the resource length and TID of the PB-TXS session. Based on this, PB-TXS communication may be performed smoothly.

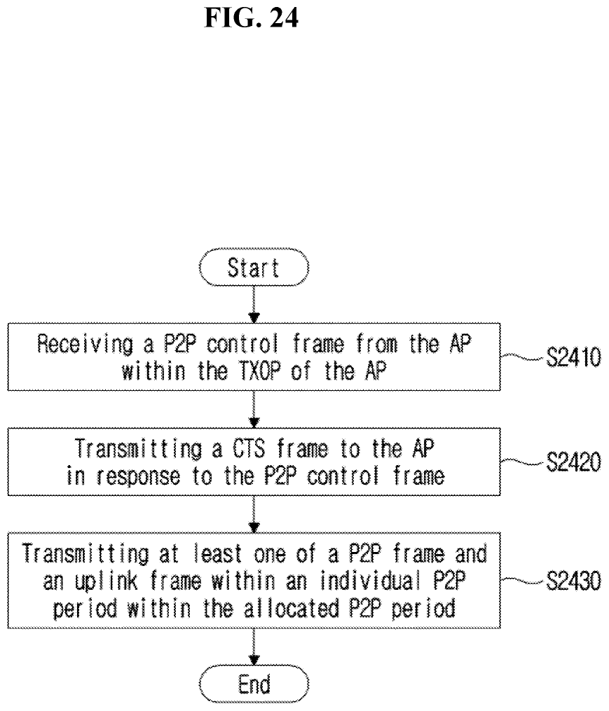

FIG. 24 is a flowchart illustrating a method of operating a STA performing direct transmission between multiple users in a wireless LAN to which the present disclosure is applied.

In a wireless LAN system, a first STA may receive a control frame from the AP within the TXOP of the AP (S2410). Here, a P2P communication period is allocated to at least one STA based on the P2P control frame, and a CTS frame may be transmitted to the AP in response to the P2P control frame (S2420). In addition, at least one STA including the first STA that received the P2P control frame may simultaneously transmit a CTS frame to the AP, as described above.

Thereafter, at least one of a P2P frame and an uplink frame may be transmitted within the individual P2P communication period of the first STA within the P2P communication period allocated to the at least one STA. In addition, other STAs allocated P2P communication may each transmit at least one of a P2P frame and an uplink frame within their respective individual P2P communication periods.

In an embodiment, a STA may be a wireless user device including at least one processor and a memory storing instructions that cause the wireless user device to perform specific operations by the at least one processor. Here, the specific operations may be as described above.

In an embodiment, the first STA may receive a polling trigger frame for P2P communication from the AP prior to receiving the P2P control frame, and may transmit a response frame to the polling trigger frame to the AP. Each of at least one STA including the first STA that intends to perform P2P communication may simultaneously transmit a response frame on each tone allocated based on the AID of OFDMA. In addition, the first STA may receive a buffer status report polling frame from the AP prior to receiving the P2P control frame, and may transmit a response frame including a buffer status report to the AP based on the buffer status report polling frame. Here, the buffer status report may include information on data to be transmitted by the first STA. The AP may receive a response frame including a buffer status report from each of at least one STA including the first STA. The individual P2P communication period of the first STA among the total P2P communication period allocated by the AP may be determined based on the buffer status report transmitted from each of the at least one STA to the AP.

In addition, the P2P control frame may include at least one of: a list of at least one STA performing P2P communication; a total P2P communication period; an individual P2P communication period per STA; an order of P2P communication performance; and CTS frame transmission timing information. As another embodiment, the P2P control frame may include a user information field. The user information field includes identification information of at least one STA and individual P2P communication period information per STA, and the order of performing P2P communication within the total P2P communication period may be determined based on the order of STAs included in the user information field.

In addition, In an embodiment, the P2P control frame may directly indicate individual time information per STA or may indicate individual time information per STA through the P2P communication period occupancy end time per STA. Here, when the P2P communication of the first STA is shorter than the individual P2P communication period of the first STA, the first STA may add padding bits to the frame transmitted based on the P2P communication so that it equals the individual P2P communication period of the first STA.

In addition, In an embodiment, when P2P communication is not detected for a preset duration during the P2P communication period allocated to the at least one STA, the AP may retransmit the P2P control frame to reallocate the P2P communication period.

As another embodiment, the first STA may receive a poll frame of the first STA from the AP after transmitting the CTS frame to the AP. The poll frame of the first STA may include at least one of information granting P2P communication to the first STA and individual P2P communication period information of the first STA. The first STA may transmit to the AP at least one of an uplink frame and a return frame including individual P2P communication period return indicator information of the first STA within the individual P2P communication period of the first STA.

As another embodiment, the P2P control frame may include information indicating whether the first STA may share the P2P communication period with other STAs. When the first STA is able to share the P2P communication period with other STAs, the first STA may transmit a P2P frame to a second STA within the P2P communication period and then transmit a P2P communication period sharing indicator frame to the second STA. The second STA that has received the P2P communication period sharing indicator frame may be allocated the P2P communication period and may transmit a P2P frame to a third STA.

In addition, the first STA may transmit a P2P frame to the second STA within the P2P communication period and then transmit a P2P communication period sharing indicator frame. The P2P communication period of the first STA may be terminated by the AP that has received the P2P communication period sharing indicator frame, and the AP may transmit a P2P control frame to the second STA based on the information included in the P2P communication period sharing indicator frame to allocate the P2P communication period to the second STA.

According to an embodiment of the present disclosure, the first STA performs a polling operation for allocating a partial time interval of a transmission opportunity (TXOP) acquired by the first STA to at least one STA. At this point, at least one polling STA that is allocated the partial time interval within the TXOP acquired by the first STA is determined based on the polling operation. The first STA transmits a trigger frame that allocates the partial time interval to the at least one polling STA. At this point, the partial time interval is allocated to the at least one polling STA within the TXOP acquired by the first STA based on the trigger frame. According to an embodiment of the present disclosure, the performing the polling operation comprises steps below. The first STA transmits a first frame to the at least one STA, and receives a second frame from the at least one polling STA that is allocated the partial time interval within the TXOP acquired by the first STA. At this point, a request for allocation of the partial time interval by the at least one polling STA is performed based on the second frame. According to an embodiment of the present disclosure, the first STA transmits the first frame based on identification information for the at least one STA. According to an embodiment of the present disclosure, the first STA does not receive the second frame from a STA among the at least one STA that is not allocated the partial time interval within the TXOP acquired by the first STA, and the partial time interval is allocated by the first STA only to a STA that transmits the second frame. According to an embodiment of the present disclosure, the trigger frame transmitted by the first STA to the at least one polling STA is a type of trigger frame indicating allocation of the partial time interval within the TXOP acquired by the first STA. According to an embodiment of the present disclosure, the trigger frame includes identification information of the at least one polling STA and partial time interval information allocated to the at least one polling STA within the TXOP. According to an embodiment of the present disclosure, a second STA is allocated the partial time interval within the TXOP acquired by the first STA based on the trigger frame, and frame exchange by the second STA is performed within the partial time interval allocated to the second STA. According to an embodiment of the present disclosure, frame exchange by the first STA is prohibited during the partial time interval allocated to the second STA. According to an embodiment of the present disclosure, when the first STA receives a TXOP return indication within the partial time interval allocated to the second STA, the partial time interval allocated to the second STA is terminated, and after the partial time interval allocated to the second STA is terminated, the first STA performs frame exchange within the TXOP acquired by the first STA. According to an embodiment of the present disclosure, the TXOP return by the second STA is indicated to the first STA through a command and status (CAS) control field of a medium access control (MAC) header of a frame transmitted by the second STA.

According to an embodiment of the present disclosure, the first STA transmits a trigger frame indicating an allocation of a partial time interval of a transmission opportunity (TXOP) acquired by the first STA to a peer-to-peer (P2P) group, and receives a response frame to the trigger frame from a second STA belonging to the P2P group. The first STA allocates the partial time interval of the TXOP acquired by the first STA to the P2P group based on receiving the response frame. According to an embodiment of the present disclosure, the trigger frame includes identification information representing the P2P group and information on the partial time interval allocated to the P2P group. According to an embodiment of the present disclosure, a duration field of the trigger frame is set to a value equal to the sum of the response frame transmission time and a short interframe space (SIFS). According to an embodiment of the present disclosure, the trigger frame includes identification information representing the P2P group as identification information allocated to the second STA, and information indicating whether the partial time interval allocated to the P2P group is sharable with at least one other STA within the P2P group. According to an embodiment of the present disclosure, the first STA receives a request frame requesting TXOP sharing for the P2P group before transmitting the trigger frame from the second STA, wherein the request frame includes information identifying the P2P group. According to an embodiment of the present disclosure, the response frame is received exclusively from the second STA among STAs within the P2P group. At this point, the second STA having previously transmitted a request for the allocation of the partial time interval to the first STA. According to an embodiment of the present disclosure, transmission of a frame addressed to the first STA or a frame addressed to at least one STA within the P2P group is permitted within the partial time interval allocated to the P2P group. According to an embodiment of the present disclosure, the trigger frame is a multi-user request to send (MU-RTS) trigger frame. According to an embodiment of the present disclosure, the first STA receives a frame including a TXOP return indicator from the second STA within the partial time interval allocated to the P2P group and resuming transmission a remaining TXOP based on the TXOP return indicator. According to an embodiment of the present disclosure, the first STA is a non-access point (AP) STA or an AP STA.

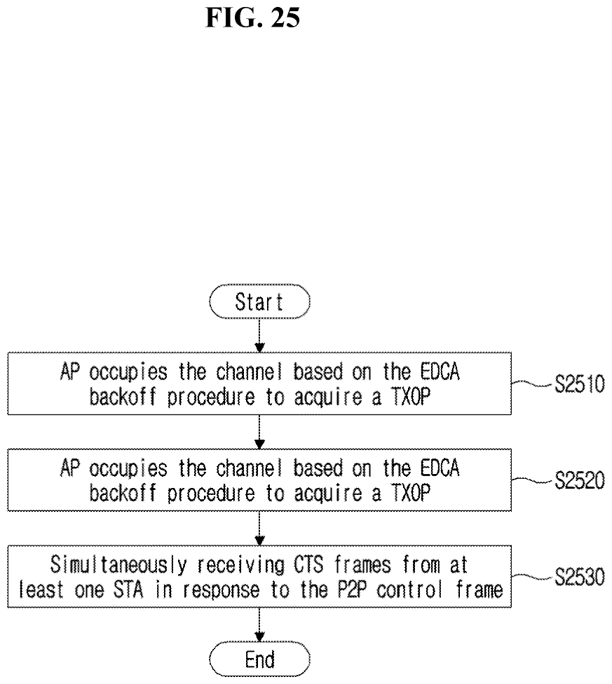

FIG. 25 is a flowchart illustrating a method of operating an AP performing direct transmission between multiple users in a wireless LAN to which the present disclosure is applied.

The AP may occupy the channel based on an EDCA backoff procedure to acquire a TXOP (S2510). Thereafter, the AP may transmit a P2P control frame to at least one STA within the TXOP, and a P2P communication period may be allocated to the at least one STA based on the P2P control frame (S2520). Thereafter, the AP may simultaneously receive a CTS frame from the at least one STA in response to the P2P control frame, and after receiving the CTS frame, the P2P communication period may be allocated to the at least one STA (S2530). In addition, In an embodiment, the AP may include at least one processor and a memory storing instructions that cause the wireless user device to perform specific operations by the at least one processor, and the specific operations may be as described above.

In an embodiment, the AP may transmit a polling trigger frame for P2P communication to the at least one STA prior to transmitting the P2P control frame, and may receive a response frame to the polling trigger frame. Each of the at least one STA intending to perform P2P communication may simultaneously transmit a response frame on each tone allocated based on the AID of OFDMA. In addition, the AP may transmit a buffer status report polling frame to the at least one STA prior to transmitting the P2P control frame. Thereafter, the AP may receive a response frame including a buffer status report from the at least one STA based on the buffer status report polling frame. Here, the buffer status report may include information on data to be transmitted by the STA. The AP may receive a response frame including a buffer status report from each of the at least one STA. The AP may determine the individual P2P communication period of each of the at least one STA within the total P2P communication period allocated by the AP based on the buffer status report.

In addition, the P2P control frame may include at least one of: a list of at least one STA performing P2P communication; a total P2P communication period; an individual P2P communication period per STA; an order of P2P communication performance; and CTS frame transmission timing information. As another embodiment, the P2P control frame may include a user information field. The user information field includes identification information of at least one STA and individual P2P communication period information per STA, and the order of performing P2P communication within the total P2P communication period may be determined based on the order of STAs included in the user information field.

In addition, In an embodiment, the P2P control frame may directly indicate individual time information per STA or may indicate individual time information per STA through the P2P communication period occupancy end time per STA. Here, when the P2P communication of a STA is shorter than the individual P2P communication period of the STA, the STA may add padding bits to the frame transmitted based on the P2P communication so that it equals the individual P2P communication period of the STA.

In addition, In an embodiment, when P2P communication is not detected for a preset duration during the P2P communication period allocated to the at least one STA, the AP may retransmit the P2P control frame to reallocate the P2P communication period.

As another embodiment, the first STA may receive a poll frame of the first STA from the AP after transmitting the CTS frame to the AP. The poll frame of the first STA may include at least one of information granting P2P communication to the first STA and individual P2P communication period information of the first STA. The first STA may transmit to the AP at least one of an uplink frame and a return frame including individual P2P communication period return indicator information of the first STA within the individual P2P communication period of the first STA.

As another embodiment, the P2P control frame may include information indicating whether the first STA may share the P2P communication period with other STAs. When the first STA is able to share the P2P communication period with other STAs, the first STA may transmit a P2P frame to a second STA within the P2P communication period and then transmit a P2P communication period sharing indicator frame to the second STA. The second STA that has received the P2P communication period sharing indicator frame may be allocated the P2P communication period and may transmit a P2P frame to a third STA.

In addition, the first STA may transmit a P2P frame to the second STA within the P2P communication period and then transmit a P2P communication period sharing indicator frame. The P2P communication period of the first STA may be terminated by the AP that has received the P2P communication period sharing indicator frame, and the AP may transmit a P2P control frame to the second STA based on the information included in the P2P communication period sharing indicator frame to allocate the P2P communication period to the second STA.

The methods according to the present disclosure may be implemented in the form of program instructions that can be executed by various computer means and recorded on a computer-readable medium. The computer-readable medium may include program instructions, data files, data structures, and the like, alone or in combination. The program instructions recorded on the computer-readable medium may be those specially designed and constructed for the present disclosure, or those known and available to those skilled in the art of computer software.

Embodiments of computer-readable media include hardware devices specially configured to store and execute program instructions, such as ROM, RAM, and flash memory. Embodiments of program instructions include not only machine language code such as that produced by a compiler, but also high-level language code that can be executed by a computer using an interpreter or the like. The hardware devices described above may be configured to operate as at least one software module to perform the operations of the present disclosure, and vice versa.

Although the present disclosure has been described with reference to the above embodiments, those skilled in the relevant art will understand that the present disclosure may be variously modified and changed without departing from the spirit and scope of the present disclosure as set forth in the claims below.

### INDUSTRIAL APPLICABILITY

The foregoing may also be applicable to other systems.

1-16. (canceled)

17. A method of operating a first station (STA) in a wireless LAN system, the method comprising:
performing, by the first STA, a polling operation for allocating a partial time interval of a transmission opportunity (TXOP) acquired by the first STA to at least one STA, wherein at least one polling STA that is allocated the partial time interval within the TXOP acquired by the first STA is determined based on the polling operation; and
transmitting, by the first STA, a trigger frame that allocates the partial time interval to the at least one polling STA, wherein the partial time interval is allocated to the at least one polling STA within the TXOP acquired by the first STA based on the trigger frame.

18. The method of claim 17,
wherein the performing the polling operation comprises:
transmitting, by the first STA, a first frame to the at least one STA, and
receiving, by the first STA, a second frame from the at least one polling STA that is allocated the partial time interval within the TXOP acquired by the first STA, wherein a request for allocation of the partial time interval by the at least one polling STA is performed based on the second frame.

19. The method of claim 18,
wherein the first STA transmits the first frame based on identification information for the at least one STA.

20. The method of claim 18,
wherein the first STA does not receive the second frame from a STA among the at least one STA that is not allocated the partial time interval within the TXOP acquired by the first STA, and the partial time interval is allocated by the first STA only to a STA that transmits the second frame.

21. The method of claim 17,
wherein the trigger frame transmitted by the first STA to the at least one polling STA is a type of trigger frame indicating allocation of the partial time interval within the TXOP acquired by the first STA.

22. The method of claim 17,
wherein the trigger frame includes identification information of the at least one polling STA and partial time interval information allocated to the at least one polling STA within the TXOP.

23. The method of claim 22,
wherein a second STA is allocated the partial time interval within the TXOP acquired by the first STA based on the trigger frame, and frame exchange by the second STA is performed within the partial time interval allocated to the second STA.

24. The method of claim 23,
wherein frame exchange by the first STA is prohibited during the partial time interval allocated to the second STA.

25. The method of claim 24,
wherein when the first STA receives a TXOP return indication within the partial time interval allocated to the second STA, the partial time interval allocated to the second STA is terminated, and after the partial time interval allocated to the second STA is terminated, the first STA performs frame exchange within the TXOP acquired by the first STA.

26. The method of claim 25,
wherein the TXOP return by the second STA is indicated to the first STA through a command and status (CAS) control field of a medium access control (MAC) header of a frame transmitted by the second STA.

27. A first station (STA) comprising:
at least one processor; and
a memory storing instructions that cause the first STA to perform specific operations by the at least one processor,
wherein the specific operations comprise:
performing a polling operation for allocating a partial time interval of a transmission opportunity (TXOP) acquired by the first STA to at least one STA, wherein at least one polling STA that is allocated the partial time interval within the TXOP acquired by the first STA is determined based on the polling operation; and
transmitting a trigger frame that allocates the partial time interval to the at least one polling STA, wherein the partial time interval is allocated to the at least one polling STA within the TXOP acquired by the first STA based on the trigger frame.

28. A method of operating a first station (STA) in a wireless LAN system, the method comprising:
transmitting, by the first STA, a trigger frame indicating an allocation of a partial time interval of a transmission opportunity (TXOP) acquired by the first STA to a peer-to-peer (P2P) group; and
receiving, by the first STA, a response frame to the trigger frame from a second STA belonging to the P2P group; and
allocating the partial time interval of the TXOP acquired by the first STA to the P2P group based on receiving the response frame.

29. The method of claim 28,
wherein the trigger frame includes identification information representing the P2P group and information on the partial time interval allocated to the P2P group.

30. The method of claim 29,
wherein a duration field of the trigger frame is set to a value equal to the sum of a transmission time of the response frame and a short interframe space (SIFS).

31. The method of claim 29, wherein the trigger frame includes identification information representing the P2P group as identification information allocated to the second STA, and information indicating whether the partial time interval allocated to the P2P group is sharable with at least one other STA within the P2P group.

32. The method of claim 28, further comprising:
receiving, by the first STA, a request frame requesting TXOP sharing for the P2P group from the second STA before transmitting the trigger frame, wherein the request frame includes information identifying the P2P group.

33. The method of claim 28,
wherein the response frame is received exclusively from the second STA among STAs within the P2P group, the second STA having previously transmitted a request for the allocation of the partial time interval to the first STA.

34. The method of claim 28,
wherein transmission of a frame addressed to the first STA or a frame addressed to at least one STA within the P2P group is permitted within the partial time interval allocated to the P2P group.

35. The method of claim 28,
wherein the trigger frame is a multi-user request to send (MU-RTS) trigger frame.

36. The method of claim 28, further comprising:
receiving, by the first STA, a frame including a TXOP return indicator from the second STA within the partial time interval allocated to the P2P group; and
resuming transmission, by the first STA, during a remaining TXOP based on the TXOP return indicator.

37. The method of claim 28,
wherein the first STA is a non-access point (AP) STA or an AP STA.

38. A first station (STA) comprising:
at least one processor; and
a memory storing instructions that cause the first STA to perform specific operations by the at least one processor,
wherein the specific operations comprise:
transmitting a trigger frame indicating an allocation of a partial time interval of a transmission opportunity (TXOP) acquired by the first STA to a peer-to-peer (P2P) group;
receiving a response frame to the trigger frame from a second STA among STAs within the P2P group; and
allocating the partial time interval of the TXOP acquired by the first STA to the P2P group.
